(19) United States
(12) Patent Application Publication
(10) Pub. No.: US 2025/0293408 A1
(43) Pub. Date: Sep. 18, 2025

(54) SECONDARY BATTERY

(71) Applicant: Semiconductor Energy Laboratory Co., Ltd., Atsugi-shi, Kanagawa-ken (JP)

(72) Inventors: Shunpei YAMAZAKI, Setagaya (JP); Yasuhiro JINBO, Isehara (JP); Rihito WADA, Atsugi (JP); Asako HIGA, Atsugi (JP)

(21) Appl. No.: 18/872,382

(22) PCT Filed: Jun. 16, 2023
(86) PCT No.: PCT/IB2023/056238

§ 371 Date: Dec. 6, 2024

(30) Foreign Application Priority Data
Jun. 29, 2022 (JP) 2022-104268
Jul. 8, 2022 (JP) 2022-110196

(51) Int. Cl. H01M 50/538; H01M 4/02; H01M 4/131; H01M 4/525; H01M 10/04

(52) U.S. Cl. CPC H01M 50/538; H01M 4/131; H01M 4/525; H01M 10/0431; H01M 2004/028

(57) ABSTRACT

To provide a secondary battery that has both high safety and a short charge and discharge time. The secondary battery is a wound secondary battery, and a positive electrode current collector of a positive electrode includes a first tab and a second tab, and a negative electrode current collector of a negative electrode includes a third tab and a fourth tab. The first tab is positioned in a portion closer to a center of a winding than the second tab is, and the third tab is positioned in a portion closer to the center of the winding than the fourth tab is. The first tab and the second tab are bonded in a first bonding portion, and the third tab and the fourth tab are bonded in a second bonding portion. The positive electrode active material includes a first region and a second region positioned on a surface side of the positive electrode active material. The first region contains lithium, cobalt, and oxygen. The second region contains lithium, cobalt, magnesium, and oxygen.

### TECHNICAL FIELD

One embodiment of the present invention relates to a secondary battery. One embodiment of the present invention relates to a lithium-ion secondary battery. One embodiment of the present invention relates to an electronic device including a secondary battery.

Note that one embodiment of the present invention is not limited to the above technical field. Examples of the technical field of one embodiment of the present invention disclosed in this specification and the like include a semiconductor device, a display device, a light-emitting device, a power storage device, a memory device, an electronic device, a lighting device, an input device, an input/output device, a driving method thereof, and a manufacturing method thereof. A semiconductor device refers to any device that can function by utilizing semiconductor characteristics.

### BACKGROUND ART

In recent years, a variety of storage batteries such as lithium-ion secondary batteries, lithium-ion capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society.

In particular, for purposes of mobile electronic devices, lithium-ion secondary batteries are highly demanded to have high discharge capacity per weight and excellent cycle performance. Thus, positive electrode active materials contained in positive electrodes of lithium-ion secondary batteries have been actively improved (see Patent Documents 1 to Patent Document 4 and Non-Patent Document 1 to Non-Patent Document 4, for example).

Lithium-ion secondary batteries are known to enter thermal runaway after passing through several states when the temperature increases at the time of charge (Non-Patent Document 6). Various researches and developments have been conducted for the reliability and safety of lithium-ion secondary batteries. For example, in Non-Patent Document 7, the thermal stability of a positive electrode active material and an electrolyte solution are described.

Another issue is, for example, an increasing time for charge and discharge in accordance with an increase in the capacity of a lithium-ion secondary battery. Thus, secondary batteries capable of high-speed charge and discharge have been required.

### REFERENCES

### Patent Documents

[Patent Document 1] Japanese Published Patent Application No. 2019-179758
[Patent Document 2] International Publication WO2020/026078 Pamphlet
[Patent Document 3] Japanese Published Patent Application No. 2020-140954
[Patent Document 4] Japanese Published Patent Application No. 2019-129009

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348
[Non-Patent Document 2]T. Motohashi, T. et al., “Electronic phase diagram of the layered cobalt oxide system Li_{X}CoO₂ (0.0≤X≤1.0)”, Physical Review B, 80 (16); 165114
[Non-Patent Document 3] Zhaohui Chen et al., “Staging Phase Transitions in LiₓCoO₂”, Journal of The Electrochemical Society, 2002, 149 (12), A1604-A1609.
[Non-Patent Document 4]G. G. Amatucci et al., “CoO₂, The End Member of the LiₓCoO₂ Solid Solution”, J. Electrochem. Soc., 143 (3), 1114 (1996).
[Non-Patent Document 5]A. Belsky, A. et al., “New developments in the Inorganic Crystal Structure Database (ICSD): accessibility in support of materials research and design”, Acta Cryst., (2002), B58 364-369
[Non-Patent Document 6] Nobuo Eda, “2-4: Mechanism of Heat Generation” in “Learning Charging and Discharging Techniques of Li-Ion Batteries from Data”, CQ Publishing Co., Ltd., published on Apr. 4, 2020, pp. 68-72.
[Non-Patent Document 7] Shinya Kitano et al., GS Yuasa Technical Report, Vol. 2, No. 2, December, 2015, pp. 18-24.
[Non-Patent Document 8] Shannon et al., Acta Cryst. Section A, (1976) 32 751.

### SUMMARY OF THE INVENTION

### Problems to be Solved by the Invention

An object of one embodiment of the present invention is to provide a highly safe secondary battery. Another object of one embodiment of the present invention is to provide a secondary battery that is capable of high-speed charge and discharge. Another object of one embodiment of the present invention is to provide a secondary battery that is capable of achieving both high safety and a shortened charge and discharge time. Another object of one embodiment of the present invention is to provide a high-capacity secondary battery.

Note that the description of these objects does not preclude the existence of other objects. One embodiment of the present invention does not necessarily achieve all these objects. Other objects can be derived from the description of the specification, the drawings, and the claims.

### Means for Solving the Problems

One embodiment of the present invention is a wound secondary battery including a positive electrode and a negative electrode. The positive electrode includes a positive electrode current collector and a positive electrode active material. The positive electrode current collector includes a first tab and a second tab. The negative electrode includes a negative electrode current collector and a negative electrode active material. The negative electrode current collector includes a third tab and a fourth tab. The first tab is positioned in a portion closer to a center of a winding than the second tab is. The third tab is positioned in a portion closer to the center of the winding than the fourth tab is. The first tab and the second tab are bonded in a first bonding portion, and the third tab and the fourth tab are bonded in a second bonding portion. The positive electrode active material includes a first region and a second region positioned on a surface side of the positive electrode active material. The first region contains lithium, cobalt, and oxygen. The second region contains lithium, cobalt, magnesium, and oxygen.

Another embodiment of the present invention is a wound secondary battery including a positive electrode and a negative electrode. The positive electrode includes a positive electrode current collector and a positive electrode active material. The positive electrode current collector includes a first tab, a second tab, and a fifth tab. The negative electrode includes a negative electrode current collector and a negative electrode active material. The negative electrode current collector includes a third tab, a fourth tab, and a sixth tab. The first tab, the second tab, and the fifth tab are positioned in this order from a side close to a center of a winding and are bonded in a first bonding portion. The third tab, the fourth tab, and the sixth tab are positioned in this order from a side close to the center of the winding and are bonded in a second bonding portion. The first tab and the fifth tab are provided with the second tab therebetween in the first bonding portion, and the third tab and the sixth tab are provided with the fourth tab therebetween in the second bonding portion. The positive electrode active material includes a first region and a second region positioned on a surface side of the positive electrode active material. The first region contains lithium, cobalt, and oxygen. The second region contains lithium, cobalt, magnesium, and oxygen.

Another embodiment of the present invention is a wound secondary battery including a positive electrode and a negative electrode. The positive electrode includes a positive electrode current collector and a positive electrode active material. The positive electrode current collector includes a first tab, a second tab, and a fifth tab. The negative electrode includes a negative electrode current collector and a negative electrode active material. The negative electrode current collector includes a third tab, a fourth tab, and a sixth tab. The first tab, the second tab, and the fifth tab are positioned in this order from a side close to a center of a winding and are bonded in a first bonding portion. The third tab, the fourth tab, and the sixth tab are positioned in this order from a side close to the center of the winding and are bonded in a second bonding portion. The second tab and the fifth tab are provided with the first tab therebetween in the first bonding portion. The fourth tab and the sixth tab are provided with the third tab therebetween in the second bonding portion. The positive electrode active material includes a first region and a second region positioned on a surface side of the positive electrode active material. The first region contains lithium, cobalt, and oxygen. The second region contains lithium, cobalt, magnesium, and oxygen.

In any of the above, a thickness of the second region is preferably greater than or equal to 2 nm and less than or equal to 5 nm.

In any of the above, it is preferable that the second region further contain nickel.

In any of the above, it is preferable that the second region further contain fluorine.

In any of the above, it is preferable that the first region further contain aluminum.

In any of the above, the second region is preferably positioned in a range of 5 nm from a surface of the positive electrode active material.

In any of the above, a volume resistivity of a powder of the positive electrode active material at a temperature higher than or equal to 15° C. and lower than or equal to 30° C. is preferably higher than or equal to 1.0×10⁵ Ω·cm under a pressure of 64 MPa.

In any of the above, a volume resistivity of a powder of the positive electrode active material at a temperature higher than or equal to 15° C. and lower than or equal to 30° C. is preferably higher than or equal to 2.0×10⁵ Ω·cm under a pressure of 13 MPa.

In any of the above, a volume resistivity of a powder of the positive electrode active material at a temperature higher than or equal to 15° C. and lower than or equal to 30° C. is preferably higher than or equal to 1.0×10⁵ Ω·cm under a pressure of 64 MPa and higher than or equal to 2.0×10⁵ Ω·cm at a pressure of 13 MPa.

### Effect of the Invention

According to one embodiment of the present invention, a highly safe secondary battery can be provided. Alternatively, a secondary battery that is capable of high-speed charge and discharge can be provided. Alternatively, a secondary battery that is capable of achieving both high safety and a shortened charge and discharge time can be provided. Alternatively, a secondary battery with high capacity can be provided.

Note that the description of these effects does not preclude the existence of other effects. One embodiment of the present invention does not necessarily have all these effects. Note that effects other than these can be derived from the description of the specification, the drawings, the claims, and the like.

### BRIEF DESCRIPTION OF THE DRAWINGS

FIG. 1 is a diagram illustrating a structure example of a secondary battery.

FIG. 2A and FIG. 2B are diagrams illustrating a structure example of a secondary battery.

FIG. 3 is a diagram illustrating a structure example of a secondary battery.

FIG. 4 is a diagram illustrating a structure example of a secondary battery.

FIG. 5 is a diagram illustrating a structure example of a secondary battery.

FIG. 6 is a diagram illustrating a structure example of a secondary battery.

FIG. 7A and FIG. 7B are diagrams each illustrating a structure example of positive electrode active materials.

FIG. 8A and FIG. 8B are graphs each showing an internal temperature of a secondary battery.

FIG. 9A and FIG. 9B are diagrams illustrating a nail penetration test.

FIG. 10A to FIG. 10F are diagrams each illustrating a structure example of a positive electrode active material.

FIG. 11 is a diagram showing a structure example of a positive electrode active material.

FIG. 12 is a diagram showing a structure example of a positive electrode active material.

FIG. 13 is an example of a TEM image of a crystal.

FIG. 14A is an example of a STEM image, and FIG. 14B and FIG. 14C are examples of FFT patterns.

FIG. 15 shows XRD patterns.

FIG. 16 shows XRD patterns.

FIG. 17A and FIG. 17B show XRD patterns.

FIG. 18A to FIG. 18C are graphs each showing lattice constants.

FIG. 19 is a diagram showing a structure example of a positive electrode active material.

FIG. 20A to FIG. 20C are diagrams each showing a method for forming a positive electrode active material.

FIG. 21A to FIG. 21C are diagrams each showing a method for forming a positive electrode active material.

FIG. 22 is a diagram showing a method for forming a positive electrode active material.

FIG. 23A to FIG. 23C are diagrams each showing a method for forming a positive electrode active material.

FIG. 24 is a diagram illustrating a heating furnace and a heating method.

FIG. 25A to FIG. 25D are diagrams illustrating structure examples of electronic devices.

FIG. 26A to FIG. 26C are diagrams each illustrating a structure example of an electronic device.

FIG. 27A to FIG. 27C are diagrams each illustrating a structure example of a vehicle.

FIG. 28A to FIG. 28C are each a structure example of a measurement apparatus.

FIG. 29 shows measurement results of volume resistivities in Example.

FIG. 30 shows measurement results of volume resistivities in Example.

### MODE FOR CARRYING OUT THE INVENTION

Embodiments will be described below with reference to the drawings. Note that the embodiments can be implemented with many different modes, and it will be readily understood by those skilled in the art that modes and details thereof can be changed in various ways without departing from the spirit and scope thereof. Thus, the present invention should not be interpreted as being limited to the following description of the embodiments.

Note that in structures of the invention described below, the same portions or portions having similar functions are denoted by the same reference numerals in different drawings, and the repeated description thereof is omitted. The same hatching pattern is used for portions having similar functions, and the portions are not especially denoted by reference numerals in some cases.

Note that in each drawing described in this specification, the size, the layer thickness, or the region of each component is exaggerated for clarity in some cases. Therefore, the size, the layer thickness, or the region is not limited to the illustrated scale.

Note that in this specification and the like, ordinal numbers such as “first” and “second” are used in order to avoid confusion among components and do not limit the number.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

A theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., x in LiₓCoO₂. In the case of a positive electrode active material in a lithium-ion secondary battery, x=(theoretical capacity−charge capacity)/theoretical capacity can be satisfied. For example, in the case where a lithium-ion secondary battery using LiCoO₂ as a positive electrode active material is charged to 219.2 mAh/g, it can be said that the positive electrode active material is represented by Li_{0.2}CoO₂ or x=0.2. Note that “x in LiₓCoO₂ is small” means, for example, 0.1<x≤0.24.

The compositional formula of lithium cobalt oxide before used for a positive electrode, which has been appropriately synthesized and almost satisfies the stoichiometric proportion, is LiCoO₂ and x=1. It can also be said that the compositional formula of lithium cobalt oxide contained in a lithium-ion secondary battery after its discharge ends is also LiCoO₂ and x=1. Here, “discharge ends” means that a voltage becomes 3.0 V or 2.5 V or lower at a current of 100 mA/g or lower, for example.

Charge capacity and/or discharge capacity used for calculation of x in LiₓCoO₂ is preferably measured under the condition of no influence or small influence of a short circuit and/or, decomposition of an electrolyte solution, or the like. For example, data of a lithium-ion secondary battery, suffering from a sudden change in capacity that seems to result from a short circuit, should not be used for calculation of x.

The space group of a lithium-ion secondary battery is identified by XRD, electron diffraction, neutron diffraction, or the like. Thus, in this specification and the like, belonging to a space group, being attributed to a space group, or being a space group can be rephrased as being identified as a space group.

In the case where three layers of anions are shifted and stacked like “ABCABC”, the structure is referred to as a cubic close-packed structure. Accordingly, anions do not necessarily form a cubic lattice structure. In addition, actual crystals always have a defect and thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

The distribution of an element indicates the region where the element is successively detected at a level higher than the background noise when analyzed by an analysis method that is capable of spatially successive analysis.

A positive electrode active material to which an additive element is added is sometimes referred to as a composite oxide, a positive electrode member, a positive electrode material, a lithium-ion secondary battery positive electrode member, or the like. A positive electrode active material of one embodiment of the present invention preferably contains one or more of a compound, a composition, and a complex.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a lithium-ion secondary battery including the positive electrode active material is sufficiently obtained.

An internal short circuit and an external short circuit of a lithium-ion secondary battery might cause not only a malfunction in at least one of charge operation and discharge operation of the lithium-ion secondary battery but also heat generation and ignition. Therefore, in order to obtain a safe lithium-ion secondary battery, an internal short circuit and an external short circuit are preferably inhibited even at a high charge voltage. In the positive electrode active material of one embodiment of the present invention, an internal short circuit is inhibited even at a high charge voltage. Thus, a lithium-ion secondary battery having a high discharge capacity and high safety can be obtained. Note that an internal short circuit of a lithium-ion secondary battery refers to contact between a positive electrode and a negative electrode inside the battery. An external short circuit of a lithium-ion secondary battery refers to contact between a positive electrode and a negative electrode outside the battery on the assumption that the battery is misused.

Note that the description is made on the assumption that materials (such as a positive electrode active material, a negative electrode active material, an electrolyte solution, and a separator) of a lithium-ion secondary battery have not deteriorated unless otherwise specified. A decrease in discharge capacity due to aging treatment and burn-in treatment during the manufacturing process of a lithium-ion secondary battery is not regarded as deterioration. For example, the case where discharge capacity is higher than or equal to 97% of the rated capacity of a lithium-ion secondary battery composed of a cell or assembled battery can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

In this specification and the like, in some cases, materials included in a lithium-ion secondary battery that have not deteriorated are referred to as initial products or materials in an initial state, and materials that have deteriorated (have discharge capacity lower than 97% of the rated capacity of a lithium-ion secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ions in the present invention, alkali metal ions or alkaline earth metal ions can be used, and specifically, sodium ions or the like can be used. In that case, the present invention can be understood by replacing lithium ions with sodium ions or the like. Also, in the case where there is no limitation on carrier ions, the term “secondary battery” is sometimes used.

### Embodiment 1

In this embodiment, structure examples of a secondary battery of one embodiment of the present invention are described.

### Structure Example of Secondary Battery

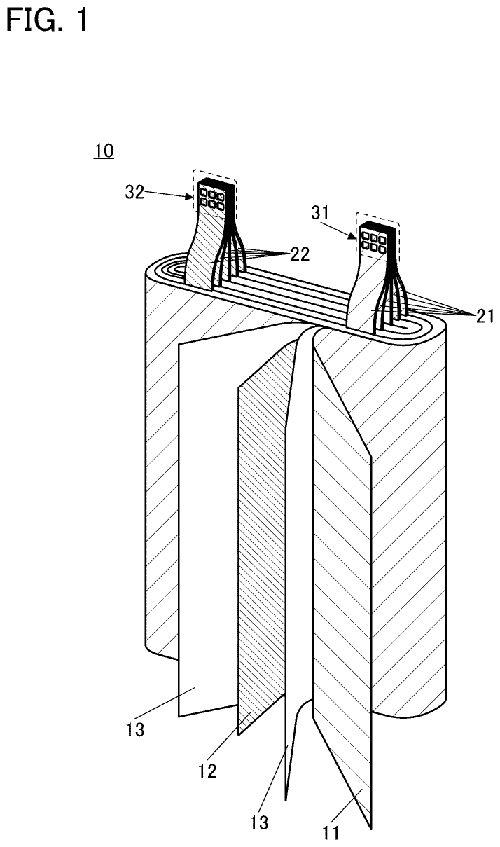

FIG. 1 illustrates a schematic view of a secondary battery 10 of one embodiment of the present invention. The secondary battery 10 includes a wound body obtained by winding a stack in which a positive electrode 11, a negative electrode 12, and two separators 13 are stacked. That is, the secondary battery 10 is a wound secondary battery.

The secondary battery 10 is housed in an exterior body (not illustrated) and is sealed after an electrolyte solution in which a salt containing carrier ions is dissolved is injected. As carrier ions included in the electrolyte solution, typically, lithium ions can be used. The secondary battery containing the lithium ions is referred to as a lithium-ion secondary battery.

The exterior body is preferably in the form of a film in terms of weight reduction, and the secondary battery that includes an exterior body in the form of a film can be referred to as a laminated secondary battery. In terms of achieving a high cooling function, the exterior body may be formed using a stacked-layer film of a polymer and a metal with high thermal conductivity. Specifically, it is preferable that polypropylene and aluminum be used as the polymer and the metal, respectively, and nylon or the like may additionally be provided outside the exterior body. Note that a metal can may be used as the exterior body, and in the case where a circular can case is used, the secondary battery is referred to as a coin-type secondary battery.

The positive electrode 11 includes a positive electrode current collector, and a positive electrode composition containing a positive electrode active material is applied to both surfaces of the positive electrode current collector. The negative electrode 12 includes a negative electrode current collector, and a negative electrode composition containing a negative electrode active material is applied to both surfaces of the negative electrode current collector. The separator 13 is provided between the positive electrode 11 and the negative electrode 12 and has a function of preventing an electrical short circuit therebetween.

As illustrated in FIG. 1, the positive electrode 11 is preferably positioned on the outer side of the negative electrode 12. One surface of the positive electrode 11 is preferably positioned on the outermost surface of the wound body. At that time, it is preferable that the positive electrode composition be not applied to part or the whole of the outermost surface of the wound body of the positive electrode 11. Here, typically, aluminum foil and copper foil can be used for the positive electrode current collector and the negative electrode current collector, respectively. At this time, in the case of using a stack of the aluminum foil and a resin film as the exterior body, part of the resin film might be damaged and the aluminum foil of the exterior body might be in contact with the wound body. At this time, when different kinds of metals are in contact with each other, corrosion might occur; thus, a metal used for the exterior body and a metal positioned on the outermost surface of the wound body are preferably the same kind of metal (here, aluminum).

The width of the negative electrode 12 is preferably larger than that of the positive electrode 11. Furthermore, the width of the separator 13 is preferably larger than those of the negative electrode 12 and the positive electrode 11. Accordingly, the positive electrode 11 is provided to be surrounded by the negative electrode 12 with the separator 13 therebetween, so that an internal short circuit between the positive electrode 11 and the negative electrode 12 can be prevented.

The positive electrode 11 includes two or more tabs 21. The negative electrode 12 includes two or more tabs 22. The tab 21 is part of the positive electrode current collector, and the tab 22 is part of the negative electrode current collector. The tab 21 and the tab 22 contain metals different from each other.

A plurality of tabs 21 are each a protruding portion provided in the positive electrode current collector of the positive electrode 11. The plurality of tabs 21 are provided in the positive electrode current collector so as to overlap with each other when a wound body is obtained through the winding process. Similarly, a plurality of tabs 22 are provided in the negative electrode current collector of the negative electrode 12 so as to overlap with each other when a wound body is obtained through the winding process.

A portion where all of the plurality of tabs 21 overlap with each other is bundled and bonded together. A region that includes the portion where the plurality of tabs 21 are bundled and bonded is referred to as a bonding portion 31. Similarly, a portion where all of the plurality of tabs 22 overlap with one another is bundled and bonded together, and this bonding portion is referred to as a bonding portion 32. As a bonding method, ultrasonic bonding can be used, for example. As illustrated in FIG. 1, the bonding portion 31 and the bonding portion 32 each preferably have a plurality of bonding marks. Accordingly, the secondary battery can have high mechanical strength and a low electric resistance.

Although not shown here, a lead may be connected to each of the plurality of tabs 21 and the plurality of tabs 22. For example, a lead connected to the positive electrode 11 may be bonded to the plurality of tabs 21 in the same bonding portion 31, or may be bonded to the plurality of tabs 21 in a position different from the bonding portion 31. The same applies to a lead connected to the negative electrode 12.

Here, it is important to wind up the stack including the positive electrode 11, the negative electrode 12, and the separators 13 with extremely higher accuracy than that of a conventional wound secondary battery so that the positions of the plurality of tabs 21 and the plurality of tabs 22 are not deviated through the winding process in fabricating the secondary battery illustrated in FIG. 1. For example, when the tension at the time of winding up is even slightly shifted, the tabs 21 and the tabs 22 might be in contact with each other.

When the plurality of tabs 21 and the plurality of tabs 22 are provided in this manner, unlike in a secondary battery including one tab 21 and one tab 22, a plurality of current paths are provided, so that the internal resistance of the secondary battery is reduced and the speed of charge and discharge can be easily improved. Furthermore, current concentration at the time of charge and discharge can be inhibited to prevent local temperature increase, so that not only increased safety but also inhibited deterioration can be achieved.

Here, as the positive electrode active material contained in the positive electrode 11, the positive electrode active material of one embodiment of the present invention including a high-resistance region in a region closer to the surface than to the center portion or the surface portion including the surface is preferably used. The use of such a positive electrode active material is preferable because even when the positive electrode 11 and the negative electrode 12 are short-circuited, current flowing into the positive electrode active material can be reduced and ignition, smoke, or the like can be inhibited. That is, the secondary battery of one embodiment of the present invention including such a positive electrode active material can be a secondary battery that is less likely to burn or does not burn even when an internal short circuit or an external short circuit occurs.

With such a structure, the secondary battery 10 with both high safety and a short charge and discharge time can be achieved. In addition, higher capacity can be achieved thanks to its high safety and high-speed charge and discharge. For example, in the case where a plurality of cells (secondary batteries) are collectively used as one module, the capacity of one cell can be increased; thus, the number of cells per module can be reduced, which leads to not only cost advantages but also a reduction in the weight of a module following a reduction in the number of components.

Next, more specific examples of structures of the tabs included in the secondary battery 10 are described.

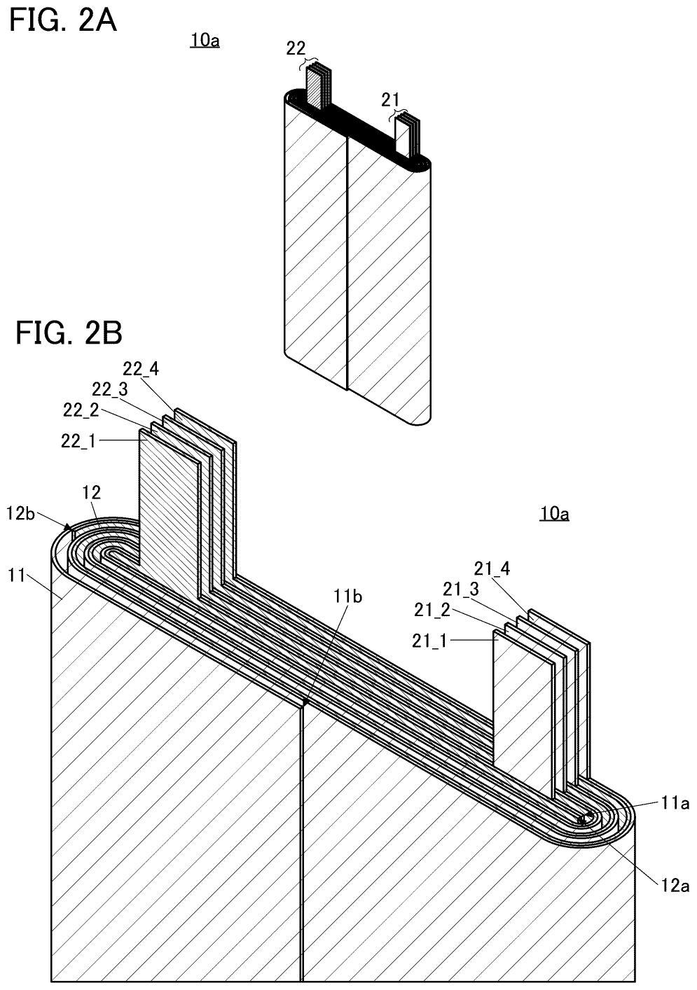

FIG. 2A is a schematic perspective view of a secondary battery 10a before the tabs are bonded. FIG. 2B is an enlarged view of a portion including the tabs 22 and the tabs 21 in FIG. 2A. Note that although the separators 13 are not illustrated in FIG. 2A and FIG. 2B so that the positions and shapes of the positive electrode 11 and the negative electrode 12 are easily understood, the separators 13 are actually provided between the positive electrode 11 and the negative electrode 12.

As illustrated in FIG. 2B, an example of the case where the positive electrode 11 includes four tabs (tabs 21_1 to 21_4) and the negative electrode 12 also includes four tabs (tabs 22_1 to 22_4) is shown here. Note that the number of the tabs is not limited thereto and may be two or more.

In FIG. 2B, two end portions (an end portion 11a and an end portion 11b) of the positive electrode 11 and two end portions (an end portion 12a and an end portion 12b) of the negative electrode 12 are indicated by arrows. The end portion 11a and the end portion 12a are each an end portion positioned on the center side of the winding, and the end portion 11b and the end portion 12b are each an end portion positioned on the outer side of the winding. Here, the center of the winding can also be referred to as the center of the spiral, and here, as the region including the end portion 11a and the end portion 12a. Note that the secondary battery described as an example here has a flat shape instead of a cylindrical shape; thus, a cross section of the wound body does not have a simple spiral shape.

The four tabs are provided in the positive electrode 11 in the order of the tab 21_1, the tab 212, the tab 213, and the tab 21_4 from the end portion 11a towards the end portion 11b. The four tabs are lined up in the order of the tab 21_1, the tab 21_2, the tab 213, and the tab 21_4 from the side close to the center of the winding.

Similarly, the four tabs are provided in the negative electrode 12 in the order of the tab 22_1, the tab 222, the tab 223, and the tab 22_4 from the end portion 12a towards the end portion 12b. The four tabs are lined up in the order of the tab 221, the tab 222, the tab 22_3, and the tab 22_4 from the side close to the center of the winding.

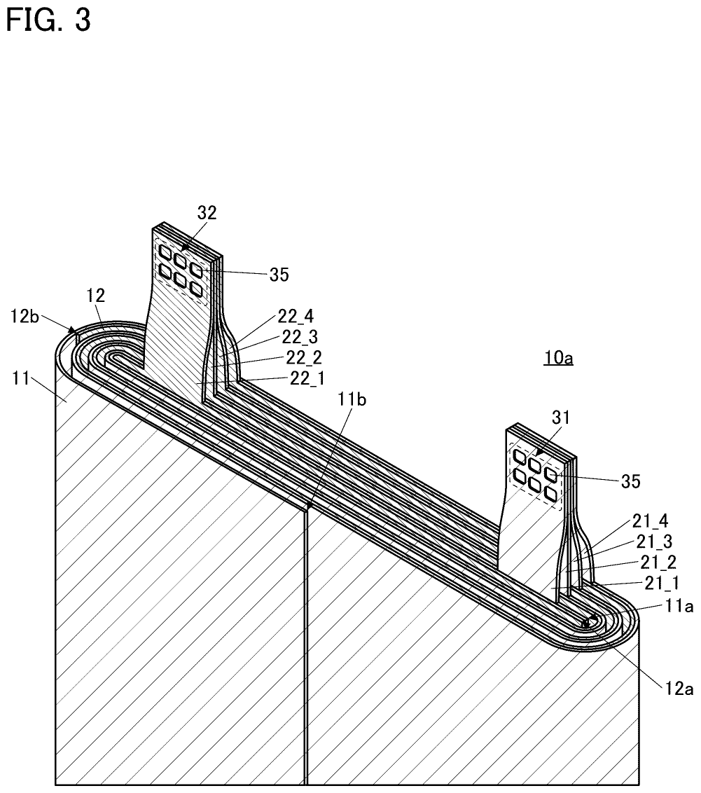

FIG. 3 is an enlarged view of the secondary battery 10a after bonding is performed. The tabs 21_1 to 21_4 of the positive electrode 11 are bonded in the bonding portion 31. The tabs 22_1 to 22_4 of the negative electrode 12 are bonded in the bonding portion 32. The bonding portion 31 includes a portion where all the tabs of the positive electrode 11 overlap with each other, and the bonding portion 32 includes a portion where all the tabs of the negative electrode overlap with each other. A plurality of bonding marks 35 are provided in each of the bonding portion 31 and the bonding portion 32.

In FIG. 3, the tab 21_2 is positioned between the tab 21_1 and the tab 21_3, and the tab 21_3 is positioned between the tab 21_2 and the tab 21_4. Similarly, the tab 22_2 is positioned between the tab 22_1 and the tab 223, and the tab 223 is positioned between the tab 22_2 and the tab 22_4.

The structure illustrated in FIG. 3 is an example in which one tab is placed every round of the positive electrode 11 and the negative electrode 12. Thus, the tabs are provided on only one side with reference to the center of the wound body, so that the thicknesses of the bonding portion 31 and the bonding portion 32 can be reduced.

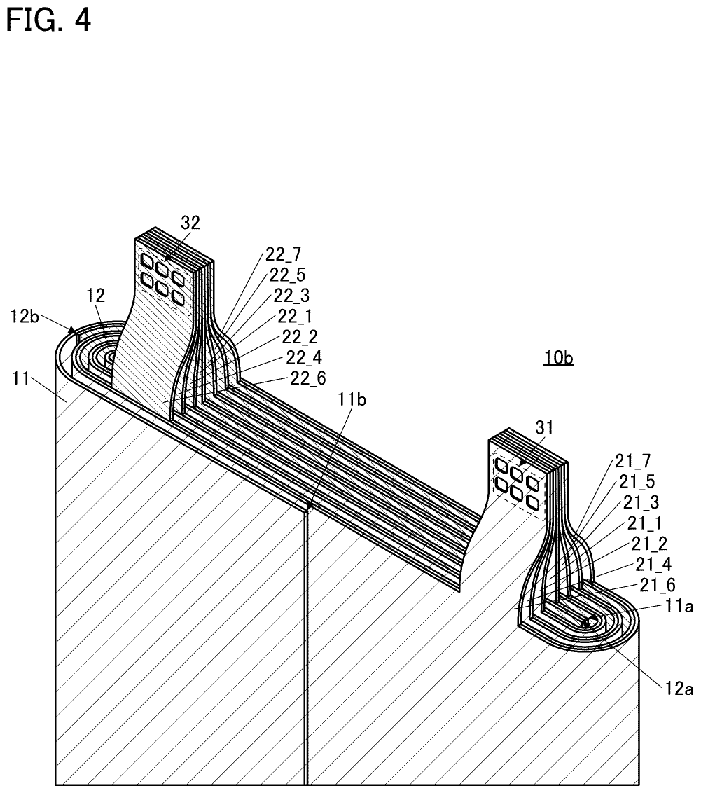

FIG. 4 illustrates an example of a secondary battery 10b in which one tab is placed every half round of the positive electrode 11 and the negative electrode 12.

The positive electrode 11 includes seven tabs (tabs 21_1 to 21_7), and the negative electrode 12 also includes seven tabs (tabs 22_1 to 22_7).

In the positive electrode 11, seven tabs are provided from the end portion 11a towards the end portion 11b in the order from the tab 21_1 to the tab 217 along the winding direction. The tab 21_1 is positioned between the tab 21_2 and the tab 21_3. The seven tabs are stacked in the order of the tab 214, the tab 212, the tab 21_1, the tab 21_3, the tab 215, and the tab 21_7 from the tab 21_6 towards the tab 21_7. That is, with the tab 21_1 as a center, there are a portion where even-numbered tabs are stacked and a portion where odd-numbered tabs are stacked.

In the negative electrode 12 like in the positive electrode 11, tabs are provided from the end portion 12a towards the end portion 12b in the order from the tab 22_1 to the tab 22_7 along the winding direction. The tab 221 is positioned between the tab 22_2 and the tab 22_3. The seven tabs are stacked in the order of the tab 224, the tab 22_2, the tab 22_1, the tab 223, the tab 225, and the tab 22_7 from the tab 22_6 towards the tab 22_7.

Since the interval between the placed tabs in the secondary battery 10b is shorter than that in the secondary battery 10a, not only can the internal resistance thereof be more effectively reduced but also heat generation can be more effectively inhibited.

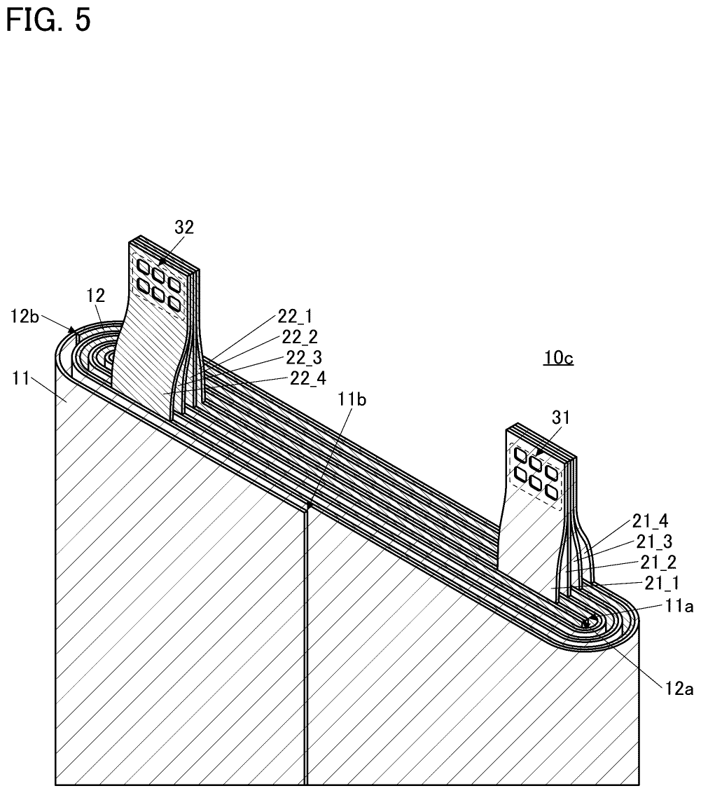

A secondary battery 10c illustrated in FIG. 5 is mainly different from the secondary battery 10a illustrated in FIG. 3 in positions of the plurality of tabs included in the negative electrode 12.

The tabs 22_2 to 22_4 included in the negative electrode 12 are provided on the opposite side of the tabs included in the positive electrode 11 in the wound body with the center of the wound body therebetween. With such a structure, the physical distance between the tabs included in the positive electrode 11 and the tabs included in the negative electrode 12 can be kept away; therefore, generation of an external short circuit due to the contact therebetween can be effectively inhibited.

Note that the number of the tabs, the positions of the tabs, the placement method of the tabs, and the like in the structures described above are only examples, and a variety of structures can be employed depending on the usage.

### [Tabs]

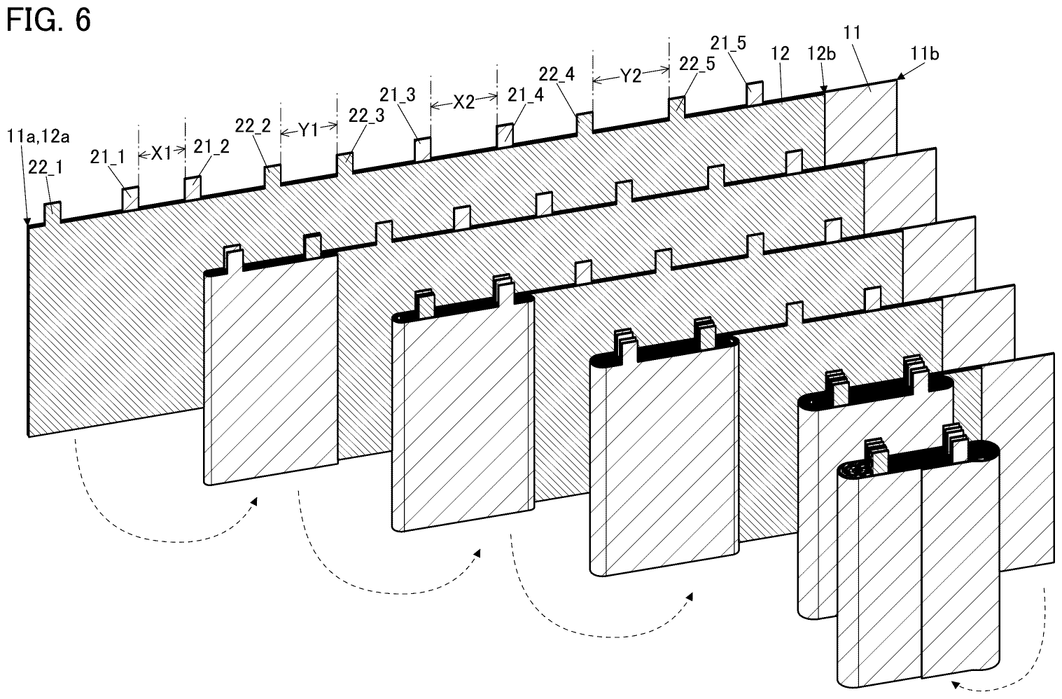

FIG. 6 illustrates states where the stack of the positive electrode 11 and the negative electrode 12 changes from a state before winding to a state after winding. FIG. 6 shows six states arranged in a time series from the upper left to the lower right.

Although not illustrated in FIG. 6, the stack includes two separators in order to insulate the positive electrode 11 and the negative electrode 12. At that time, as a stack before winding, a first separator, the positive electrode 11, a second separator, and the negative electrode 12 may be stacked in this order, i.e., the positive electrode 11 may be sandwiched between the two separators. At this time, a structure may be employed where one separator that is long in the longitudinal direction of the stack and folded in half is used instead of the two separators, and the positive electrode 11 is sandwiched such that the fold of the separator is positioned on the end portion 11a side of the positive electrode 11.

Alternatively, as a stack before winding, the positive electrode 11, the first separator, the negative electrode 12, and the second separator may be stacked in this order, i.e., the negative electrode 12 may be sandwiched between the two separators. At this time, a structure may be employed where a long separator is used as described above and the negative electrode 12 is sandwiched such that the fold is positioned on the end portion 12a side of the negative electrode.

In a state before winding (the upper left state in FIG. 6), the positive electrode 11 includes the five tabs (the tab 21_1 to the tab 21_5) from the end portion 11a towards the end portion 11b. The negative electrode 12 includes the five tabs (the tab 22_1 to the tab 22_5) from the end portion 12a towards the end portion 12b.

The ten tabs included in the stack are arranged in the order of the tab 22_1, the tab 21_1, the tab 212, the tab 22_2, the tab 223, the tab 213, the tab 214, the tab 224, the tab 22_5, and the tab 21_5 from the end portion 11a (the end portion 12a) side.

The two adjacent tabs are placed such that the interval therebetween is shorter as the tabs are closer to the center of the winding and is longer towards the outer side of the winding. For example, when the distance between the tab 21_1 and the tab 21_2 is X1 and the distance between the tab 21_3 and the tab 21_4 is X2, X2 is larger than X1. Similarly, when the distance between the tab 22_2 and the tab 22_3 is Y1 and the distance between the tab 22_4 and the tab 22_5 is Y2, Y2 is larger than Y1.

When winding up of the stack is performed, it is important to adjust the winding-up conditions so that the tabs included in the positive electrode 11 overlap with each other and the tabs included in the negative electrode 12 overlap with each other. For example, winding up is performed while the tension of each of the positive electrode 11, the negative electrode 12, and the two separators is adjusted. In this manner, when the winding process is completed, a wound body in which all the tabs included in the positive electrode 11 overlap with each other and all the tabs included in the negative electrode 12 overlap with each other can be obtained. After that, the wound body may be fixed with a non-flammable tape (e.g., a polyimide tape) so as to maintain this state.

### [Components]

### {Positive Electrode}

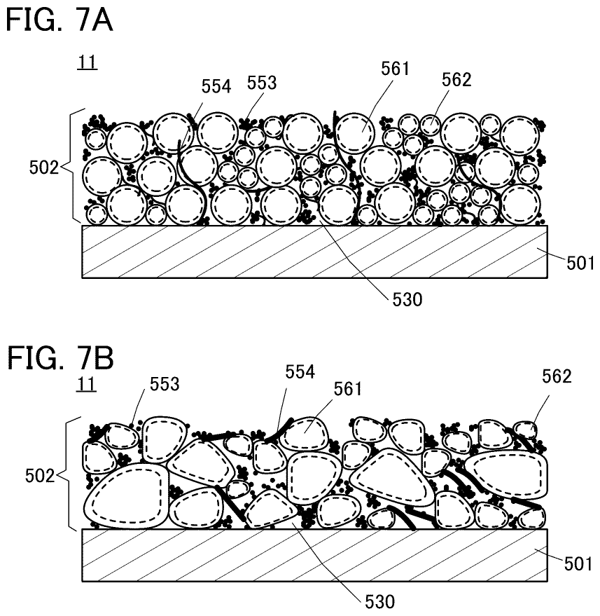

FIG. 7A shows an example of a cross-sectional view of the positive electrode 11 included in the secondary battery 10 or the like. The positive electrode 11 includes a positive electrode active material layer 502 over a positive electrode current collector 501. The positive electrode active material layer 502 includes a positive electrode active material 561, a positive electrode active material 562, a conductive material 553, a conductive material 554, and an electrolyte solution 530. The positive electrode active material layer 502 also includes a binder (not illustrated). The secondary battery may include any one of the conductive material 553 and the conductive material 554.

To increase the filling density, the positive electrode active materials with different median diameters (D50) are preferably included. Here, an example of including at least the positive electrode active material 561 and the positive electrode active material 562 with a smaller median diameter (D50) than the positive electrode active material 561 is illustrated.

The median diameter (D50) of the positive electrode active material 561 is greater than or equal to 1 μm and less than or equal to 50 μm, preferably greater than or equal to 5 μm and less than or equal to 30 μm. The median diameter (D50) of the positive electrode active material 562 is preferably greater than or equal to ⅙ and less than or equal to 1/10 of the median diameter (D50) of the positive electrode active material 561. When particle size distribution measurement is performed on an active material in which the positive electrode active material 561 and the positive electrode active material 562 are mixed, two peaks with different local maximum values are observed. Needless to say, two or more peaks may be observed. Note that it is possible to increase the filling density without including the positive electrode active material 562.

Each of the positive electrode active material 561 and the positive electrode active material 562 preferably includes a shell. A positive electrode active material including a shell can have a high insulating property and is less likely to enter thermal runaway. Although the boundary between a surface portion and an inner portion is indicated by a dotted line in FIG. 7A, the boundary is not always as clear as that in FIG. 7A. The positive electrode active materials are not limited to those in FIG. 7A and for example, any one of the positive electrode active material 561 and the positive electrode active material 562 includes the shell.

The active material of the positive electrode active material 561 may be the same as or different from the active material of the positive electrode active material 562. The same active materials contain the same main materials but may be different in the presence of an additive element or the like. Different active materials contain different main materials.

The positive electrode active material 561 and the positive electrode active material 562 each preferably contain an additive element, and in particular, the additive element is preferably contained in the shell. The additive element included in the shell may be unevenly distributed or thinly distributed in the inner portion. The uneven distribution refers to uneven presence or localized presence of the additive element. Therefore, a state where the concentration of the additive element increases from an inner portion towards a shell is sometimes referred to as uneven distribution of the additive element in the shell. Uneven distribution may be expressed as segregation or precipitation.

The positive electrode active material 561 and the positive electrode active material 562 are referred to as positive electrode active material particles. The positive electrode active material can have any of various shapes other than a particle shape. For example, FIG. 7A illustrates an example in which the positive electrode active material has a spherical shape and its cross section is circular. FIG. 7B illustrates an example in which the cross section is not circular.

Although the positive electrode active material 561 and the positive electrode active material 562 illustrated in FIG. 7A and FIG. 7B are primary particles, the positive electrode active material 561 and the positive electrode active material 562 may be secondary particles. In this specification, a primary particle refers to a particle (lump) of the smallest unit having no grain boundary when being observed, for example, at a magnification of 5000 times with a SEM (scanning electron microscope) or the like. That is, the primary particle is a particle of the smallest unit. A secondary particle refers to a particle in which the above-described primary particles are aggregated, partially sharing the grain boundary (the circumference of the primary particle or the like), and which is independent of another particle. That is, the secondary particle has a grain boundary. The surface portion of the secondary particle may be the surface portion of the whole secondary particle. The surface portion of the secondary particle may be the surface portion of the primary particles constituting the secondary particle.

The positive electrode active material described above and another positive electrode active material may be mixed to be used.

Other examples of the positive electrode active material include an oxide with an olivine crystal structure, a layered rock-salt crystal structure, a spinel crystal structure, or the like. For example, a compound such as LiFePO₄, LiFeO₂, LiNiO₂, LiMn₂O₄, V₂O₅, Cr₂O₅, or MnO₂ is given.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

The applicable another example of the positive electrode active material is a lithium-manganese composite oxide that can be represented by a composition formula LiaMnMcOd. Here, the element M is preferably silicon, phosphorus, or a metal element other than lithium and manganese, further preferably nickel. In the case where the whole particle of a lithium-manganese composite oxide is measured, it is preferable to satisfy the following at the time of discharge: 0<a/(b+c)<2; c>0; and 0.26≤(b+c)/d<0.5. Note that the proportions of metals, silicon, phosphorus, and the like in the whole particle of a lithium-manganese composite oxide can be measured with, for example, an ICP-MS (inductively coupled plasma mass spectrometer). The proportion of oxygen in the whole particle of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that a lithium-manganese composite oxide is an oxide containing at least lithium and manganese, and may contain one or two or more elements selected from a group consisting of chromium, cobalt, aluminum, nickel, iron, magnesium, molybdenum, zinc, indium, gallium, copper, titanium, niobium, silicon, phosphorus, and the like.

### {Conductive Material}

The conductive material has a function of giving aid to, for example, a current path between the active material and the current collector or a current path between a plurality of the active materials. In order to fulfill such a function, the conductive material preferably contains a material having lower resistance than the active material. The conductive material is also referred to as a conductive additive or a conductivity-imparting agent because of its function.

As the conductive material, a carbon material or a metal material is typically used. For example, as a particulate conductive material, carbon black (furnace black, acetylene black, graphite, and the like) is included. Carbon black mostly has a smaller grain diameter than the positive electrode active material. The conductive material may be fibrous. Examples of a fibrous conductive material include carbon nanotube (CNT) and VGCF (registered trademark). The conductive material may have a sheet-like shape such as multilayer graphene. The sheet-shaped conductive additive sometimes looks like a thread in observation of a cross section of a positive electrode.

The particulate conductive material can enter a gap of the positive electrode active material and the like and easily aggregates. Thus, the particulate conductive material can give aid to a conductive path between positive electrode active materials provided close to each other. Although having a bent region, the fibrous conductive material is larger than the positive electrode active material. The fibrous conductive material can thus give aid not only to a conductive path between adjacent positive electrode active materials but also to a conductive path between positive electrode active materials located apart from each other. Conductive materials in two or more forms as described above are preferably mixed.

FIG. 7A and FIG. 7B illustrate an example in which the positive electrode active material layer 502 contains sheet-like graphene or a graphene compound as the conductive material 554. As the conductive material 553, carbon black can be used, for example. Although the conductive material 554 is schematically illustrated by a thick line in FIG. 7A and FIG. 7B, the conductive material 554 is actually an extremely thin film having a thickness of a single layer or a multi-layer of carbon molecules. A plurality of sheets of graphene or graphene compounds are formed to partly cover the plurality of positive electrode active materials or to adhere to the surfaces of the plurality of positive electrode active materials. Accordingly, a conductive path can be efficiently formed even with a small amount, so that the internal resistance can be reduced.

### {Binder}

The binder functions as a binding agent that makes sure of the adhesion of the active material in a powder state without covering the surface of the active material. It is preferable that the binder be sufficiently flexible and resilient to a change in the state of the active material, in view of expansion of the active material. The binder also needs to show the compatibility with the electrolyte solution. Moreover, since an oxidation reaction and a reduction reaction that are extremely strong occur in a secondary battery, it is desirable that the binder not be degraded by the reactions or be less reactive to the reactions.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

### {Positive Electrode Current Collector}

The positive electrode current collector can be formed using a material that has high conductivity, such as a metal like stainless steel, gold, platinum, copper, aluminum, or titanium, or an alloy thereof. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### {Negative Electrode}

The negative electrode includes a negative electrode active material layer and a negative electrode current collector. The negative electrode active material layer may include a conductive material and a binder. As the negative electrode active material, for example, an alloy-based material, a carbon-based material, or the like can be used.

For the negative electrode active material, an element that enables charge and discharge reactions by an alloying reaction and a dealloying reaction with lithium can be used. For example, a material containing one or two or more selected from silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

As the carbon-based material, graphite, graphitizing carbon (soft carbon), non-graphitizing carbon (hard carbon), carbon nanotube, graphene, carbon black, or the like can be used.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N₃ is preferable because of its high charge and discharge capacity (900 mAh/g and 1890 mAh/cm³).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorine compounds such as FeF₃ and BiF₃.

For the conductive material and the binder that can be included in the negative electrode active material layer, materials similar to those for the conductive material and the binder that can be included in the positive electrode active material layer can be used.

### {Negative Electrode Current Collector}

For the negative electrode current collector, a material similar to that of the positive electrode current collector can be used. Note that a material that does not alloy with carrier ions of lithium or the like is preferably used for the negative electrode current collector.

### {Electrolyte Solution}

The electrolyte solution contains a solvent and a lithium salt. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

As the electrolyte solution, a mixed organic solvent containing a fluorinated cyclic carbonate (also referred to as a cyclic carbonate fluoride in some cases) or a fluorinated chain carbonate (also referred to as a chain carbonate fluoride in some cases) can be used. A fluorinated cyclic carbonate and a fluorinated chain carbonate each include a substituent with an electron-withdrawing property and have a low solvation energy of a lithium ion, which is preferable.

As a fluorinated cyclic carbonate, fluoroethylene carbonate (fluorinated ethylene carbonate, FEC, or F1EC), difluoroethylene carbonate (DFEC or F2EC), trifluoroethylene carbonate (F3EC), tetrafluoroethylene carbonate (F4EC), or the like can be used. Note that DFEC has isomers such as a cis-4,5 isomer and a trans-4,5 isomer. Each of these fluorinated cyclic carbonates includes a substituent with an electron-withdrawing property and is thus presumed to have a low solvation energy of a lithium ion. As the fluorinated chain carbonate, methyl 3,3,3-trifluoropropionate (MTFP) can be used, for example.

The use of one or more kinds of ionic liquids (room temperature molten salts) which have features of non-flammability and non-volatility as the solvent of the electrolyte solution can prevent a secondary battery from exploding and/or ignition even when the internal temperature increases due to an internal short circuit or overcharging of the secondary battery, for example. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

### {Electrolyte}

As a lithium salt (also referred to as an electrolyte) dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), and LiN(C₂F₅SO₂)₂ can be used, or two or more of these lithium salts can be used in an appropriate combination in an appropriate ratio. The lithium salt is preferably dissolved in the solvent at greater than or equal to 0.5 mol/L and less than or equal to 3.0 mol/L. Using a fluoride such as LiPF₆ or LiBF₄ enables a lithium-ion secondary battery to have improved safety.

Note that instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator and/or a spacer is not necessary. Furthermore, the battery can be entirely solidified; therefore, there is no possibility of liquid leakage and thus the safety of the battery is dramatically improved.

### {Separator}

The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

### {Exterior Body}

For an exterior body included in the secondary battery, at least one of metal materials such as aluminum and a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The above is the description of the components of the secondary battery.

### [Thermal Runaway of Secondary Battery]

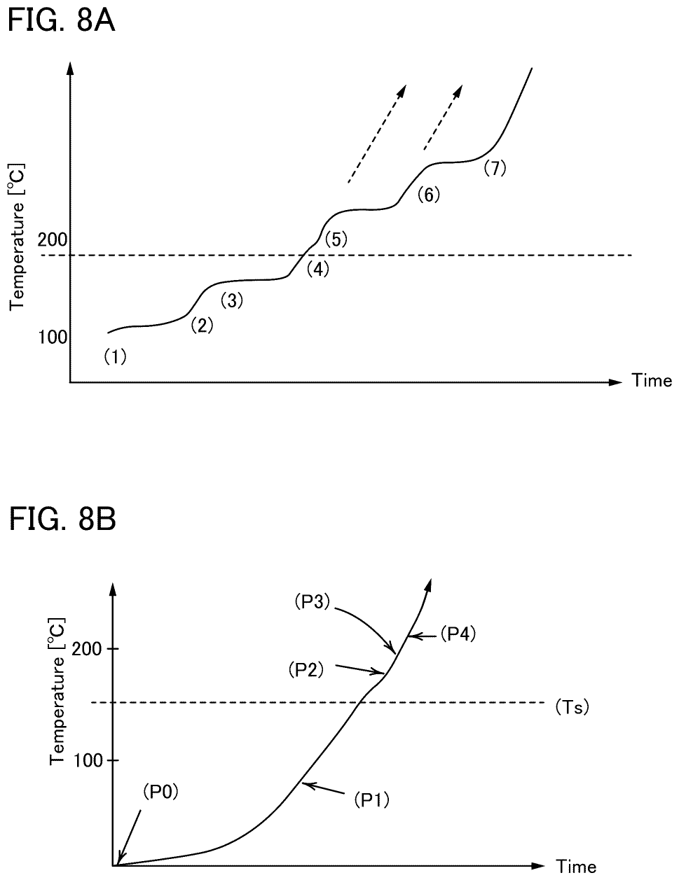

The mechanism of thermal runaway of a secondary battery is described with reference to FIG. 8A showing a graph cited from [FIG. 2-11] on page 69 of Non-Patent Document 6, which is partly retouched. A secondary battery as described above enters thermal runaway after passing through several states when the temperature (specifically, the internal temperature) increases during charge, for example. FIG. 8A is a graph showing the temperature of a secondary battery with respect to time. When the temperature of the secondary battery reaches 100° C. or the vicinity thereof, for example, (1) collapse of a SEI (Solid Electrolyte Interphase) of a negative electrode and heat generation are caused. When the temperature of the secondary battery exceeds 100° C., (2) reduction of an electrolyte solution by the negative electrode (the negative electrode is C₆Li when graphite is used) and heat generation are caused, and (3) oxidation of the electrolyte solution by a positive electrode and heat generation are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change in a positive electrode active material) are caused. After that, when the temperature of the secondary battery exceeds 200° C., (6) decomposition of the negative electrode is caused, and finally, (7) the positive electrode and the negative electrode come into direct contact with each other. The secondary battery enters thermal runaway after passing through such states, specifically the state (5), the state (6), or the state (7).

To prevent thermal runaway, it is considered to be preferable that an increase in the temperature of the secondary battery be inhibited and components of the secondary battery (e.g., negative electrode, positive electrode, and electrolyte solution) be stable at high temperatures.

### [Nail Penetration Test]

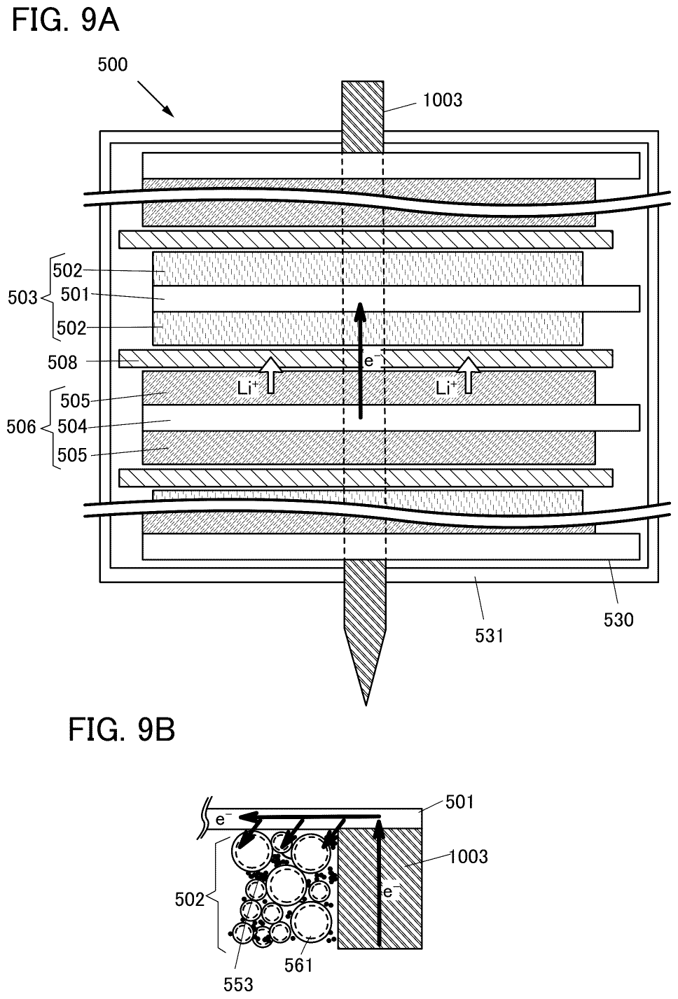

Next, the nail penetration test is described with reference to FIG. 9A, FIG. 9B, and the like. In the nail penetration test, a secondary battery 500 being in a fully charged state (a state at 100% state of charge (SOC)), a nail 1003 having a predetermined diameter in the range of 2 mm to 10 mm penetrates the secondary battery at a predetermined speed. The nail penetrating speed can be, for example, greater than or equal to 1 mm/s and less than or equal to 20 mm/s. FIG. 9A is a cross-sectional view illustrating the state where the nail 1003 penetrates the secondary battery 500. The secondary battery 500 has a structure in which a positive electrode 503, a separator 508, a negative electrode 506, and an electrolyte solution 530 are held in an exterior body 531. The positive electrode 503 includes a positive electrode current collector 501 and positive electrode active material layers 502 formed over both surfaces of the positive electrode current collector 501, and the negative electrode 506 includes a negative electrode current collector 504 and negative electrode active material layers 505 formed over both surfaces of the negative electrode current collector 504. FIG. 9B illustrates an enlarged view of the nail 1003 and the positive electrode current collector 501 and the positive electrode active material 561 and the conductive material 553 included in the positive electrode active material layer 502 are also illustrated.

As illustrated in FIG. 9A and FIG. 9B, when the nail 1003 penetrates the positive electrode 503 and the negative electrode 506, an internal short circuit occurs. This makes the potential of the nail 1003 equal to that of the negative electrode, so that an electron (e⁻) flows to the positive electrode 503 through the nail 1003 and the like as indicated by the arrows and Joule heat is generated in the portion of the internal short circuit and the vicinity thereof. The internal short circuit causes carrier ions extracted from the negative electrode 506, typically lithium ions (Li⁺), are released into the electrolyte solution as the white arrows. Here, in the case where anions are insufficient in the electrolyte solution 530, the electrical neutrality of the electrolyte solution 530 is not maintained when lithium ions are extracted from the negative electrode 506 to the electrolyte solution 530, so that the electrolyte solution 530 starts decomposing to maintain the electrical neutrality. This is one of electrochemical reactions and is referred to as a reduction reaction of an electrolyte solution by a negative electrode.

The Joule heat sometimes increases the temperature of the secondary battery 500. At this time, in the case where lithium cobalt oxide is used for the positive electrode active material, the crystal structure of the lithium cobalt oxide might be changed, and heat generation is further caused in some cases.

Then, the electron (e⁻) that flows to the positive electrode 503 reduces Co, which is tetravalent in the lithium cobalt oxide in the charged state, to trivalent or divalent Co, and oxygen is released from the lithium cobalt oxide by this reduction reaction. An oxidation reaction due to the oxygen decomposes the electrolyte solution 530. This is one of electrochemical reactions and is referred to as an oxidation reaction of an electrolyte solution by a positive electrode. The speed at which a current flows to the positive electrode active material 561 or the like varies depending on the insulating property of the positive electrode active material, and it can also be deemed that the speed at which a current flows affects the above electrochemical reaction.

When an internal short circuit of a secondary battery occurs, it is considered that the temperature changes as shown in the graph of FIG. 8B. FIG. 8B is the graph cited from [FIG. 2-12] on page 70 of Non-Patent Document 6, which is partly retouched and is a graph of the temperature (specifically, the internal temperature) of a secondary battery with respect to time. When an internal short circuit at (P0) is caused, the temperature of the secondary battery increases over time. As shown in (P1), when heat generation due to Joule heat continues until the temperature of the secondary battery reaches the vicinity of 100° C., the temperature exceeds the reference temperature (Ts) of the secondary battery, which is the limit temperature that does not lead to thermal runaway. Then, reduction of an electrolyte solution by a negative electrode (the negative electrode is C₆Li when graphite is used) and heat generation are caused at (P2), oxidation of the electrolyte solution by a positive electrode and heat generation are caused at (P3), and heat generation due to thermal decomposition of the electrolyte solution is caused at (P4). Accordingly, the secondary battery enters thermal runaway, resulting in ignition, smoking, or the like.

To prevent the occurrence of smoking, heat generation, or the like in the nail penetration test, it is considered important that an increase in the temperature of the secondary battery be suppressed and members constituting the secondary battery (e.g., the negative electrode, the positive electrode, and the electrolyte solution) be stable at high temperatures. Specifically, it is preferable that the positive electrode active material have a stable structure from which no oxygen is released even when being exposed at high temperatures. Alternatively, the positive electrode active material preferably has a structure in which a current flows to the active material at a low speed. As described later, the positive electrode active material 100 of one embodiment of the present invention can have both the above stable structure in which a current flows at a low speed.

### [Positive Electrode Active Material]

Next, the positive electrode active material 100 of one embodiment of the present invention is described. As the positive electrode active material 100, a compound which contains oxygen and a transition metal, into and from which carrier ions, typically lithium ions (Li⁺), can be inserted and extracted, is used. As the transition metal, one or two or more selected from cobalt (Co), nickel (Ni), manganese (Mn), iron (Fe), and the like can be used. For example, as a compound in which Co is used as the transition metal, lithium cobalt oxide can be used for the positive electrode active material 100. The positive electrode active material 100 described below as an example can be used for the positive electrode of the above-described secondary battery.

The positive electrode active material 100 of one embodiment of the present invention preferably includes a region having an insulating property or a region having high resistance. It can be said that the positive electrode active material 100 including the region has a structure in which a rapid current is less likely to flow. Note that the region is sometimes referred to as a first region to be distinguished from other regions. It is preferable that the above region have a narrow width of greater than or equal to 1 nm and less than or equal to 2θ nm, further preferably greater than or equal to 2 nm and less than or equal to 10 nm, still further preferably greater than or equal to 2 nm and less than or equal to 5 nm in a cross-sectional view, and these values can each be regarded as the thickness or width of the first region in the cross-sectional view. The narrow region is sometimes referred to as a “shell” in this specification and the like. A cross-sectional STEM image can be used as the cross-sectional view, for example.

The shell is preferably included in the surface portion of the positive electrode active material 100. The positive electrode active material 100 including such a shell is preferable because a current flowing to the positive electrode active material can be reduced even in the case where the nail penetration test is conducted, inhibiting ignition, smoking, or the like. In order to reduce a current flowing to the positive electrode active material, the shell is preferably positioned on an outer side or a surface side of the surface portion of the positive electrode active material 100.

The shell preferably contains an additive element added to the positive electrode active material 100. As examples of the added element, titanium, zirconium, vanadium, iron, manganese, chromium, niobium, arsenic, zinc, silicon, sulfur, phosphorus, boron, bromine, beryllium, and the like are given in addition to magnesium, fluorine, nickel, and aluminum. Magnesium is one of the suitable elements for the shell, and fluorine is considered to be one of the elements preferable for adding magnesium to the positive electrode active material 100. Note that the additive element is preferably included in the surface portion. Specifically, the crystal structure of the positive electrode active material 100 can be stabilized.

A structure of the shell is described using magnesium. In the cross-sectional view of the surface portion of the positive electrode active material 100, magnesium is preferably present in a region having a narrow width of greater than or equal to 1 nm and less than or equal to 2θ nm, further preferably greater than or equal to 2 nm and less than or equal to 10 nm, still further preferably greater than or equal to 2 nm and less than or equal to 5 nm, and the narrow region is referred to as a shell. The shell preferably contains cobalt, in which case the shell allows insertion and extraction of lithium ions (Li⁺) and a reduction in speed of a current that flows owing to an internal short-circuit. In other words, the surface portion of the positive electrode active material 100 preferably has the first region and a second region; magnesium is preferably contained at least in the first region, and magnesium is not necessarily contained in the second region. Furthermore, the first region is preferably positioned outer side of or on the surface side of the positive electrode active material 100 as compared with the second region. Cobalt contained in the first region and the second region probably allows insertion and extraction of lithium ions (Li⁺).

The above-described shell may be provided to sufficiently cover the entire positive electrode active material 100, or may be provided such that a specific region of the positive electrode active material 100 is thick. For example, the shell can be provided to be thick along a plane other than the (001) plane of the layered rock-salt lithium cobalt oxide.

Note that the shell may be positioned anywhere in the positive electrode active material 100 as long as ignition does not occur in the nail penetration test, and magnesium may be present in the whole surface portion as long as insertion and extraction of lithium ions (Li⁺) are allowed and the speed at which a current flows owing to an internal short circuit can be made lower.

Lithium cobalt oxide containing one or two or more selected from the above additive elements is preferably used for the positive electrode active material 100. The additive element has a function of stabilizing the positive electrode active material 100 more, and thus release of oxygen from the lithium cobalt oxide can be inhibited, improving thermal stability. Specifically, when lithium cobalt oxide containing Mg is used for the positive electrode active material 100, the crystal structure can be stabilized, oxygen release can be inhibited, and the thermal stability can be increased. Furthermore, when the lithium cobalt oxide containing Mg is used for the positive electrode active material 100, the insulating property can be increased and thermal runaway is less likely to occur. In addition to Mg, F may be contained as the additive element; thus, release of oxygen from a plane other than the (001) plane is inhibited, thermal stability can be improved, and a structure in which thermal runaway is less likely to occur can be obtained.

The concentration of the additive element is discussed. For example, Mg, which is the additive element, is preferably greater than or equal to 0.5 atomic % (referred to as at %) and less than or equal to 30 at %, further preferably greater than or equal to 1.5 at % and less than or equal to 10 at % in the surface portion of the lithium cobalt oxide. The above Mg concentration can be specified by EDX linear analysis or the like. Mg existing at a high concentration in the whole surface portion would enhance the insulating property, making it difficult to achieve favorable battery characteristics in a charge and discharge cycle test or the like. By contrast, Mg preferably exists at an appropriate concentration in an appropriate region such as the shell in the surface portion, in which case the lithium cobalt oxide can be stabilized and heat generation and smoking in the above-described nail penetration test or the like can be inhibited. In addition, Mg existing at an appropriate concentration in the surface portion is expected to increase the hardness of the lithium cobalt oxide.

The position of the additive element is discussed. Mg or the like preferably exists at a high concentration in the surface portion. If Mg is present at a high concentration in the inner portion than the surface portion, the discharge capacity might be decreased. Therefore, for example, Mg is preferably at least in the surface portion or in the shell. That is, Mg is preferably positioned on the surface side as compared with other additive elements.

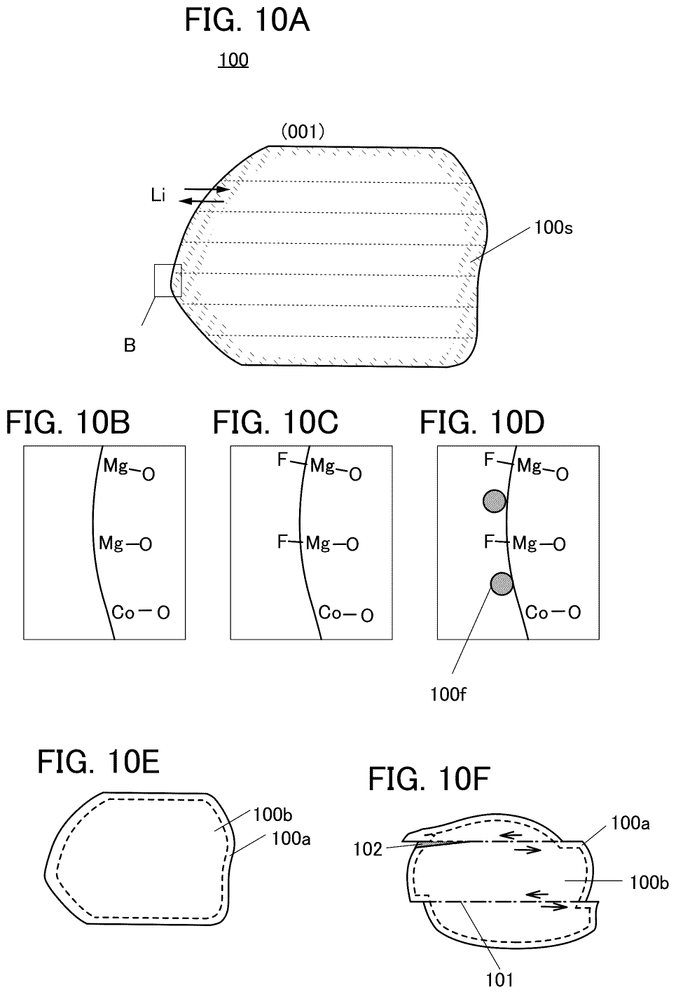

FIG. 10A is a cross-sectional view of the positive electrode active material 100 of one embodiment of the present invention. As illustrated in FIG. 10A, the positive electrode active material 100 of one embodiment of the present invention preferably includes a shell 100s. The shell 100s preferably exists narrowly. Furthermore, the width of the shell 100s on a plane into and from which lithium can be inserted and extracted, that is, a plane other than the (001) plane, is larger than that on the (001) plane. In other words, when the shell 100s is provided on the plane other than the (001) plane, release of oxygen from the plane other than the (001) plane can be inhibited in some cases.

In this specification and the like, the (001) plane, the (003) plane, and the like are sometimes collectively referred to as the (001) plane. In this specification and the like, the (001) plane is sometimes referred to as a C-plane, a basal plane, or the like. In lithium cobalt oxide, lithium has a two-dimensional diffusion path. In other words, the diffusion path of lithium exists along the basal plane. In this specification and the like, a plane where a lithium diffusion path is exposed, i.e., a plane where lithium is inserted and extracted, specifically, a plane other than the (001) plane, is sometimes referred to as an edge plane.

In the case where the positive electrode active material 100 of one embodiment of the present invention further contains Ni as the additive element, the region containing Mg and the region containing Ni are preferably overlapped, connected, or continuously in contact with each other on a plane into and from which lithium can be inserted and extracted, i.e., a plane other than (001). In other words, it is preferable that Ni also be present in the shell. This structure can inhibit release of oxygen from the positive electrode active material or a structural change of the positive electrode active material.

FIG. 10B to FIG. 10D are enlarged conceptual diagrams of a region B indicated by the rectangle in FIG. 10A. Lithium cobalt oxide containing Mg is given as an example of the positive electrode active material 100, here. As shown in FIG. 10B, Mg as one of the additive elements is preferably bonded to oxygen in the shell. Furthermore, the shell preferably contains Co and Co is preferably bonded to oxygen. It is deemed that by the shell shown in FIG. 10B, a rapid current flow owing to an internal short circuit can be inhibited while insertion and extraction of lithium ions (Li⁺) are allowed.

Next, lithium cobalt oxide containing Mg and F is given as an example of the positive electrode active material 100. As shown in FIG. 10C, F as one of the additive elements does not necessarily exist in the shell and is preferably adsorbed onto the surface of the positive electrode active material 100. It is known that fluorine has high electronegativity and is likely to form stable compounds with many kinds of element. Inside the battery, the positive electrode active material 100 is immersed in the electrolyte solution; thus, fluorine adsorbed onto the surface of the positive electrode active material 100 can react with the electrolyte solution near the fluorine, for example, which would inhibit thermal decomposition of the electrolyte solution or the like even in the case where an internal short circuit occurs.

As shown in FIG. 10D, a fluorine compound 100f may be adsorbed onto the surface of the positive electrode active material 100, which is the lithium cobalt oxide containing Mg and F. It is known that fluorine has high electronegativity and is likely to form stable compounds with many kinds of element. The positive electrode active material 100 is immersed in the electrolyte solution; thus, the fluorine compound 100f adsorbed onto the surface of the positive electrode active material 100 can react with the electrolyte solution near the fluorine compound 100f, for example, which would inhibit thermal decomposition of the electrolyte solution or the like even when an internal short circuit occurs.

The above adsorption includes chemical adsorption or physical adsorption. Chemical adsorption refers to formation of a chemical bond due to a chemical reaction between at least one of the additive elements and the surface of the positive electrode active material 100, whereas physical adsorption refers to adsorption due to intermolecular force (Van der Waals force) exerted between at least one of the additive elements and the surface of the positive electrode active material 100.

Although not illustrated, the positive electrode active material 100 may contain fluorine forming a solid solution; for example, fluorine may be substituted for some oxygen of the lithium cobalt oxide. Fluorine forming a solid solution exists in the surface portion of the lithium cobalt oxide and may exist in the shell. When the positive electrode active material 100 contains sufficient fluorine, fluorine adsorbed onto the surface and fluorine substituted for some oxygen coexist.

FIG. 10E and FIG. 10F each illustrate an example of a positive electrode active material in which a boundary between a surface portion 100a and a bulk 100b is indicated by a dashed line. In this manner, the surface portion is distinguished from the inner portion, and the surface portion includes the surface. Note that in this specification and the like, a surface portion of the positive electrode active material 100 refers to a region extending vertically or nearly vertically from the surface to a depth of less than or equal to 2θ nm or to a depth of less than or equal to 50 nm towards the inner portion. The surface portion can be rephrased as the vicinity of a surface and a region in the vicinity of a surface. Note that “vertically” or “nearly vertically” specifically refers to a range of 800 or more and 100° or less from the surface. A region in a deeper position than the surface portion of the positive electrode active material is referred to as an inner portion. The inner portion is rephrased as a bulk or a core.

Furthermore, in FIG. 10F, a crystal grain boundary 101 by a dashed-dotted line is added. A crystal having a layered crystal structure typified by a layered rock-salt crystal structure has a feature that cleavage is likely to occur along a plane (here, the basal plane) parallel to a layer. Therefore, the crystal grain boundary 101 is likely to be formed parallel to the basal plane. A crack is formed in FIG. 10F and a filling portion 102 that is formed to fill the crack is illustrated. In a portion where a crack is formed in the positive electrode active material 100, the cleavage plane (i.e., the plane parallel to the basal plane) is likely to be exposed.

The positive electrode active material 100 may contain magnesium in the entire surface portion, and for example, a larger amount of magnesium exists in the surface portion of the lithium cobalt oxide than in the inner portion of the lithium cobalt oxide. The lithium cobalt oxide containing magnesium has a feature that the crystal structure is less likely to be broken when the battery is charged with high voltage.

The positive electrode active material 100 may contain nickel. Nickel exists in the inner portion of lithium cobalt oxide in some cases. When fluorine and magnesium exist in the inner portion of the lithium cobalt oxide, the discharge capacity of the positive electrode active material might be decreased; however, even when nickel exists in the inner portion of the lithium cobalt oxide, a decrease in discharge capacity is less likely to occur. Thus, when the lithium cobalt oxide containing nickel in the inner portion is charged with high voltage without decreasing the discharge capacity, the effect that the crystal structure is less likely to break can be obtained.

When breakage of the crystal structure is inhibited, oxygen is less likely to be released from the positive electrode active material, specifically, the lithium cobalt oxide. Thus, in the case where the lithium cobalt oxide containing the additive element such as fluorine is used for the positive electrode of the lithium-ion secondary battery, heat generation is inhibited even when an internal short circuit occurs; thus, the effect that thermal runaway is less likely to occur is obtained.

The lithium cobalt oxide is composed of a lithium layer (sometimes referred to as a lithium site) and an octahedron of an oxygen atom. The octahedron of the oxygen atom can be referred to as an octahedral structure with cobalt coordinated to six oxygen atoms and is sometimes referred to as a CoO₂ layer. The lithium layer of the lithium cobalt oxide forms a plane, and lithium ions can move on the plane in accordance with charge and discharge. (001) in the drawing refers to a (001) plane of the lithium cobalt oxide. LiCoO₂ belongs to a space group R-3m.

Examples of a fluoride contained in the lithium-ion secondary battery include, as described later, LiPF₆ and LiBF₄ as lithium salts and polyvinylidene fluoride (PVDF) as a binder. Fluorine from such a fluoride may be adsorbed onto the surface of the positive electrode active material 100.

### [Surface of Positive Electrode Active Material]

A surface of the positive electrode active material 100 refers to a surface of a composite oxide including the surface portion 100a and the bulk 100b. Such a surface can be observed in a cross section. Thus, the surface of the positive electrode active material 100 does not contain a material to which a metal oxide that does not contain a lithium site contributing to charge and discharge, such as aluminum oxide (Al₂O₃), is attached, or a carbonate, a hydroxy group, or the like which is chemically adsorbed after formation of the positive electrode active material. The attached metal oxide refers to, for example, a metal oxide whose crystal orientation is not aligned with a crystal orientation of the bulk 100b.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium are present and a region where oxygen and the transition metal Mare absent is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Thus, the surface of the positive electrode active material in, for example, STEM-EDX linear analysis refers to a point where the value of the amount of the detected transition metal M is equal to 50% of the sum of the average value M_{AVE} of the amount of the detected transition metal Min the inner portion and the average value M_{BG} of the amount of the background transition metal M and a point where a value of the amount of the detected oxygen is equal to 50% of the sum of the average value O_{AVE} of the amount of detected oxygen in the inner portion and the average value O_{BG} of the amount of background oxygen. Note that in the case where the positions of the points of 50% of the sum of the detected amount in the inner portion and the background amount differ between the transition metal M and oxygen, the difference is probably due to the influence of a carbonate, a metal oxide containing oxygen, or the like, which is attached to the surface. Thus, the point that is equal to 50% of the sum of the average value M_{AVE} of the amount of the detected transition metal Min the inner portion and the average value M_{BG} of the amount of the background transition metal M can be used. In the case of a positive electrode active material containing a plurality of transition metals M, its surface can be determined using M_{AVE} and M_{BG} of an element whose count number is the largest in the bulk 100b.

The average value M_{BG} of the amount of the background transition metal M can be calculated by averaging the amount in the range greater than or equal to 2 nm, preferably greater than or equal to 3 nm, which is outside a portion in the vicinity of the portion at which the amount of the detected transition metal M begins to increase, for example. The average value M_{AVE} of the amount of the detected transition metal M in the inner portion can be calculated by averaging the amount in the range greater than or equal to 2 nm, preferably greater than or equal to 3 nm in a region where the count numbers of the transition metals M and oxygen atoms are saturated and stabilized, e.g., a portion that is greater than or equal to 30 nm, preferably greater than 50 nm in depth from the portion where the amount of the detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. Alternatively, the surface refers to an intersection of a tangent drawn at a luminance profile from the surface towards the bulk and an axis in the depth direction in a STEM image. The surface in a STEM image or the like may be determined in combination with analysis with higher spatial resolution.

The spatial resolution of STEM-EDX is approximately 1 nm. Thus, the maximum value of an additive element profile may be shifted by approximately 1 nm. For example, even when the maximum value of the profile of the additive element such as magnesium is outside the surface determined in the above-described manner, it can be said that a difference between the maximum value and the surface can be referred to as within the margin of error as long as the difference is less than 1 nm.

A peak in STEM-EDX line analysis refers to the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by measurement by scanning six times can be used as the profile of each element. The number of scanning is not limited to six and an average obtained by performing scanning seven or more times can be used as the profile of each element.

STEM-EDX line analysis can be performed as follows, for example. First, a protective film is deposited over a surface of a positive electrode active material. For example, carbon can be deposited with an ion sputtering apparatus (MC1000, produced by Hitachi High-Tech Corporation).

Next, the positive electrode active material is thinned to form a cross-section sample to be subjected to STEM analysis. For example, the positive electrode active material can be thinned with an FIB-SEM apparatus (XVision 200TBS, produced by Hitachi High-Tech Corporation). Here, picking up can be performed by a MPS (micro probing system), and an accelerating voltage at final processing condition can be, for example, 10 kV.

The STEM-EDX line analysis can be performed with a STEM apparatus (HD-2700 produced by Hitachi High-Tech Corporation) and Octane T Ultra W (with two detectors) produced by EDAX Inc can be used as EDX detectors. In the EDX line analysis, the emission current of the STEM apparatus is set to be greater than or equal to 6 μA and less than or equal to 10 μA, and a portion of the thinned sample, which is not positioned at a deep level and has little unevenness, is measured. The magnification is 150,000 times, for example. The EDX line analysis can be performed under conditions where drift correction is performed, the line width is 42 nm, the pitch is 0.2 nm, and the number of frames is six or more.

The crystal grain boundary 101 refers to, for example, a portion where particles of the positive electrode active material 100 adhere to each other or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. The crystal defect refers to a defect that can be observed in a cross-sectional TEM (transmission electron microscope) image, a cross-sectional STEM image, or the like, i.e., a structure containing another atom between lattices, a hollow, or the like. The crystal grain boundary 101 can be regarded as one of plane defects. The vicinity of the crystal grain boundary 101 refers to a region within 10 nm from the crystal grain boundary 101.

### [Contained Elements]

The positive electrode active material 100 contains lithium, cobalt, oxygen, and an additive element. Alternatively, the positive electrode active material 100 can contain lithium cobalt oxide (LiCoO₂) to which an additive element is added. Note that the positive electrode active material 100 of one embodiment of the present invention contains a crystal structure described later. Thus, the composition of the lithium cobalt oxide is not strictly limited to Li:Co:O=1:1:2.

A positive electrode active material of a lithium-ion secondary battery needs to contain a transition metal which can take part in an oxidation-reduction reaction in order to maintain a neutrally charged state even when lithium ions are inserted and extracted. It is preferable that the positive electrode active material 100 of one embodiment of the present invention mainly contain cobalt as the transition metal taking part in an oxidation-reduction reaction. In addition to cobalt, at least one or two selected from nickel and manganese may be used.

Using cobalt at higher than or equal to 75 at %, preferably higher than or equal to 90 at %, further preferably higher than or equal to 95 at % as the transition metal contained in the positive electrode active material 100 brings many advantages such as relatively easy synthesis, easy handling, and excellent cycle performance, which is preferable. When cobalt is used as the transition metal contained in the positive electrode active material 100 at greater than or equal to 75 at %, preferably greater than or equal to 90 at %, further preferably greater than or equal to 95 at %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the orbital of the d transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, this increases a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As already described above, as the additive element contained in the positive electrode active material 100, one or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used. The total percentage of the transition metal among the additive elements is preferably less than 25 at %, further preferably less than 10 at %, still further preferably less than 5 at %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element may be formed a solid solution with the positive electrode active material 100, and is preferably formed a solid solution with the surface of the positive electrode active material 100, for example. Thus, in STEM-EDX line analysis, for example, a position where the amount of the detected additive element increases is preferably at a deeper level than a position where the amount of the detected transition metal M increases, i.e., on the inner portion side of the positive electrode active material 100.

In this specification and the like, the depth at which the amount of detected element increases in STEM-EDX line analysis refers to the depth at which a measured value, which can be determined not to be a noise in terms of intensity, spatial resolution, and the like, is successively obtained.

Such an additive element further stabilizes the crystal structure of the positive electrode active material 100 as described later, so that ignition or the like due to an internal short circuit can be inhibited. In this specification and the like, the additive element can be rephrased as a mixture or part of a raw material.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

For example, when the positive electrode active material 100 is substantially free from manganese, the above advantages such as relatively easy synthesis, easy handling, and excellent cycle performance are sometimes enhanced. The weight of manganese contained in the positive electrode active material 100 is preferably less than or equal to 600 ppm, further preferably less than or equal to 100 ppm, for example.

### [Crystal Structure]

{x in LiₓCoO₂ being 1}

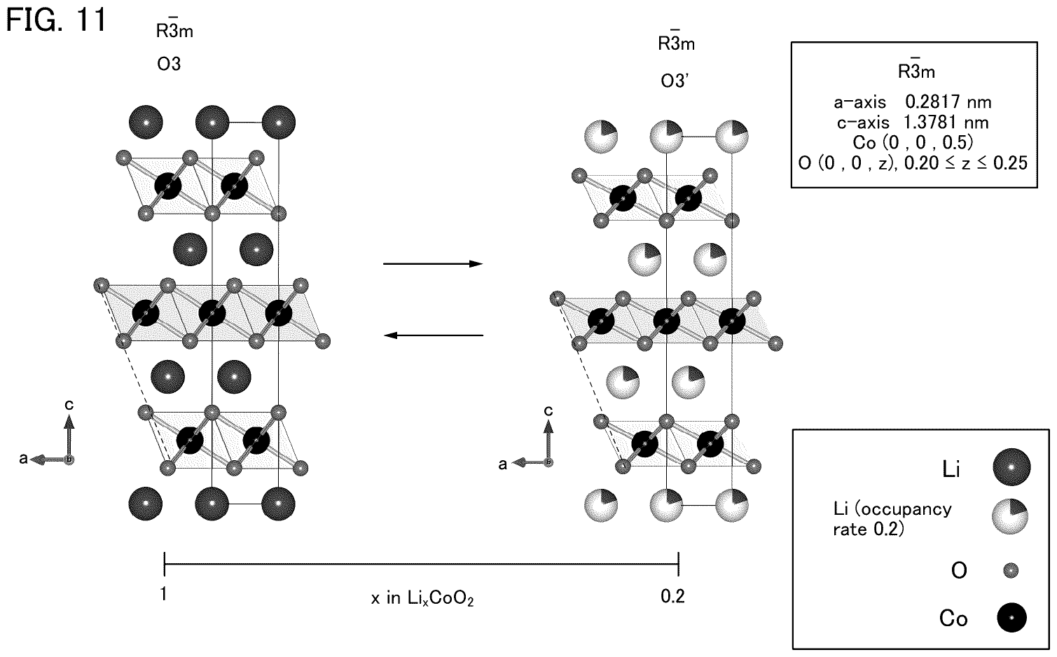

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the bulk 100b, which accounts for the majority of the volume of the positive electrode active material 100, have a layered rock-salt crystal structure. In FIG. 11, the layered rock-salt crystal structure is denoted by R-3m O3.

Meanwhile, the surface portion 100a of the positive electrode active material 100 of one embodiment of the present invention preferably has a function of reinforcing the layered structure, which is formed of octahedrons of the transition metal M and oxygen, of the bulk 100b so that the layered structure does not break even when a large amount of lithium is extracted from the positive electrode active material 100 by charge. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means at least one of inhibition of a structural change of the surface portion 100a and the bulk 100b of the positive electrode active material 100 such as extraction of oxygen and inhibition of oxidative decomposition of an electrolyte on the surface of the positive electrode active material 100.

Accordingly, the surface portion 100a preferably has a different composition and a different crystal structure from those of the bulk 100b. The surface portion 100a preferably has a more stable composition and a more stable crystal structure than those of the bulk 100b at room temperature (25° C.). For example, at least part of the surface portion 100a of the positive electrode active material 100 of one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charge, and is a region that tends to have a lower concentration of lithium than the bulk 100b. Bonds between atoms are regarded as being partly cut on the surface of the positive electrode active material 100 included in the surface portion 100a. Thus, the surface portion 100a is regarded as a region that tends to be unstable and easily starts deterioration of the crystal structure. Meanwhile, when the surface portion 100a can be made sufficiently stable, the layered structure, which is formed of octahedrons of the transition metal M and oxygen, of the bulk 100b is unlikely to be broken even with small x in LiₓCoO₂, e.g., with x of less than or equal to 0.24. Furthermore, a shift in layers, which are formed of octahedrons of the transition metal M and oxygen, of the bulk 100b can be inhibited.

In the bulk 100b of the positive electrode active material 100, the density of defects such as dislocation is preferably low. In the positive electrode active material 100, the crystallite size measured by XRD is preferably large. In other words, the bulk 100b preferably has high crystallinity. The positive electrode active material 100 preferably has a smooth surface. These features are important factors for assuring the reliability of the positive electrode active material 100 used for a secondary battery. A secondary battery can have a high upper limit of a charge voltage when a positive electrode active material is highly reliable and thereby can have high charge and discharge capacity.

Dislocation in the bulk 100b can be observed with a TEM, for example. Defects such as dislocation are sometimes not observed in a specific 1 μm² region of an observation sample in the case where the density of defects such as dislocation is sufficiently low. Note that dislocation is a kind of crystal defect and is different from a point defect.

The crystallite size measured by XRD is preferably larger than or equal to 300 nm, for example. The larger the crystallite size is, the more easily the O3′ type crystal structure is maintained and contraction of the c-axis length is inhibited in the state where x in LiₓCoO₂ is small as described later.

It is deemed that the crystallite size measured by XRD is larger as fewer defects such as dislocation are observed with a TEM.

An XRD diffraction pattern for calculation of the crystallite size is preferably obtained in a state of the positive electrode active material alone, or may be obtained in a state of a positive electrode including a current collector, a binder, a conductive material, and the like in addition to the positive electrode active material. Note that the positive electrode active material particles present in the positive electrode might be oriented such that the crystal planes of the positive electrode active material particles are oriented in the same direction owing to, for example, pressure application in a formation process. When the positive electrode active material particles have high orientation, the crystallite size might fail to be calculated accurately; thus, it is further preferable that to obtain an XRD pattern, a positive electrode active material layer be taken out of the positive electrode, the binder and the like in the positive electrode active material layer be eliminated to some extent using a solvent or the like, and a sample holder be filled, for example. Alternatively, a powder sample of the positive electrode active material or the like may be attached onto a reflection-free silicon plate to which grease is applied, for example.

The crystallite size can be calculated using ICSD coll. code. 172909 as literature data of lithium cobalt oxide and a diffraction pattern that is obtained with Bruker D8 ADVANCE, for example, CuKα used as an X-ray source, the 2θ ranged from 15° to 90°, an increment being 0.005, and a detector being LYNXEYE XE-T. DIFFRAC.TOPAS ver. 6 can be used as crystal structure analysis software to analyze, and set as follows, for example.
Emission Profile: CuKa5.1 am
Background: Chebychev polynomial of degree 5
Instrument
Primary radius: 280 mm
Secondary radius: 280 mm
Linear PSD
2Th angular range: 2.9
FDS angle: 0.3
Full Axial Convolution
Filament length: 12 mm
Sample length: 15 mm
Receiving Slit length: 12 mm
Primary Sollers: 2.5
Secondary Sollers: 2.5
Corrections
Specimen displacement: Refine
LP Factor: 0

A value of LVol-IB, which is a crystallite size calculated by the above method, is preferably employed as a crystallite size. Note that preferred orientation is calculated to be less than 0.8, too many particles are oriented in the same direction in a sample; thus, this sample is not suitable for calculation of a crystallite size in some cases.

### {Distribution of Additive Element}

The distribution of the additive element in the positive electrode active material 100 in a discharged state is described as an example. In order that the surface portion 100a can have a stable composition and a stable crystal structure, the surface portion 100a preferably contains the additive element, further preferably contains a plurality of additive elements. The surface portion 100a preferably has a higher concentration of one or two or more selected from the additive elements than those of the bulk 100b. The one or two or more selected from the additive elements contained in the positive electrode active material 100 preferably have a concentration gradient. It is further preferable that the additive elements contained in the positive electrode active material 100 be differently distributed. For example, it is further preferable that the additive elements exhibit concentration peaks at different depths from the surface. The concentration peak here refers to the local maximum value of the detected amount in the surface portion 100a or the detected amount in a region from the surface to a depth of 50 nm or less.

For example, some of the additive elements such as magnesium, fluorine, nickel, titanium, silicon, phosphorus, boron, and calcium preferably have a concentration gradient in which the concentration increases from the bulk 100b towards the surface. An element having such a concentration gradient is referred to as an additive element X.

Another additive element such as aluminum or manganese preferably has a concentration gradient and has a concentration peak in a relatively deep region. The concentration peak may be located in the surface portion 100a or located deeper than the surface portion 100a. For example, the concentration peak is preferably located in a region of 5 nm to 30 nm inclusive in a perpendicular direction or a substantially perpendicular direction from the surface. An element having such a concentration gradient is referred to as an additive element Y.

For example, magnesium, which is one of the additive elements X, is divalent, and a magnesium ion is more stable in lithium sites than in transition metal M sites in the layered rock-salt crystal structure and thus is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion 100a probably increases the corrosion resistance to hydrofluoric acid generated by the decomposition of the electrolyte solution.

An appropriate concentration of magnesium does not have an adverse effect on insertion and extraction of lithium in charge and discharge, and the above-described advantages can be obtained. However, excess magnesium might adversely affect insertion and extraction of lithium. Furthermore, the effect of stabilizing the crystal structure might be reduced. This is probably because magnesium enters the transition metal M sites in addition to the lithium sites. Moreover, an undesired magnesium compound (e.g., an oxide or a fluoride) which is substituted for neither the lithium site nor the transition metal M site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. For example, the proportion of magnesium to the sum of the transition metal M (Mg/Co) in the positive electrode active material 100 of one embodiment of the present invention is preferably higher than or equal to 0.25% and lower than or equal to 5%, further preferably higher than or equal to 0.5% and lower than or equal to 2%, still further preferably approximately 1%. The amount of magnesium contained in the entire positive electrode active material 100 here may be a value obtained by element analysis on the entire positive electrode active material 100 using GD-MS, ICP-MS, or the like, or may be a value based on the ratio of the raw materials mixed in the formation process of the positive electrode active material 100, for example.

Nickel, which is an example of the additive elements X, can be present in both the transition metal M sites and the lithium sites. Nickel preferably exists in the transition metal M site because an oxidation-reduction potential can be lower than the case of cobalt, leading to an increase in discharge capacity.

In addition, when nickel exists in the lithium sites, a shift in the layer structure, which is formed of the transition metal M and octahedrons of oxygen, can be inhibited. Moreover, a change in volume in charge and discharge is inhibited. Furthermore, an elastic modulus becomes large, i.e., hardness increases. This is probably because nickel in the lithium sites serves as a column supporting the CoO₂ layers. Thus, in particular, the crystal structure is expected to be more stable in a charged state at high temperatures, e.g., 45° C. or higher, which is preferable.

Meanwhile, excess nickel might increase the influence of distortion due to the Jahn-Teller effect. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the process of forming the positive electrode active material, for example.

Aluminum, which is one of additive elements Y, can exist in the transition metal M site in a layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Furthermore, aluminum has effects of inhibiting dissolution of the transition metal M around aluminum and improving continuous charge tolerance. Moreover, an Al—O bond is stronger than a Co—O bond; thus, extraction of oxygen around aluminum can be inhibited. These effects improve thermal stability. Hence, a secondary battery containing aluminum as the additive element Y can have improved safety. Furthermore, the positive electrode active material 100 can have a crystal structure that is unlikely to be broken by repeated charge and discharge.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

Fluorine, which is an example of the additive element X, is a monovalent anion; when fluorine is substituted for part of oxygen in the surface portion 100a, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved current characteristics, or the like. When fluorine is present in the surface portion 100a, which has a surface in contact with the electrolyte solution, the corrosion resistance to hydrofluoric acid can be effectively increased. In the case where a fluoride such as lithium fluoride has a lower melting point than another additive element source, the fluoride can serve as a fusing agent (also referred to as a flux) for lowering the melting point of the other additive element source.

An oxide of titanium, which is an example of the additive element X, is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

When the surface portion 100a contains phosphorus, which is an example of the additive element X, a short circuit can be inhibited while a state with small x in LiₓCoO₂ is maintained, in some cases, which is preferable. For example, a compound containing phosphorus and oxygen preferably exists in the surface portion 100a.

The positive electrode active material 100 preferably contains phosphorus, in which case the phosphorus reacts with hydrogen fluoride generated by the decomposition of the electrolyte, which can decrease the hydrogen fluoride concentration in the electrolyte.

In the case where the electrolyte contains LiPF₆, hydrogen fluoride might be generated by hydrolysis. In addition, hydrogen fluoride might be generated by the reaction of polyvinylidene fluoride (PVDF) used as a component of the positive electrode and alkali. The decrease in the concentration of hydrogen fluoride in the electrolyte can inhibit corrosion of a current collector and/or separation of a coating film in some cases. Furthermore, a reduction in adhesion properties due to gelling and/or insolubilization of PVDF can be inhibited in some cases.

The positive electrode active material 100 preferably contains magnesium and phosphorus, in which case the stability in a state with small x in LiₓCoO₂ is extremely high. In the case where the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 100 by GC-MS, ICP-MS, or the like, or may be a value based on the ratio of the raw materials mixed in the formation process of the positive electrode active material 100, for example.

In the case where the positive electrode active material 100 has a crack, crack development can be inhibited by phosphorus, more specifically, a compound containing phosphorus and oxygen, for example, being in the vicinity of the center of the positive electrode active material having the crack on its surface, e.g., the filling portion 102.

In the case where the surface portion 100a contains both magnesium and nickel, divalent magnesium might be able to be present more stably in the vicinity of divalent nickel. Thus, dissolution of magnesium might be inhibited even when x in LiₓCoO₂ is small. This can contribute to stabilization of the surface portion 100a.

Additive elements that are differently distributed, such as the additive element X and the additive element Y, are preferably contained at a time, in which case the crystal structure in a wider region can be stabilized. For example, in the case where the positive electrode active material 100 contains magnesium and nickel, which are parts of the additive elements X, and contains aluminum, which is one of the additive elements Y, the crystal structure in a wider region can be stabilized as compared with the case where only one of the additive element X or the additive element Yis contained. In the case where the positive electrode active material 100 contains both the additive element X and the additive element Y as described above, the surface can be sufficiently stabilized by the additive element X such as magnesium; thus, the additive element Y such as aluminum is not necessary for the surface. On the contrary, aluminum is preferably widely distributed in a deep region, e.g., in a region that is 5 nm to 50 nm inclusive in depth from the surface, in which case the crystal structure in a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, an atomic ratio of the number of magnesium atoms Mg to the number of cobalt atoms Co, Mg/Co, is preferably less than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is higher than that of fluorine in the surface portion 100a.

Moreover, excess nickel might hinder diffusion of lithium; thus, the concentration of magnesium is preferably higher than that of nickel in the surface portion 100a. For example, the number of nickel atoms is preferably less than or equal to one sixth that of magnesium atoms.

It is preferable that some additive elements, in particular, magnesium, nickel, and aluminum have higher concentrations in the surface portion 100a than in the bulk 100b and exist randomly also in the bulk 100b to have low concentrations. When magnesium and aluminum exist in the lithium sites of the bulk 100b at appropriate concentrations, an effect of facilitating maintenance of the layered rock-salt crystal structure can be obtained in a manner similar to the above. When nickel exists in the bulk 100b at an appropriate concentration, a shift in the layered structure formed of octahedrons of the transition metal M and oxygen can be inhibited in a manner similar to the above. Also, in the case where both magnesium and nickel are contained, a synergistic effect of inhibiting dissolution of magnesium can be expected since divalent magnesium can be present more stably in the vicinity of divalent nickel.

It is preferable that the crystal structure continuously change from the bulk 100b towards the surface owing to the above-described concentration gradient of the additive element. Alternatively, the crystal orientations of the surface portion 100a and the bulk 100b are preferably substantially aligned with each other.

For example, a crystal structure preferably changes continuously from a layered rock-salt bulk 100b towards the surface and the surface portion 100a that have a feature of a rock-salt structure or have features of both a rock-salt structure and a layered rock-salt structure. Alternatively, the orientation of the surface portion 100a that has a feature of a rock-salt structure or has the features of both a rock-salt structure and a layered rock-salt structure and the orientation of the bulk 100b that has the layered rock-salt structure are preferably substantially aligned with each other.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal Mare regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be determined by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal M. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt structure, for example, and on the (003) plane in a layered rock-salt structure, for example. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ crystal described later are also presumed to form a cubic close-packed structure. Thus, when a layered rock-salt crystal and a rock-salt crystal are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, a state where the orientations of the cubic close-packed structures composed of anions in the layered rock-salt crystal, the O3′ crystal, and the rock-salt crystal are aligned with each other is sometimes referred to as a state where crystal orientations are substantially aligned with each other, topotaxy, or epitaxy.

Topotaxy refers to having similarity in a three-dimensional structure such that crystal orientations are substantially aligned with each other, or to having the same orientations crystallographically. Epitaxy refers to similarity in structures of two-dimensional interfaces.

The crystal orientations in two regions being substantially aligned with each other can be determined, for example, from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron Microscope) image, an eHCI-TEM (enhanced Hollow-Cone Illumination-TEM) image, an electron diffraction pattern, and an FFT pattern of a TEM image, a STEM image, and the like. XRD (X-ray Diffraction), electron diffraction, neutron diffraction, and the like can also be used for the determination.

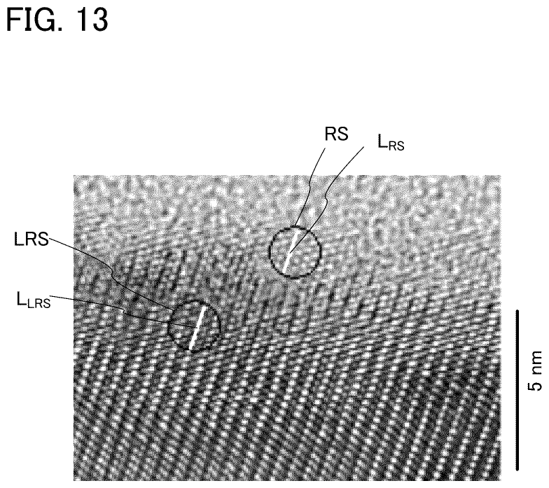

FIG. 13 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident perpendicularly to the c-axis of a layered rock-salt type composite hexagonal lattice, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., LRS and LLRS shown in FIG. 13) is greater than or equal to 0° and less than or equal to 5° or greater than or equal to 0° and less than or equal to 2.5° in the TEM image, it can be determined that the crystal planes are substantially aligned with each other, that is, the crystal orientations are substantially aligned with each other. Similarly, when the angle between the dark lines is 5° or less or 2.5° or less, it can be determined that orientations of the crystals are substantially aligned with each other. Thus, in general, it is difficult to clearly differentiate “perfectly aligned” from “substantially aligned”. In this specification, the expression “aligned” includes both “perfectly aligned” (where the angle between bright lines is 0°, for example) and “substantially aligned”.

In a HAADF-STEM image, a contrast proportional to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed in the direction perpendicular to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be determined that arrangements of the atoms are substantially aligned with each other, that is, orientations of the crystals are substantially aligned with each other. Similarly, when the angle between the dark lines is 5° or less or 2.5° or less, it can be determined that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be determined as in a HAADF-STEM image.

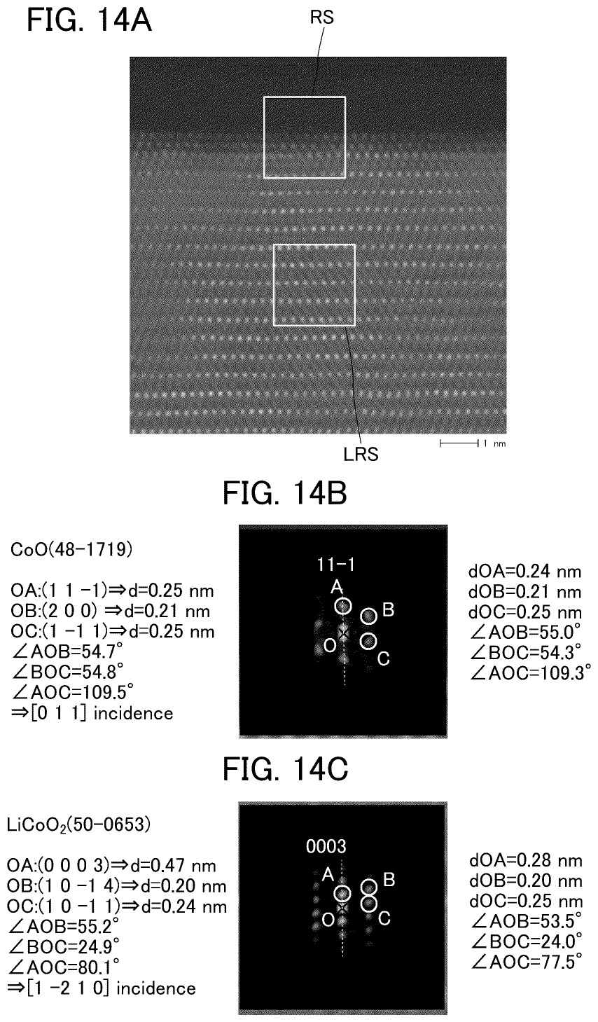

FIG. 14A shows an example of a STEM image in which orientations of the layered rock-salt crystal LRS and the rock-salt crystal RS are substantially aligned with each other. FIG. 14B shows FFT of a region of the rock-salt crystal RS, and FIG. 14C shows FFT of a region of the layered rock-salt crystal LRS. In FIG. 14B and FIG. 14C, the composition, the JCPDS (Joint Committee on Powder Diffraction Standard) card number, and d values and angles to be calculated are shown on the left. The measured values are shown on the right. A spot denoted by O is zero-order diffraction, and X denotes the center of the spot.

A spot denoted by A in FIG. 14B is derived from 11-1 reflection of a cubic structure. A spot denoted by A in FIG. 14C is derived from 0003 reflection of a layered rock-salt structure. It is found from FIG. 14B and FIG. 14C that the direction of the 11-1 reflection of the cubic structure and the direction of the 0003 reflection of the layered rock-salt structure are substantially aligned with each other. That is, a straight line that passes through A0 in FIG. 14B is substantially parallel to a straight line that passes through A0 in FIG. 14C. Here, the terms “substantially aligned” and “substantially parallel” mean that the angle between the two is greater than or equal to 0° and less than or equal to 5° or greater than or equal to 0° and less than or equal to 2.5°.

When the orientations of the layered rock-salt crystal and the rock-salt crystal are substantially aligned with each other in the above manner in FFT and electron diffraction, the <0003> orientation of the layered rock-salt crystal and the <11-1> orientation of the rock-salt crystal may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt structure are substantially aligned with each other as described above, a spot that is not derived from the 0003 reflection of the layered rock-salt structure may be observed, depending on the incident direction of the electron beam, on a reciprocal lattice space different from the direction of the 0003 reflection of the layered rock-salt structure. For example, a spot denoted by B in FIG. 14C is derived from 10-14 reflection of the layered rock-salt structure. This is sometimes observed at a position where the difference in orientation from the reciprocal lattice point derived from the 0003 reflection of the layered rock-salt structure (A in FIG. 14C) is greater than or equal to 520 and less than or equal to 56° (i.e., ∠AOB is 52° to 56°) and d is greater than or equal to 0.19 nm and less than or equal to 0.21 nm. Note that these indices are just an example, and the spot does not necessarily correspond with them. For example, the spot may be a reciprocal lattice point equivalent to the indices.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 14B is derived from 200 reflection of the cubic structure. The diffraction spot is sometimes observed at a position where the difference in orientation of reflection derived from the 11-1 reflection of the cubic structure (A in FIG. 14B) is greater than or equal to 540 and less than or equal to 560 (i.e., ∠AOB is 54° to 56°). Note that these indices are just an example, and the spot does not necessarily correspond with them. For example, the spot may be a reciprocal lattice point equivalent to the indices.

Note that to determine whether crystal orientations are aligned, a sample is preferably processed to be thin so that the (0003) plane of the layered rock-salt structure is easily observed. Thus, for example, a sample to be observed is preferably processed to be thin using an FIB or the like such that an electron beam of a TEM, for example, enters in [1-210]. It is known that in a layered rock-salt positive electrode active material, such as lithium cobalt oxide, the (0003) plane and a plane equivalent thereto and the (10-14) plane and a plane equivalent thereto are likely to be crystal planes. Thus, by carefully observing the shape of the positive electrode active material with a SEM or the like, a sample to be observed can be processed to be thin so that the (0003) plane is easily observed.

{State where x in LiₓCoO₂ is Small}

The crystal structure in a state where x in LiₓCoO₂ is small of the positive electrode active material 100 of one embodiment of the present invention is different from that of a conventional positive electrode active material because the positive electrode active material 100 has the above-described additive element distribution and crystal structure in a discharged state. Here, “x is small” means 0.1<x≤0.24.

A change in the crystal structure due to a change of x in LiₓCoO₂ is hereinafter described comparing a conventional positive electrode active material and the positive electrode active material 100 of one embodiment of the present invention.

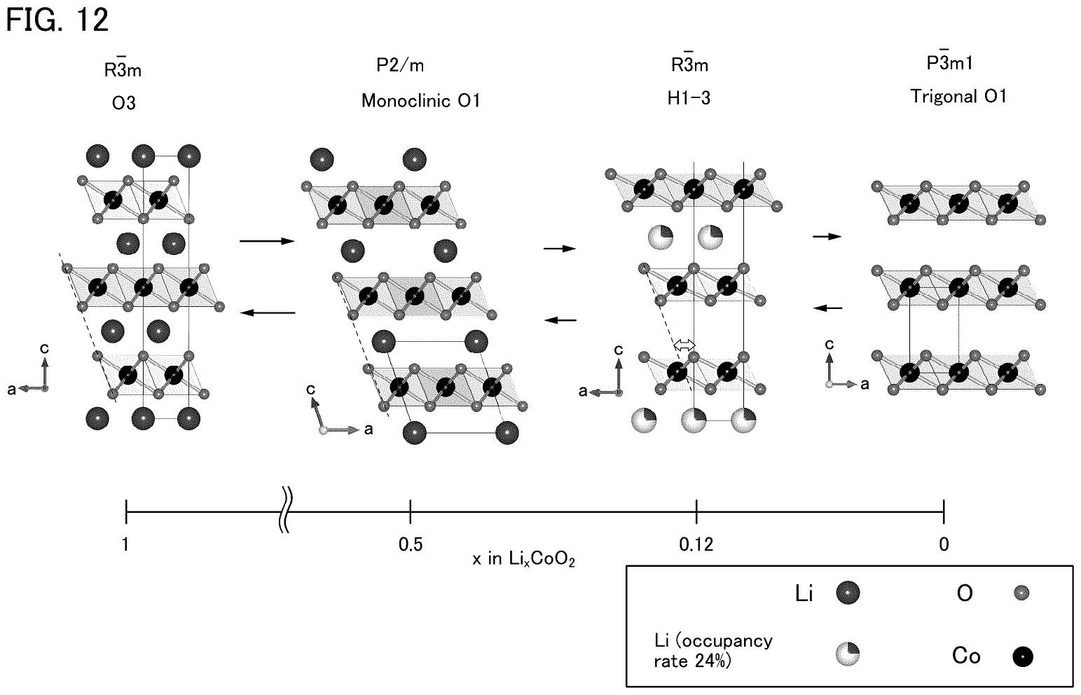

A change in the crystal structure of the conventional positive electrode active material is illustrated in FIG. 12. The conventional positive electrode active material shown in FIG. 12 is lithium cobalt oxide (LiCoO₂) without an added element in particular. A change in the crystal structure of lithium cobalt oxide not containing an additive element in particular is described in Non-Patent Document 1 to Non-Patent Document 4 and the like.

In FIG. 12, the crystal structure of lithium cobalt oxide with x in LiₓCoO₂ of 1 is denoted by R-3m O3. In a unit cell of this crystal structure, three CoO₂ layers exist and lithium is positioned between the CoO₂ layers. Furthermore, lithium occupies octahedral sites with six coordinated oxygen. Thus, this crystal structure is referred to as an O3 type crystal structure in some cases. Note that the CoO₂ layer refers to a structure in which an octahedral structure with cobalt coordinated to six oxygen atoms continues on a plane in an edge-shared state. Such a layer is sometimes referred to as a layer formed of octahedrons of cobalt and oxygen. The coordinates of lithium, cobalt, and oxygen in a unit cell of R-3m O3 can be represented by Li (0, 0, 0), Co (0, 0, 0.5), and O (0, 0, 0.23951).

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3m1 and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in reality, the H1-3 type crystal structure starts to be observed when x is approximately 0.25 in practice. The number of cobalt atoms per unit cell in the actual H1-3 type crystal structure is twice that in other structures. However, in this specification including FIG. 12, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. Which unit cell should be used for representing a crystal structure of a positive electrode active material can be judged by the Rietveld analysis of XRD patterns, for example. In this case, a unit cell is selected such that the value of GOF (goodness of fit) is small.

When charge that makes x in LiₓCoO₂ be 0.24 or less and discharge are repeated, the crystal structure of conventional lithium cobalt oxide experiences repetitive changes between the R-3m O3 type crystal structure in a discharged state and the H1-3 type crystal structure (i.e., an unbalanced phase change).

However, there is a large shift in the CoO₂ layers between these two crystal structures. As denoted by the dotted lines and the arrow in FIG. 12, the CoO₂ layer in the H1-3 type crystal structure largely shifts from that in R-3m O3 in a discharged state. Such a dynamic structural change can adversely affect the stability of the crystal structure.

Moreover, a difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charge that makes x be 0.24 or less and discharge are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

FIG. 11 shows crystal structures of the positive electrode active material 100 of one embodiment of the present invention. Here, crystal structures of the bulk 100b of the positive electrode active material 100 in a state where x in LiₓCoO₂ is 1 and in a state where x in LiₓCoO₂ is approximately 0.2 are illustrated. The bulk 100b, accounting for the majority of the volume of the positive electrode active material 100, largely contributes to charge and discharge and can thus be regarded as a portion where a shift in CoO₂ layers and a volume change matter most.

In the positive electrode active material 100 of one embodiment of the present invention, a change in the crystal structure between a discharged state with x in LiₓCoO₂ being 1 and a state with x being 0.24 or less is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is not easily broken even when charge that makes x be 0.24 or less and discharge are repeated, and enables excellent cycle performance. In addition, the positive electrode active material 100 of one embodiment of the present invention with x in LiₓCoO₂ being 0.24 or less can have a more stable crystal structure than a conventional positive electrode active material. Thus, the positive electrode active material 100 of one embodiment of the present invention with x in LixCoO₂ being kept at 0.24 or less does not readily cause a short circuit. This is preferable because in that case, the safety of the secondary battery is improved.

The positive electrode active material 100 with x being 1 has the R-3m O3 type crystal structure, which is the same as that of conventional lithium cobalt oxide. However, the positive electrode active material 100 has a crystal structure different from the H1-3 type crystal structure in a state where x is 0.24 or less, e.g., approximately 0.2 or approximately 0.12, and conventional lithium cobalt oxide would have the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is referred to as an O3′ type crystal structure. In FIG. 11, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 0.2797 nm≤a≤0.2837 nm, further preferably 0.2807 nm≤a≤0.2827 nm, typically a=0.2817 nm. The lattice constant of the c-axis is preferably 1.3681 nm≤c≤1.3881 nm, further preferably 1.3751 nm≤c≤1.3811 nm, typically, c=1.3781 nm.

In the O3′ type crystal structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 11, the CoO₂ layers hardly shift between the R-3m (O3) type crystal structure in a discharged state and the O3′ type crystal structure.

The R-3m (O3) type crystal structure in a discharged state and the O3′ type crystal structure which contain the same number of cobalt atoms have a difference in volume of 2.5% or less, specifically 2.2% or less, typically 1.8%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 100 is less likely to be broken even when charge that makes x be 0.24 or less and discharge are repeated. Therefore, the positive electrode active material 100 inhibits a decrease in charge and discharge capacity in charge and discharge cycles. Furthermore, the positive electrode active material 100 can stably use a larger amount of lithium than a conventional positive electrode active material and thus enables high discharge capacity per weight and per volume. Thus, with the use of the positive electrode active material 100, a secondary battery with high discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte, and the like, so that the range of x is not limited to the above.

Hence, when x in LiₓCoO₂ in the positive electrode active material 100 is greater than 0.1 and less than or equal to 0.24, the entire crystal structure of the bulk 100b of the positive electrode active material 100 is not necessarily the O3′ type. The bulk may include another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed. For example, when CC/CV charge is performed at a voltage of 4.6 V or higher with reference to the potential of a lithium metal in a 25° C. environment, the H1-3 type crystal structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

That is, the positive electrode active material 100 of one embodiment of the present invention is preferable because the crystal structure with the symmetry of R-3m O3 can be maintained even when charge at a high charge voltage of 4.6 V or higher is performed at 25° C., for example. Moreover, the positive electrode active material 100 of one embodiment of the present invention is preferable because the positive electrode active material 100 can have the O3′ type crystal structure when charge at a higher charge voltage, e.g., a voltage higher than or equal to 4.65 V and lower than or equal to 4.7 V, is performed at 25° C.

In the positive electrode active material 100, when the charge voltage is increased, the H1-3 type crystal structure is eventually observed in some cases. As described above, the crystal structure is influenced by the number of charge and discharge cycles, a charge current and a discharge current, temperature, an electrolyte, and the like, so that the positive electrode active material 100 of one embodiment of the present invention can sometimes have the O3′ type crystal structure even at a lower charge voltage, e.g., a charge voltage higher than or equal to 4.5 V and lower than 4.6 V, at 25° C.

Note that in the case where graphite is used as a negative electrode active material in a secondary battery, for example, the voltage of the secondary battery is lower than the above-mentioned voltages by the difference between the potential of graphite and the potential of a lithium metal. The potential of graphite is approximately 0.05 V to 0.2 V with reference to the potential of a lithium metal. Thus, in case of a secondary battery using graphite as a negative electrode active material, a crystal structure similar to that at a voltage corresponding to a difference between the above-described voltage and the potential of the graphite is obtained.

Although a chance of the existence of lithium is the same in all lithium sites in O3′ in FIG. 11, one embodiment of the present invention is not limited thereto. Lithium may exist unevenly in only some of the lithium sites; for example, lithium may symmetrically exist as in the monoclinic O1 (Li_{0.5}CoO₂) shown in FIG. 12. Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ type crystal structure in general.

The additive element concentration gradient is preferably similar in a plurality of portions of the surface portion 100a of the positive electrode active material 100. In other words, it is preferable that a barrier film derived from the additive element be uniformly formed in the surface portion 100a. When the surface portion 100a partly has reinforcement, stress might be concentrated on parts that do not have reinforcement. The concentration of stress on part of the positive electrode active material 100 might cause defects such as cracks from that part, leading to cracking of the positive electrode active material and a decrease in discharge capacity.

### [Crystal Grain Boundary]

It is further preferable that the additive element contained in the positive electrode active material 100 of one embodiment of the present invention have the above-described distribution and be at least partly unevenly distributed at the crystal grain boundary 101 and the vicinity thereof.

Note that in this specification and the like, uneven distribution means that the concentration of an element in a certain region differs from that in another region. This may be rephrased as segregation, precipitation, unevenness, deviation, or a mixture of a high-concentration portion and a low-concentration portion.

For example, the concentration of magnesium at the crystal grain boundary 101 and the vicinity thereof in the positive electrode active material 100 is preferably higher than that in the other regions in the bulk 100b. In addition, the fluorine concentration at the crystal grain boundary 101 and the vicinity thereof is preferably higher than that in the other regions in the bulk 100b. In addition, the concentration of nickel at the crystal grain boundary 101 and the vicinity thereof is preferably higher than that in the other regions in the bulk 100b. In addition, the concentration of aluminum at the crystal grain boundary 101 and the vicinity thereof is preferably higher than that in the other regions in the bulk 100b.

The crystal grain boundary 101 is a type of plane defect. Thus, the crystal grain boundary tends to be unstable and suffer from the initiation of a change in the crystal structure like the surface of the particle. Thus, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration would be high in the vicinity of a surface generated by a crack that may be generated along the crystal grain boundary 101 of the positive electrode active material 100 of one embodiment of the present invention. Thus, the positive electrode active material including a crack can also have an increased corrosion resistance to hydrofluoric acid.

### [Particle Diameter]

When the particle diameter of the positive electrode active material 100 of one embodiment of the present invention is too large, there are problems such as difficulty in lithium diffusion and large surface roughness of an active material layer at the time when the material is applied to a current collector. In contrast, too small a particle size causes problems of overreaction with an electrolyte solution and the like. Thus, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 μm. Alternatively, it is preferably greater than or equal to 1 μm and less than or equal to 30 μm. Alternatively, it is preferably greater than or equal to 2 μm and less than or equal to 100 μm. Alternatively, it is preferably greater than or equal to 2 μm and less than or equal to 30 μm. Alternatively, it is preferably greater than or equal to 5 μm and less than or equal to 100 μm. Alternatively, it is preferably greater than or equal to 5 μm and less than or equal to m.

A positive electrode is preferably formed using a mixture of particles having different particle diameters to have an increased electrode density and enable a high energy density of a secondary battery. The positive electrode active material 100 with a relatively small particle diameter is expected to enable favorable charge-discharge rate characteristics. The positive electrode active material 100 having a relatively large particle diameter is expected to enable high charge-discharge cycle performance and maintaining high discharge capacity.

In the case where a positive electrode is formed using a mixture of particles having different median diameters (D50), the speed at which x in LiₓCoO₂ decreases is higher in the positive electrode active material 100 with a relatively small particle diameter than in the positive electrode active material 100 with a relatively large particle diameter, on the assumption that extraction of lithium ions starts from the surface of the positive electrode active material. Thus, both the O3′ type crystal structure and the monoclinic O1(15) type crystal structure are sometimes detected when powder XRD measurement is performed on a positive electrode active material formed using a mixture of particles having different particle diameters.

### [Analysis Method]

### {Evaluation of Crystal Structure}

Whether or not a given positive electrode active material is the positive electrode active material 100 of one embodiment of the present invention, which has the O3′ type crystal structure and/or monoclinic O1(15) type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferably employed, in which case the symmetry of a transition metal such as cobalt in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example. A diffraction peak reflecting the crystal structure of the bulk 100b of the positive electrode active material 100, which accounts for the majority of the volume of the positive electrode active material 100, is obtained through powder XRD among some kinds of XRD.

Note that in the case where the crystallite size is measured by powder XRD, the measurement is preferably performed while the influence of orientation due to pressure or the like is removed. For example, it is preferable that the positive electrode active material be taken out from a positive electrode obtained from a disassembled secondary battery, the positive electrode active material be made into a powder sample, and then the measurement be performed.

As described above, the positive electrode active material 100 of one embodiment of the present invention has a feature of a small change in the crystal structure between when x in LiₓCoO₂ is 1 and when x is less than or equal to 0.24. A material where 50% or more of the crystal structure largely changes in high-voltage charge is not preferable because the material cannot withstand the repetition of high-voltage charge and discharge.

It should be noted that the O3′ type crystal structure or the monoclinic O1(15) type crystal structure is not obtained in some cases only by addition of the additive element. For example, when x in LiₓCoO₂ is less than or equal to 0.24, lithium cobalt oxide containing magnesium and fluorine or lithium cobalt oxide containing magnesium and aluminum has the O3′ type crystal structure and/or the monoclinic O1(15) type crystal structure at 60% or more in some cases, and has the H1-3 type crystal structure at 50% or more in other cases, depending on the concentration and distribution of the additive element.

In addition, in the case where x is too small, e.g., 0.1 or less, or under the condition where charge voltage is higher than 4.9 V, the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data on charge capacity, charge voltage, or the like.

Note that a positive electrode active material with small x sometimes suffers from a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether the distribution of the additive element contained in a given positive electrode active material is in the above-described state can be judged by, for example, analysis using XPS, energy dispersive X-ray spectroscopy (EDX), EPMA (electron probe microanalysis), or the like.

The crystal structure of the surface portion 100a, the crystal grain boundary 101, or the like can be analyzed by electron diffraction of a cross section of the positive electrode active material 100, for example.

### {Powder Resistivity Measurement}

The positive electrode active material 100 of one embodiment of the present invention has a stable crystal structure even at a high voltage. The stable crystal structure of the positive electrode active material in a charged state can inhibit a charge and discharge capacity decrease due to repeated charge and discharge. An example of a feature of the positive electrode active material 100 having excellent characteristics as described above is that the positive electrode active material 100 has the O3′ type structure and/or the monoclinic O1(15) type structure in XRD when x in LiₓCoO₂ is small (which is described later in {XRD}). Another example is that in the case where the positive electrode active material 100 is subjected to STEM-EDX analysis, there are preferable distributions of the additive element X and the additive element Y (which is described later in {EDX}). Furthermore, the positive electrode active material 100 of one embodiment of the present invention also has a feature in the volume resistivity of the powder.

As the feature of the positive electrode active material 100 of one embodiment of the present invention, the volume resistivity of the powder thereof is preferably higher than or equal to 1.0×10⁴ Ω·cm, further preferably higher than or equal to 1.0×10⁵ Ω·cm, still further preferably higher than or equal to 1.0×10⁶ Ω·cm under a pressure of 64 MPa. The volume resistivity of the powder of the positive electrode active material 100 of one embodiment of the present invention is preferably lower than or equal to 1.0×10⁹ Ω·cm, further preferably lower than or equal to 1.0×10⁸ Ω·cm, still further preferably lower than or equal to 1.0×10⁷ Ω·cm under a pressure of 64 MPa.

The positive electrode active material 100 with the above volume resistivity has a stable crystal structure at a high voltage, and can indicate the favorable formation of the surface portion 100a, which is an important factor for a stable crystal structure of a positive electrode active material in a charged state. In other words, it is preferable that the surface portion 100a have high resistance.

Note that a battery reaction might be hindered in the case where a high-resistance region extends from the surface of the positive electrode active material 100 towards the inner portion thereof to have a large thickness. It is thus further preferable that only a thin region near the surface of the surface portion 100a have high resistance. That is, a high-resistance region preferably extends from the surface towards the inner portion to have a small thickness in the surface portion 100a. For example, a region with a high concentration of Mg in the surface portion 100a can have high resistance. It is thus preferable that Mg be in the surface portion 100a.

A method for measuring the volume resistivity of the powder of the positive electrode active material 100 of one embodiment of the present invention is described.

A measurement for the volume resistivity of the powder preferably includes a device portion including terminals for measuring resistance and a mechanism for applying pressure to the powder serving as a measurement target. As such a measurement instrument that includes the terminals for resistance measurement and the mechanism for applying pressure to the powder as a measurement target (sample), for example, MCP-PD51 manufactured by Mitsubishi Chemical Analytech Co., Ltd. can be used. As a resistance meter, Loresta-GP or Hiresta-GP can be used. Loresta-GP can be used for the measurement for a low-resistance sample by a four-probe method, whereas Hiresta-UP can be used for the measurement for a high-resistance sample by a two-terminal method. Note that the measurement is preferably performed in a stable environment such as an environment of a dry room but may be performed in an environment of a common laboratory. In the environment of a dry room, the temperature is preferably higher than or equal to 20° C. and lower than or equal to 25° C. and the dew point is preferably lower than or equal to −40° C., for example. In the environment of a common laboratory, the temperature may be higher than or equal to 15° C. and lower than or equal to 30° C. and the humidity may be higher than or equal to 30% and lower than or equal to 70%.

The measurement of the volume resistivity of the powder using the above-described measurement instrument is described. First, a powder sample is set in the measurement portion. The measurement portion has a structure in which the powder sample and the terminals for measuring resistance are in contact with each other, and pressure can be applied to the powder sample. A structure for measuring the thickness of the powder sample set in the measurement portion is also included. Specifically, the measurement portion includes a cylindrical space, and the powder sample is set in the space.

In the measurement of the thickness resistivity of the powder, the electric resistance and thickness of the powder under pressure are measured. The pressure applied to the powder can be varied. For example, the electric resistance and thickness of the powder can be measured under pressures of 13 MPa, 25 MPa, 38 MPa, 51 MPa, and 64 MPa. The volume resistivity of the powder can be calculated from the measured value of the electric resistance and thickness of the powder.

A calculation method of volume resistivity is described. In the case where the measurement is performed by a two-terminal method using Hiresta-UP, the volume resistivity can be calculated by multiplying the electric resistance of the powder by the area of the electrode putting pressure on the powder and then dividing the product by the thickness of the powder. In the case where the measurement is performed by a four terminal method using Loresta-GP, the volume resistivity can be calculated by multiplying the electric resistance of the powder, a correction coefficient, and the thickness of the powder. The correction coefficient is a value that depends on the sample shape, the sample size, and the measurement position and can be calculated using calculation software incorporated in Loresta-GP.

The volume resistivity of the powder of the positive electrode active material 100 of one embodiment of the present invention obtained by the above-described measurement is preferably higher than or equal to 1.0×10⁴ Ω·cm, further preferably higher than or equal to 1.0×10⁵ Ω·cm, still further preferably higher than or equal to 1.0×10⁶ Ω·cm under a pressure of 64 MPa. In the case where the above-described measurement is performed, the volume resistivity of the powder of the positive electrode active material 100 of one embodiment of the present invention is preferably lower than or equal to 1.0×10⁹ Ω·cm, further preferably lower than or equal to 1.0×10⁸ Ω·cm, still further preferably lower than or equal to 1.0×10⁷ Ω·cm under a pressure of 64 MPa. A battery that includes the positive electrode active material 100 with such volume resistivity achieves favorable cycle performance in a charge and discharge cycle test under high-voltage conditions. Moreover, the battery does not easily ignite in an internal short circuit test such as a nail penetration test.

### {Charging Method}

Charge for determining whether or not a certain composite oxide is the positive electrode active material 100 of one embodiment of the present invention can be performed on a coin cell (CR2032 type with a diameter of 2θ mm and a height of 3.2 mm) with a lithium metal used for a counter electrode, for example.

More specifically, a positive electrode can be formed by application of slurry in which the positive electrode active material, a conductive material, and a binder are mixed to a positive electrode current collector made of aluminum foil.

A lithium metal can be used for the counter electrode as described above, but a material other than a lithium metal may be alternatively used. When the counter electrode is formed using a material other than the lithium metal, the potential of a secondary battery differs from the potential of the positive electrode. Unless otherwise specified, the voltage and the potential in this specification and the like refer to the potential of a positive electrode.

As a lithium salt contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

The coin cell fabricated with the above conditions is charged with a given voltage (e.g., 4.5 V, 4.55 V, 4.6 V, 4.65 V, 4.7 V, 4.75 V, or 4.8 V). The charging method is not particularly limited as long as charge with a given voltage can be performed for sufficient time. In the case of CCCV charge, for example, CC charge can be performed with a current higher than or equal to 2θ mA/g and lower than or equal to 100 mA/g. CV charge can be ended at higher than or equal to 2 mA/g and lower than or equal to 10 mA/g. To observe a phase change of the positive electrode active material, charge with such a small current value is preferably performed. The temperature is set to 25° C., since it is difficult to perform XRD measurement at a temperature lower than or equal to 0° C. Note that 25° C. is an exemplary temperature. After charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere when subjected to various analyses later. For example, XRD can be performed on the positive electrode enclosed in an airtight container with an argon atmosphere. After charge is completed, the positive electrode is preferably taken out immediately and subjected to the analysis. Specifically, the positive electrode is preferably subjected to the analysis within an hour, further preferably within 30 minutes after the completion of charge.

In the case where the crystal structure in a charged state after charge and discharge are performed multiple times is analyzed, the conditions of the charge and discharge performed multiple times may be different from the above-described charge conditions. For example, the charge can be performed by constant current charge at a current value of higher than or equal to 2θ mA/g and lower than or equal to 100 mA/g to a given voltage (e.g., 4.6 V, 4.65 V, 4.7 V, 4.75 V, or 4.8 V) and subsequent constant voltage charge performed until the current value becomes higher than or equal to 2 mA/g and lower than or equal to 10 mA/g. The discharge can be performed by constant current discharge at higher than or equal to 2θ mA/g and lower than or equal to 100 mA/g to 2.5 V.

Also, in the case where the crystal structure in a discharged state after the charge and discharge are performed multiple times is analyzed, constant current discharge can be performed at a current value higher than or equal to 2θ mA/g and lower than or equal to 100 mA/g to 2.5 V, for example.

### {XRD}

The apparatus and conditions of the XRD measurement are not particularly limited as long as appropriate adjustment and calibration are performed. The measurement can be performed with the apparatus and conditions as described below, for example.
XRD apparatus: D8 ADVANCE produced by Bruker AXS
X-ray: CuKα₁
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm
As a standard sample used for the adjustment and calibration, a standard sintered alumina plate SRM 1976 from National Institute of Standards and Technology (NIST) can be used, for example.

In the case where the measurement sample is a powder, the sample can be set by, for example, being put on a glass sample holder or being sprinkled on a reflection-free silicon plate to which grease is applied. In the case where the measurement sample is a positive electrode, the sample can be set in the following manner: the positive electrode is attached to a substrate with a double-sided adhesive tape such that the position of the positive electrode active material layer can be adjusted to the measurement plane required by the apparatus.

Characteristic X-rays may be monochromatized with the use of a filter or the like or may be monochromatized with XRD data analysis software after an XRD diffraction pattern is obtained. For example, a peak due to CuKα₂ radiation can be eliminated and only a peak due to CuKα₁ radiation can be extracted by using DEFFRAC.EVA (XRD data analysis software produced by Bruker Corporation). This software can also be used to eliminate the background, for example.

In this specification and the like, the value of 2θ of a diffraction peak refers to the value of 2θ at which a peak top of the diffraction peak appears in the XRD pattern after the calculation model is fitted. There is no particular limitation on the crystal structure analysis software used for the fitting; for example, it is possible to use TOPAS ver. 3 (crystal structure analysis software produced by Bruker Corporation).

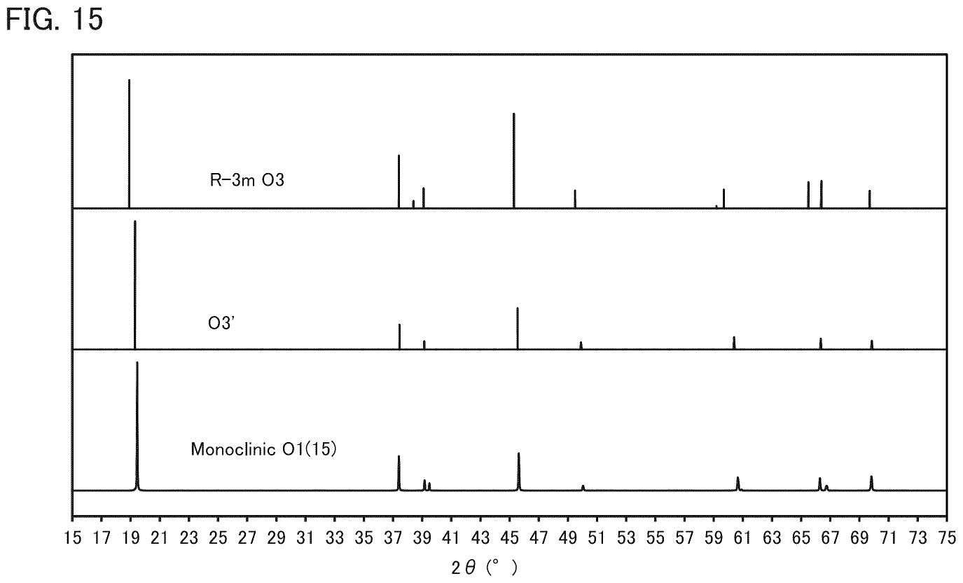

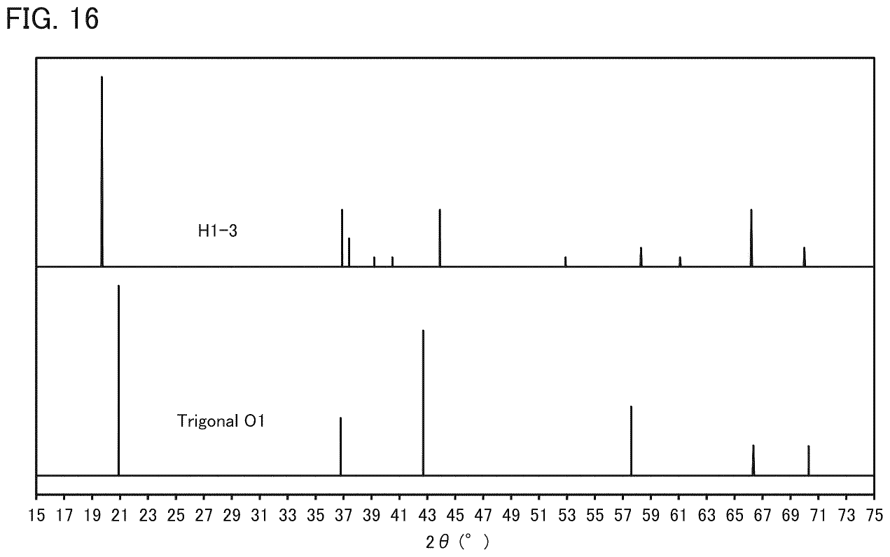

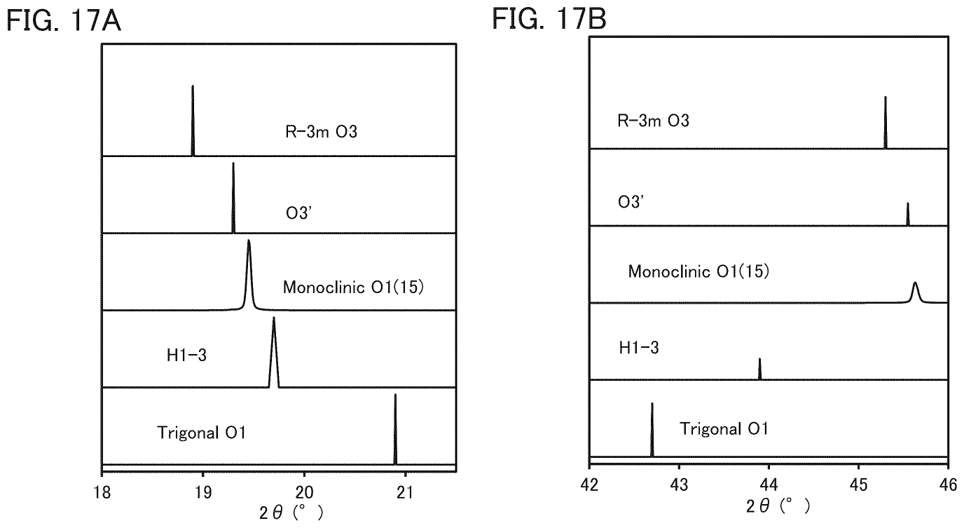

FIG. 15 shows diffraction profiles of the O3 type crystal structure, the O3′ type crystal structure, and the monoclinic O1(15) type crystal structure of the case where CuKα1 is used as an X-ray. FIG. 16 shows an ideal powder XRD pattern with CuKα₁ radiation calculated from a model of the H1-3 type crystal structure and an ideal XRD pattern with CuKα₁ radiation calculated from the trigonal O1 type crystal structure with x of 0. FIG. 17A and FIG. 17B show all the XRD patterns described above. Note that the patterns in the range of 2θ of 18° to 21°, and the range of 2θ of 42° and to 46° are shown. Note that the patterns of LiCoO₂ (O3) and CoO₂ (O1) were made from crystal structure data obtained from ICSD (the Inorganic Crystal Structure Database) (see Non-Patent Document 5) with Reflex Powder Diffraction, which is a module of Materials Studio (BIOVIA). At this time, the 2θ range was from 15° to 75°, the step size was 0.01, the wavelength λ was 1.54×10⁻¹⁰ μm, and a single monochromator was used. The pattern of the H1-3 type crystal structure was similarly made from the crystal structure data disclosed in Non-Patent Document 3. Patterns of the O3′ type crystal structure and the monoclinic O1(15) type crystal structure were obtained in the following manner: the crystal structures were estimated from the XRD pattern of the positive electrode active material 100 of one embodiment of the present invention, and the fitting was performed with TOPAS ver. 3 (crystal structure analysis software produced by Bruker Corporation).

As shown in FIG. 15, FIG. 17A, and FIG. 17B, the O3′ type crystal structure exhibits diffraction peaks at 2θ of 19.25±0.12° (greater than or equal to 19.130 and less than 19.37°) and 2θ of 45.47±0.10° (greater than or equal to 45.37° and less than 45.57°).

Furthermore, the monoclinic O1(15) type crystal structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°).

However, as shown in FIG. 16, FIG. 17A, and FIG. 17B, the H1-3 type crystal structure and the trigonal O1 do not exhibit peaks at these positions. Thus, exhibiting the peak at greater than or equal to 19.13° and less than 19.37° and/or the peak at greater than or equal to 19.37° and less than or equal to 19.57° and the peak at greater than or equal to 45.37° and less than 45.57° and/or the peak at greater than or equal to 45.57° and less than or equal to 45.67° in a state with small x in LiₓCoO₂ can be the feature of the positive electrode active material 100 of one embodiment of the present invention.

It can be said that the positions of the XRD diffraction peaks exhibited by the crystal structure with x being 1 and the crystal structure with x being 0.24 or less are close to each other. More specifically, it can be said that a difference in 2θ between the main diffraction peak exhibited by the crystal structure with x=1 and the main diffraction peak exhibited by the crystal structure with x≤0.24, which are exhibited at 2θ greater than or equal to 42° and less than or equal to 46°, is 0.7° or less, preferably 0.5° or less.

Although the positive electrode active material 100 of one embodiment of the present invention has the O3′ type crystal structure and/or the monoclinic O1(15) type crystal structure when x in LiₓCoO₂ is small, not all of the particles of the positive electrode active material 100 necessarily have the O3′ type crystal structure and/or the monoclinic O1(15) type crystal structure. The positive electrode active material may include another crystal structure or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% enables sufficiently good cycle performance.

Furthermore, even after 100 or more cycles of charge and discharge after the measurement starts, the O3′ type crystal structure and/or the monoclinic O1(15) type crystal structure preferably account(s) for more than or equal to 35%, further preferably more than or equal to 40%, still further preferably more than or equal to 43% when the Rietveld analysis is performed.

In addition, the H1-3 type crystal structure and the O1 type crystal structure preferably account for less than or equal to 50% in the Rietveld analysis performed in a similar manner. Alternatively, the H1-3 type crystal structure and the O1 type crystal structure preferably account for less than or equal to 34%. It is further preferable that substantially no H1-3 type crystal structure and substantially no O1 type crystal structure be observed.

Sharpness of a diffraction peak in an XRD pattern indicates the degree of crystallinity. It is thus preferable that the diffraction peaks after charge be sharp or in other words, have a small half width, e.g., a small full width at half maximum. Even peaks that are derived from the same crystal phase have different half widths depending on the XRD measurement conditions and the 2θ value. In the case of the above-described measurement conditions, the peak observed at 2θ greater than or equal to 43° and less than or equal to 46° preferably has a full width at half maximum less than or equal to 0.2°, further preferably less than or equal to 0.15°, still further preferably less than or equal to 0.12°. Note that not all peaks need to fulfill the requirement. A crystal phase can be regarded as having high crystallinity when some peaks fulfill the requirement. Such high crystallinity contributes to stability of the crystal structure after sufficient charge.

The crystallite sizes of the O3′ type crystal structure and the monoclinic O1(15) type crystal structure included in the positive electrode active material 100 do not decrease to less than approximately one-twentieth that of LiCoO₂ (O3) in a discharged state. Thus, a clear peak of the O3′ type crystal structure and/or the monoclinic O1(15) type crystal structure can be observed when x in LiₓCoO₂ is small, even under the same XRD measurement conditions as those of a positive electrode before charge and discharge. In contrast, conventional LiCoO₂ has a small crystallite size and a broad and small peak even when it can have a structure part of which is similar to the O3′ type crystal structure and/or the monoclinic O1(15) type crystal structure. The crystallite size can be calculated from the half width of the XRD peak.

As described above, the influence of the Jahn-Teller effect is preferably small in the positive electrode active material 100 of one embodiment of the present invention. The positive electrode active material 100 may contain a transition metal such as nickel or manganese as the additive element in addition to cobalt as long as the influence of the Jahn-Teller effect is small.

The proportions of nickel and manganese and the range of the lattice constants in each of which the influence of the Jahn-Teller effect is presumed to be small in the positive electrode active material are examined by XRD analysis.

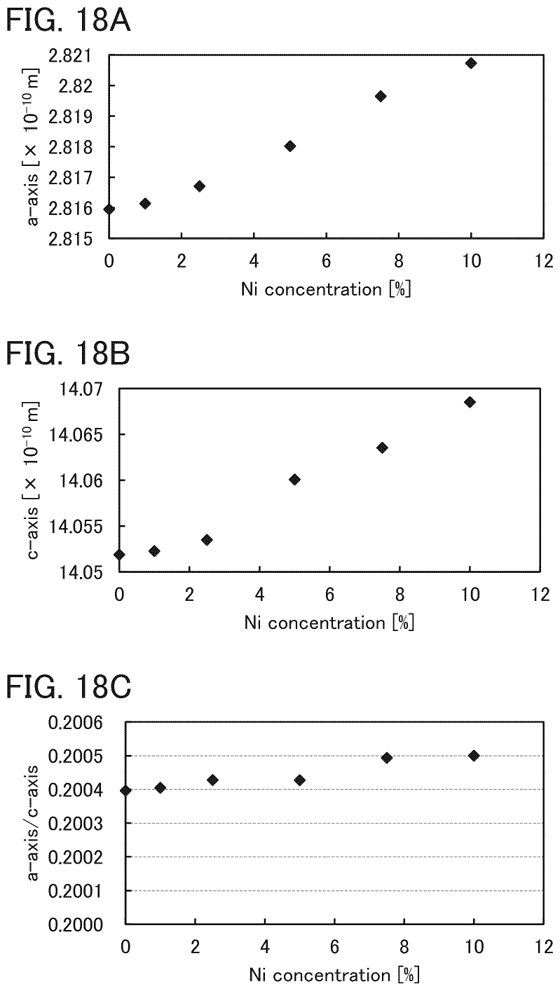

FIG. 18 shows the calculation results of the lattice constants of the a-axis and the c-axis by XRD of the case where the positive electrode active material 100 of one embodiment of the present invention has a layered rock-salt crystal structure and contains cobalt and nickel. FIG. 18A shows the results of the a-axis, and FIG. 18B shows the results of the c-axis. Note that the XRD patterns of a powder after the synthesis of the positive electrode active material before incorporation into a positive electrode were used for the calculation. The nickel concentration on the horizontal axis represents a nickel concentration with the sum of cobalt atoms and nickel atoms assumed as 100%.

FIG. 18C shows values obtained by dividing the lattice constants of the a-axis by the lattice constants of the c-axis (a-axis/c-axis) for the positive electrode active material, whose results of the lattice constants are shown in FIG. 18A and FIG. 18B.

As shown in FIG. 18C, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. It is suggested that an excellent positive electrode active material with small Jahn-Teller distortion can be obtained at a nickel concentration lower than 7.5%.

Note that the nickel concentration in the surface portion 100a is not limited to the above range. In other words, the nickel concentration in the surface portion 100a may be higher than the above concentration in some cases.

Preferable ranges of the lattice constants of the positive electrode active material of one embodiment of the present invention were examined above. It was thus found that in the layered rock-salt crystal structure of the positive electrode active material 100 in a discharged state or a state where charge and discharge are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charge and discharge are not performed may be, for example, the state of a powder before the formation of a positive electrode of a secondary battery.

Alternatively, in the layered rock-salt crystal structure of the positive electrode active material 100 in the discharged state or the state where charge and discharge are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in the discharged state or the state where charge and discharge are not performed is subjected to XRD analysis, a first peak is observed at 2θ greater than or equal to 18.50° and less than or equal to 19.30° and a second peak is observed at 2θ greater than or equal to 38.00° and less than or equal to 38.80°, in some cases.

### {XPS}

In an inorganic oxide, a region that extends approximately 2 nm to 8 nm (normally, 5 nm or less) in depth from the surface can be analyzed by X-ray photoelectron spectroscopy (XPS) using monochromatic aluminum Kα radiation as an X-ray; thus, the concentrations of elements can be quantitatively analyzed in a region expending to approximately half the depth of the surface portion 100a. The bonding states of the elements can be analyzed by narrow scanning. Note that the quantitative accuracy of XPS is approximately ±1 atomic % in many cases, and the lower detection limit is approximately 1 atomic % but depends on the element.

In the positive electrode active material 100 of one embodiment of the present invention, the concentration of one or two or more selected from the additive elements is preferably higher in the surface portion 100a than in the bulk 100b. This means that the concentration of one or two or more selected from the additive elements in the surface portion 100a is preferably higher than the average concentration of the selected element(s) in the entire positive electrode active material 100. For this reason, for example, it can be said that it is preferable that the concentration of one or two or more additive elements selected from the surface portion 100a, which is measured by XPS or the like, be higher than the concentration of the additive element(s) in the entire positive electrode active material 100, which is measured by ICP-MS (inductively coupled plasma-mass spectrometry), GD-MS (glow discharge mass spectrometry), or the like. For example, the average concentration of magnesium in at least part of the surface portion 100a, which is measured by XPS or the like, is preferably higher than the average concentration of magnesium in the entire positive electrode active material 100. The concentration of nickel in at least part of the surface portion 100a is preferably higher than the average concentration of nickel in the entire positive electrode active material 100. The concentration of aluminum in at least part of the surface portion 100a is preferably higher than the average concentration of aluminum in the entire positive electrode active material 100. The concentration of fluorine in at least part of the surface portion 100a is preferably higher than the average concentration of fluorine in the entire positive electrode active material 100.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not included either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample as a positive electrode active material, a positive electrode active material layer or the like may be washed, for example, to eliminate an electrolyte solution, a binder, a conductive material, or a compound originating from any of these that is attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The ratio of the additive element to cobalt is preferably used, in which case comparison can be performed while reducing the influence of a carbonate or the like which is chemically adsorbed after formation of the positive electrode active material. For example, in the XPS analysis, the atomic ratio of magnesium to cobalt, Mg/Co, is preferably greater than or equal to 0.4 and less than or equal to 1.5. In the ICP-MS analysis, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than the concentration of one or two or more selected from the additive elements contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium is preferably higher than the concentration of fluorine.

It is further preferable that the additive element Y such as aluminum be widely distributed in a deep region such as a region expending from a depth from the surface of 5 nm to a depth from the surface of 50 nm. Thus, the additive element Y such as aluminum is detected by analysis on the entire positive electrode active material 100 by ICP-MS, GD-MS, or the like, but the concentration of the additive element Y such as aluminum is preferably lower than or equal to the lower detection limit in XPS or the like.

Furthermore, when XPS analysis is performed on the positive electrode active material 100 of one embodiment of the present invention, the number of magnesium atoms is preferably 0.4 times or more and 1.2 times or less, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms. When the numbers are within the above ranges, it can be said that the additive elements are not attached to the surface of the positive electrode active material 100 in a narrow range but widely distributed at a preferable concentration in the surface portion 100a of the positive electrode active material 100.

In the XPS analysis, monochromatic aluminum Ku radiation can be used as an X-ray, for example. An extraction angle is, for example, 45°. For example, the measurement can be performed using the following apparatus and conditions.
Measurement apparatus: Quantera II produced by PHI, Inc.
X-ray: monochromatic Al Kα (1486.6 eV)
   Detection area: 100 μmϕ
Detection depth: approximately 4 nm to 5 nm (extraction angle: 45°)
   Measurement spectrum: wide scanning, narrow scanning of each detected element

In addition, when the positive electrode active material 100 of one embodiment of the present invention is analyzed by XPS, a peak indicating the binding energy of fluorine with another element is preferably at greater than or equal to 682 eV and less than 685 eV, further preferably approximately 684.3 eV. The above value is different from 685 eV, which is the binding energy of lithium fluoride, and 686 eV, which is the binding energy of magnesium fluoride.

Furthermore, when the positive electrode active material 100 of one embodiment of the present invention is analyzed by XPS, a peak indicating the binding energy of magnesium with another element is preferably at greater than or equal to 1302 eV and less than 1304 eV, further preferably at approximately 1303 eV. This binding energy is different from that of magnesium fluoride (1305 eV) and is close to that of magnesium oxide.

### {EDX}

The one or two or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using FIB (Focused Ion Beam) or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement for evaluation of the atomic concentration distribution in a positive electrode active material by line scan is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the bulk 100b, the vicinity of the crystal grain boundary 101, and the like of the positive electrode active material 100 can be quantitatively analyzed. By EDX line analysis, the concentration distribution and the highest concentration of the additive element can be analyzed. Analysis in which a thinned sample is used, such as STEM-EDX, is preferably used to analyze the concentration distribution in the depth direction from the surface towards the center in a specific region of the positive electrode active material without the influence of the distribution in the front-back direction.

EDX area analysis or EDX point analysis of the positive electrode active material 100 of one embodiment of the present invention preferably reveals that the concentration of each additive element, in particular, the additive element Xin the surface portion 100a is higher than that in the bulk 100b.

For example, EDX area analysis or EDX point analysis of the positive electrode active material 100 containing magnesium as the additive element preferably reveals that the concentration of magnesium in the surface portion 100a is higher than that in the bulk 100b. Thus, in the EDX line analysis, a peak of the concentration of magnesium in the surface portion 100a is preferably observed in a region extending, towards the center of the positive electrode active material 100, from the surface thereof to a depth of 3 nm, further preferably 1 nm, still further preferably 0.5 nm. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Here, a peak of concentration refers to the local maximum value of concentration.

When the positive electrode active material 100 contains magnesium and fluorine as the added elements, the distribution of fluorine and the distribution of magnesium preferably overlap with each other. For example, a difference in the depth direction between a peak of the concentration of fluorine and a peak of the concentration of magnesium is preferably within 10 nm, further preferably within 3 nm, still further preferably within 1 nm.

Thus, in the EDX line analysis, a peak of the concentration of fluorine in the surface portion 100a is preferably observed in a region extending, towards the center of the positive electrode active material 100, from the surface thereof to a depth of 3 nm, further preferably 1 nm, still further preferably 0.5 nm. It is further preferable that a peak of the concentration of fluorine be observed slightly closer to the surface side than a peak of the concentration of magnesium is, which increases resistance to hydrofluoric acid. For example, it is still further preferable that a peak of the concentration of fluorine be observed slightly closer to the surface side than a peak of the concentration of magnesium is by 0.5 nm or more, further preferably 1.5 nm or more.

When the positive electrode active material 100 contains nickel as the additive element, a peak of the concentration of nickel in the surface portion 100a is preferably observed in a region extending, towards the center of the positive electrode active material 100, from the surface thereof to a depth of 3 nm, further preferably 1 nm, still further preferably 0.5 nm. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 10 nm, further preferably within 3 nm, still further preferably within 1 nm.

In the case where the positive electrode active material 100 contains aluminum as the additive element, in the EDX line analysis, the peak of the concentration of magnesium, the concentration of nickel, or the concentration of fluorine is preferably closer to the surface than the peak of the concentration of aluminum is in the surface portion 100a. For example, the peak of the concentration of aluminum is preferably observed by a region extending, towards the center of the positive electrode active material 100, from a depth from the surface of 0.5 nm to a depth from the surface of 50 nm, further preferably from a depth from the surface of 5 nm to a depth from the surface of 50 nm.

EDX line, area, or point analysis of the positive electrode active material 100 preferably reveals that the atomic ratio of magnesium Mg to cobalt Co (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum Al to cobalt Co (Al/Co) at a peak of the concentration of aluminum is preferably greater than or equal to 0.05 and less than or equal to 0.6, further preferably greater than or equal to 0.1 and less than or equal to 0.45. The atomic ratio of nickel Ni to cobalt Co (Ni/Co) at a peak of the concentration of nickel is preferably greater than or equal to 0 and less than or equal to 0.2, further preferably greater than or equal to 0.01 and less than or equal to 0.1. The atomic ratio of fluorine F to cobalt Co (F/Co) at a peak of the concentration of fluorine is preferably greater than or equal to 0 and less than or equal to 1.6, further preferably greater than or equal to 0.1 and less than or equal to 1.4.

According to results of the EDX line analysis, where a surface of the positive electrode active material 100 is can be estimated as follows. A point where the detected amount of an element which uniformly exists in the bulk 100b of the positive electrode active material 100, e.g., oxygen or cobalt, is ½ of the detected amount thereof in the bulk 100b is assumed to be the surface.

Since the positive electrode active material 100 is a composite oxide, the detected amount of oxygen can be used to estimate where the surface is. Specifically, an average value Gave of the oxygen concentration in a region of the bulk 100b where the detected amount of oxygen is stable is calculated first. At this time, in the case where oxygen O_{bg} which is probably led from chemical adsorption or the background is detected in a region that is obviously outside the surface, O_{bg} can be subtracted from the measurement value to obtain the average value Oₐᵥₑ of the oxygen concentration. The measurement point where the measurement value which is closest to ½ of the average value Oₐᵥₑ, i.e., ½Oₐᵥₑ, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is less likely to be affected by chemical adsorption and is thus suitable for estimating where the surface is.

When the line analysis or the area analysis is performed on the positive electrode active material 100, the atomic ratio of the additive element A to cobalt Co (A/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100 containing magnesium as the additive element, the atomic ratio of magnesium to cobalt (Mg/Co) in the vicinity of the crystal grain boundary 101 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. When the ratio is within the above range in a plurality of portions, e.g., three or more portions, of the positive electrode active material 100, it can be said that the additive element is not attached to the surface of the positive electrode active material 100 in a narrow range but widely distributed at a preferable concentration in the surface portion 100a of the positive electrode active material 100.

### {EPMA}

Quantitative analysis of elements can be conducted also by EPMA (electron probe microanalysis). In area analysis, distribution of each element can be analyzed.

EPMA area analysis of a cross section of the positive electrode active material 100 of one embodiment of the present invention preferably reveals that one or two or more selected from the additive elements have a concentration gradient, as in the EDX analysis results. It is further preferable that the additive elements exhibit concentration peaks at different depths from a surface. The preferred ranges of the concentration peaks of the additive elements are the same as those of the case of EDX.

Note that in EPMA, a region from a surface to a depth of approximately 1 μm is analyzed. Thus, the quantitative value of each element is sometimes different from measurement results obtained by other analysis methods. For example, when area analysis is performed by EPMA on the positive electrode active material 100, the concentrations of the additive elements present in the surface portion 100a might be lower than the results obtained in XPS.

### {Raman Spectroscopy}

As described above, at least part of the surface portion 100a of the positive electrode active material 100 of one embodiment of the present invention preferably has the rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a STEM image and a nanobeam electron diffraction pattern described later, a bright spot cannot be detected when cobalt that is substituted at a lithium site, cobalt that is present at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to the Co—O bond can be observed in some cases. Furthermore, since Raman spectroscopy can measure a range with an area of several square micrometers and a depth of approximately 1 μm of a surface portion, states only at the surface of a particle can be observed with high sensitivity.

When a laser wavelength is 532 nm, for example, peaks (vibration mode: E_{g}, A_{1g}) of LiCoO₂ having a layered rock-salt crystal structure are observed in a range from 470 cm⁻¹ to 490 cm⁻¹ and in a range from 580 cm⁻¹ to 600 cm⁻¹. Meanwhile, a peak (vibration mode: A_{1g}) of cubic CoOₓ (0<x<1) (Co_{1-y}O having a rock-salt structure (0<y<1) or Co₃O₄ having a spinel structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that an appropriate range of the surface portion 100a of the positive electrode active material 100 has a rock-salt crystal structure.

### {Nanobeam Electron Diffraction Pattern}

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a portion from the surface to a depth of 1 nm). This is because a diffusion path of lithium can be ensured and a function of stabilizing a crystal structure can be enhanced in the case where the additive element such as magnesium is present in the lithium layer while the outermost surface has a layered rock-salt crystal structure as compared with the case where the outermost surface is covered with a rock-salt crystal structure.

Therefore, for example, when a nanobeam electron diffraction pattern of a region that extends from the surface to a depth less than or equal to 1 nm and a region that extends from a depth from the surface of 3 nm to a depth from the surface of 10 nm are obtained, a difference between lattice constants calculated from the patterns is preferably small.

For example, a difference between lattice constants calculated from a measured portion that is at a depth less than or equal to 1 nm from the surface and a measured portion that is at a depth greater than or equal to 3 nm and less than or equal to 10 nm from the surface is preferably less than or equal to 0.01 nm for the a-axis and less than or equal to 0.1 nm for the c-axis. It is further preferable that the difference be less than or equal to 0.005 nm for the a-axis, and less than or equal to 0.06 nm for the c-axis. It is still further preferable that the difference be less than or equal to 0.004 nm for the a-axis, and less than or equal to 0.03 nm for the c-axis.

### [Additional Features]

The positive electrode active material 100 has a depression, a crack, a concave, a V-shaped cross section, or the like in some cases. These are examples of defects, and when charge and discharge are repeated, dissolution of cobalt, breakage of a crystal structure, cracking of the positive electrode active material 100, extraction of oxygen, or the like might be derived from these defects. However, when there is a filling portion 102 as shown in FIG. 10F that fills such defects, dissolution of cobalt or the like can be inhibited. Thus, the positive electrode active material 100 can have high reliability and enables excellent cycle performance.

As described above, an excessive amount of the additive element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the bulk 100b in the positive electrode active material 100, so that the additive element concentration can be appropriate in the bulk 100b. This can inhibit an internal resistance increase, a charge and discharge capacity decrease, and the like when a secondary battery is fabricated. A feature of inhibiting an internal resistance increase in a secondary battery is extremely preferable especially in charge and discharge with a large amount of current such as charge and discharge at 400 mA/g or more.

In the positive electrode active material 100 including the region where the additive element is unevenly distributed, mixing of excess additive elements to some extent in the formation process is acceptable. This is preferable because the margin of production can be increased.

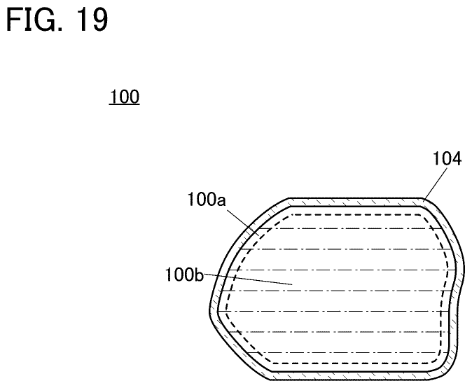

A coating portion may be attached to at least part of the surface of the positive electrode active material 100. FIG. 19 illustrates an example of the positive electrode active material 100 to which a coating portion 104 is attached. In FIG. 19, the coating portion 104 is provided to cover the surface portion 100a. In the case where an uneven portion, a crack, or the filling portion 102 shown in FIG. 10F is formed on the surface of the positive electrode active material 100, the coating portion 104 may be provided to cover the unevenness, the crack, or the filling portion 102.

The coating portion 104 is preferably formed by deposition of a decomposition product of a lithium salt, an organic electrolyte solution, and the like due to charge and discharge, for example. A coating portion originating from an organic electrolyte solution, which is formed on the surface of the positive electrode active material 100, is expected to improve charge and discharge cycle performance particularly when charge that makes x in LiₓCoO₂ be 0.24 or less is repeated. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution includes LiBOB and/or SUN (suberonitrile), for example. Accordingly, the coating portion 104 containing one or more selected from boron, nitrogen, sulfur, and fluorine is preferable because of having high quality in some cases. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100. In a portion without the coating portion, fluorine may be adsorbed onto the surface of the positive electrode active material 100.

At least part of this embodiment can be implemented in combination with the other embodiments described in this specification as appropriate.

### Embodiment 2

In this embodiment, examples of methods for forming the positive electrode active material 100 of one embodiment of the present invention are described.

A way of adding an additive element is important in forming the positive electrode active material 100 described in the above embodiment. Favorable crystallinity of the bulk 100b is important as well.

In the formation process of the positive electrode active material 100 using one method, lithium cobalt oxide is synthesized first, an additive element source is then mixed, and heat treatment is performed. A method in which an additive element source is mixed together with a cobalt source and a lithium source to synthesize lithium cobalt oxide containing the additive element may alternatively be employed. It is preferable that heating be performed in addition to mixing of lithium cobalt oxide and the additive element source to make the additive element be formed a solid solution with lithium cobalt oxide. Sufficient heating is preferably performed to enable favorable distribution of the additive element. The heat treatment after the mixing of the additive element source is thus important. The heat treatment after the mixing of the additive element source may be referred to as baking or annealing.

However, heat treatment at an excessively high temperature may cause cation mixing, which increases the possibility of entry of the additive element such as magnesium into the cobalt sites. Magnesium that exists at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

Here, a material functioning as a fusing agent is preferably mixed together with the additive element source or is preferably mixed as an additive element. A fusing agent refers to a substance whose melting point is lower than that of lithium cobalt oxide, and such substance functions as a fusing agent. As the fusing agent, for example, a fluorine compound such as lithium fluoride is preferably used. By adding the fusing agent, the melting points of the additive element source and lithium cobalt oxide are decreased. The decrease in the melting points makes it easier to favorably distribute the additive element at a temperature at which the cation mixing is less likely to occur.

### [Initial Heating]

It is further preferable that heat treatment be performed after the synthesis of the lithium cobalt oxide before the mixing of the additive element, as well. This heating is referred to as initial heating in some cases.

Owing to influence of lithium extraction from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, the additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is obtained by reduction due to lithium deficiency, Mg²⁺, and Ni²⁺ is formed. However, this phase is formed in part of the surface portion 100a, and thus is sometimes not clearly observed in an image obtained with an electron microscope, such as a STEM, and an electron diffraction pattern.

Among the additive elements, nickel is likely to be formed a solid solution and is diffused to the bulk 100b in the case where the surface portion 100a is lithium cobalt oxide that has a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me—O distance) tends to be longer than that in a layered rock-salt crystal structure.

For example, the Me—O distance is 0.209 nm and 0.211 nm in Ni_{0.5}Mg_{0.5}O having a rock-salt crystal structure and MgO having a rock-salt crystal structure, respectively. Even when a spinel phase is formed in part of the surface portion 100a, the Me—O distance is 0.20125 nm and 0.202 nm in NiAl₂O₄ having a spinel structure and MgAl₂O₄ having a spinel structure, respectively. In each case, the Me—O distance is longer than 0.2 nm.

Meanwhile, in a layered rock-salt crystal structure, the bond distance between oxygen and a metal other than lithium is shorter than the above-described distance. For example, the Al—O distance is 0.1905 nm (Li—O distance is 0.211 nm) in LiAlO₂ having a layered rock-salt crystal structure. In addition, the Co—O distance is 0.19224 nm (Li—O distance is 0.20916 nm) in LiCoO₂ having a layered rock-salt crystal structure.

According to Shannon's ionic radius (see Non-Patent Document 8), the ion radius of hexacoordinated aluminum is 0.0535 nm and the ion radius of hexacoordinated oxygen is 0.14 nm and the sum of these values is 0.1935 nm.

From the above, aluminum is considered to exist at sites other than lithium sites more stably in a layered rock-salt crystal structure than in a rock-salt crystal structure. Thus, in the surface portion 100a, aluminum is more likely to be distributed in a region having a layered rock-salt phase at a larger depth and/or the bulk 100b than in a region having a rock-salt phase and being close to the surface.

Moreover, the initial heating is expected to increase the crystallinity of the layered rock-salt crystal structure of the bulk 100b.

For this reason, the initial heating is preferably performed in forming the positive electrode active material 100 that has the monoclinic O1(15) type crystal structure when x in LiₓCoO₂ is, for example, greater than or equal to 0.15 and less than or equal to 0.17.

However, the initial heating is not necessarily performed. In some cases, by controlling atmosphere, temperature, time, or the like in another heating step, the positive electrode active material 100 that has the O3′ type structure and/or the monoclinic O1(15) type structure when x in LiₓCoO₂ is small can be formed.

### [Formation Method 1 of Positive Electrode Active Material]

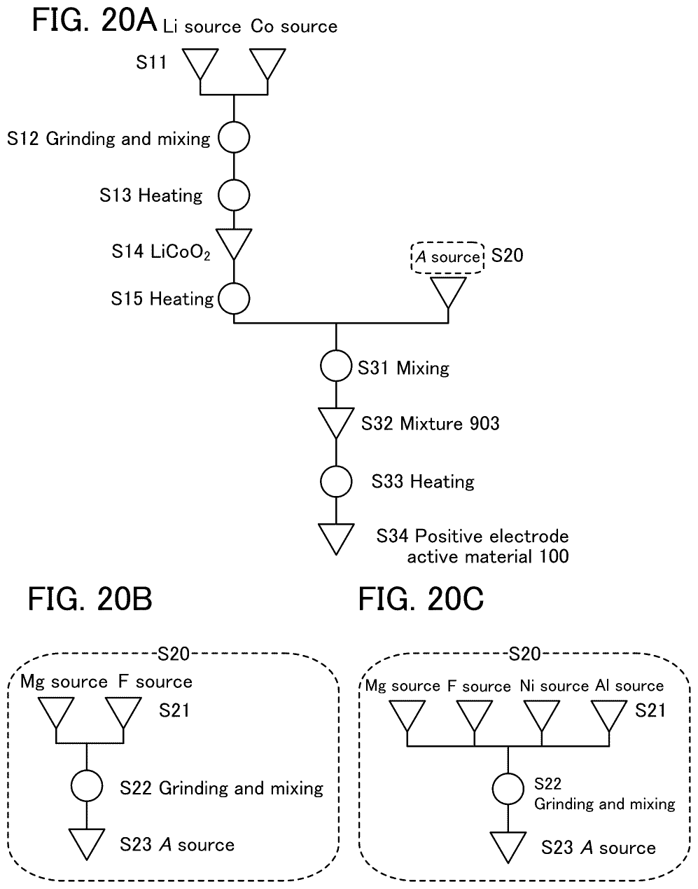

A formation method 1 of the positive electrode active material 100, in which initial heating is performed, will be described with reference to FIG. 20A to FIG. 20C.

### <Step S11>

In Step S11 shown in FIG. 20A, a lithium source (Li source) and a cobalt source (Co source) are prepared as materials for lithium and the transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide (specifically, tricobalt tetraoxide), cobalt hydroxide (specifically, cobalt hydroxide), or the like can be used.

The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the cobalt source preferably has high crystallinity, and preferably includes single crystal particles, for example. The crystallinity of the cobalt source can be evaluated with a TEM (transmission electron microscope) image, a STEM (scanning transmission electron microscope) image, a HAADF-STEM (high-angle annular dark-field scanning transmission electron microscope) image, or an ABF-STEM (annular bright-field scanning transmission electron microscope) image or by X-ray diffraction (XRD), electron diffraction, neutron diffraction, or the like. Note that the above methods for evaluating crystallinity can also be employed to evaluate the crystallinity of other materials in addition to the cobalt source.

### <Step S12>

Next, in Step S12 shown in FIG. 20A, the lithium source and the cobalt source are ground and mixed to form a mixed material. The grinding and mixing can be performed by a dry method or a wet method. A wet method is preferable because it can crush a material into a smaller size. When the grinding and mixing are performed by a wet method, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 20A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 2θ hours.

A temperature rising rate is preferably higher than or equal to 80° C./h and lower than or equal to 250° C./h, although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. A method of continuously introducing oxygen into a reaction chamber to make oxygen flow therein is referred to as flowing.

In the case where the heating atmosphere is an oxygen-containing atmosphere, flowing is not necessarily performed. For example, a method may be employed in which the pressure in the reaction chamber is reduced, the reaction chamber is filled (which may also be referred to as purged) with oxygen, and the oxygen is prevented from entering or exiting from the reaction chamber. For example, the pressure in the reaction chamber may be reduced to −970 hPa and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours; for example, the temperature falling rate is preferably higher than or equal to 80° C./h and lower than or equal to 250° C./h, further preferably higher than or equal to 180° C./h and lower than or equal to 210° C./h. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

As a crucible used at the time of the heating, a crucible made of aluminum oxide is preferable. A crucible made of aluminum oxide has a material property that hardly releases impurities. In this embodiment, a crucible made of aluminum oxide with a purity of 99.9% is used. The heating is preferably performed with the crucible covered with a lid. This can prevent volatilization or sublimation of a material. A lid at least prevents volatilization or sublimation of a material at the time when the temperature is increased and decreased in this step, and does not necessarily seal off a crucible. For example, this step can be performed without sealing off the crucible in the case where the reaction chamber is filled with oxygen as described above.

A used crucible is preferred to a new crucible. In this specification and the like, a new crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. In the case where a new crucible is used, some materials such as lithium fluoride might be absorbed by, diffused in, transferred to, and/or attached to a sagger at the time of heating. Loss of some materials due to such phenomena increases a concern that an element is not distributed in a preferable range particularly in the surface portion of the positive electrode active material. In contrast, such a risk is low in the case of a used crucible.

The heated material is ground as needed and may be made to pass through a sieve. Before collection of the heated material, the material may be moved from the crucible to a mortar. As the mortar, an aluminum oxide mortar can be suitably used. A mortar made of aluminum oxide has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above process, lithium cobalt oxide (LiCoO₂) can be synthesized in Step S14 in FIG. 20A. In the case where a median diameter (D50) is employed as the particle diameter of lithium cobalt oxide, lithium cobalt oxide is preferably ground in order to obtain the positive electrode active material 100 with a relatively small median diameter (D50).

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, in Step S15 shown in FIG. 20A, the lithium cobalt oxide is heated. The heating in Step S15 is the first heating performed on the lithium cobalt oxide and thus, this heating is sometimes referred to as the initial heating. The heating is performed before Step S20 described below and thus is sometimes referred to as preheating or pretreatment. The crucible, lid, and/or the like used in this step are/is similar to those used in Step S13. Although the initial heating is expected to have the following effects, the initial heating is not essential in obtaining the positive electrode active material of one embodiment of the present invention.

By the initial heating, lithium is extracted from part of the surface portion 100a of the lithium cobalt oxide as described above. In addition, an effect of increasing the crystallinity of the bulk 100b can be expected. The lithium source and/or the cobalt source prepared in Step S11 and the like might contain impurities. The initial heating can reduce impurities in the lithium cobalt oxide completed in Step S14.

In addition, through the initial heating, an effect of smoothing the surface of the lithium cobalt oxide is obtained. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to a surface.

For the initial heating, there is no need to prepare a lithium source. For the initial heating, there is no need to prepare the additive element source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected to perform the heating. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the bulk 100b is, for example, an effect of reducing distortion, a shift, or the like derived from differential shrinkage or the like of the lithium cobalt oxide formed in Step S13.

The heating in Step S13 might cause a temperature difference between the surface and an inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it can be deemed that Step S15 reduces the shift in a crystal or the like which is caused in the composite oxide and makes the surface of the composite oxide smooth.

In a secondary battery including lithium cobalt oxide with a smooth surface as a positive electrode active material, deterioration by charge and discharge is suppressed and cracking in the positive electrode active material can be prevented.

Note that pre-synthesized lithium cobalt oxide may be used in Step S14. In this case, Step S11 to Step S13 can be omitted. When Step S15 is performed on the pre-synthesized lithium cobalt oxide, lithium cobalt oxide with a smooth surface can be obtained.

### <Step S20>

Next, as shown in Step S20, the additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIG. 20B and FIG. 20C.

### <Step S21>

In Step S21 shown in FIG. 20B, an additive element A source (A source) to be added to the lithium cobalt oxide are prepared. A lithium source may be prepared together with the additive element A source.

As the additive element A, the additive element described in the above embodiment, such as the additive element X or the additive element Y, can be used. Specifically, one or two or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or two selected from bromine and beryllium can be used.

When magnesium is selected as the additive element, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, cycle performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x is an approximate value of 0.33). Note that in this specification and the like, the neighborhood means a value greater than 0.9 times and less than 1.1 times a given value.

### <Step S22>

Next, in Step S22 shown in FIG. 20B, the magnesium source and the fluorine source are ground and mixed. Any of the conditions for grinding and mixing that are described for Step S12 can be selected to perform this step.

### <Step S23>

Next, in Step S23 shown in FIG. 20B, the materials ground and mixed in the above step are collected to give the additive element A source (A source). Note that the additive element A source shown in Step S23 contains a plurality of starting materials and can be referred to as a mixture.

As for the particle diameter of the mixture, the median diameter (D50) is preferably greater than or equal to 600 nm and less than or equal to 10 μm, further preferably greater than or equal to 1 μm and less than or equal to 5 μm. When one kind of material is used as the additive element source, the median diameter (D50) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of lithium cobalt oxide particles uniformly in a later step of mixing with the lithium cobalt oxide. The mixture is preferably attached uniformly to the surface of the lithium cobalt oxide particles, in which case the additive element is easily distributed or dispersed uniformly in the surface portion 100a of the composite oxide after heating.

### <Step S21>

A process different from that in FIG. 20B is described with reference to FIG. 20C. In Step S21 shown in FIG. 20C, four kinds of additive element sources to be added to the lithium cobalt oxide are prepared. In other words, FIG. 20C is different from FIG. 20B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 20B. As the nickel source, nickel oxide, nickel hydroxide, or the like can be used. As the aluminum source, aluminum oxide, aluminum hydroxide, or the like can be used.

### <Step S22 and Step S23>

Step S22 and Step S23 shown in FIG. 20C are similar to the steps described with reference to FIG. 20B.

### <Step S31>

Next, in Step S31 shown in FIG. 20A, the lithium cobalt oxide and the additive element A source (A source) are mixed. The atomic ratio of cobalt Co in the lithium cobalt oxide to magnesium Mg contained in the additive element A source is preferably Co:Mg=100:y (0.1≤y≤6), further preferably M:Mg=100:y (0.3≤y≤3).

The condition of the mixing in Step S31 is preferably milder than that of the mixing in Step S12 not to damage the lithium cobalt oxide particle shape. For example, conditions with a lower rotational frequency or a shorter time than those for the mixing in Step S12 are preferable. In addition, it can be said that a dry method has a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 20A, the materials mixed in the above step are collected to give a mixture 903. At the time of the collection, the materials may be crushed as needed and made to pass through a sieve.

Note that although FIG. 20A to FIG. 20C show the formation method in which addition of the additive element is performed after the initial heating, the present invention is not limited to the above-described method. The addition of the additive element may be performed at another timing or may be performed a plurality of times. The timing of the addition may be different between the additive elements.

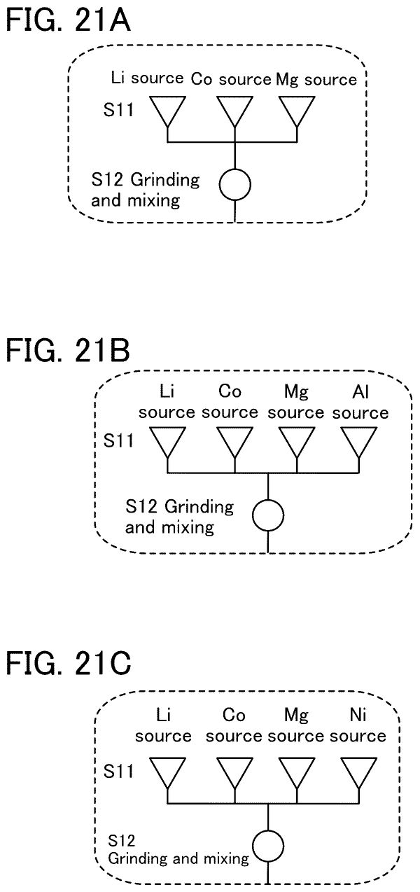

As shown in FIG. 21A to FIG. 21C, for example, the additive element may be added to the lithium source and the cobalt source in Step S11, i.e., at the stage of the starting materials of the composite oxide. FIG. 21A shows a flowchart for adding the magnesium source to the lithium source and the cobalt source. FIG. 21B shows a flowchart for adding the magnesium source and the aluminum source to the lithium source and the cobalt source. FIG. 21C shows a flowchart for adding the magnesium source and the nickel source to the lithium source and the cobalt source. The additive element sources shown in FIG. 21A to FIG. 21C are examples.

The process is followed by Step S12, lithium cobalt oxide containing the additive element can be obtained in Step S13. The distribution of the additive element can be controlled by changing the timing of the addition of the additive element. The additive elements added as shown in FIG. 21A to FIG. 21C are expected to be located in the inner portion of the positive electrode active material 100. In the flowchart shown in FIG. 21A to FIG. 21C, there is no need to separate steps of Step S11 to Step S14 and steps of Step S21 to Step S23; therefore, this method can be regarded as being simple and highly productive. Needless to say, another additive element may be added in Step S20 also in the case where any of the flowcharts shown in FIG. 21A to 21C is employed.

Alternatively, lithium cobalt oxide that contains some of the additive elements in advance may be used. When lithium cobalt oxide to which magnesium and fluorine are added is used, for example, Step S11 to Step S14 and part of Step S20 can be skipped. This method can be regarded as being simple and highly productive.

Alternatively, after the heating in Step S15 is performed, to lithium cobalt oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 illustrated in FIG. 20A, the mixture 903 is heated. Any of the heating conditions described for Step S13 can be selected to perform the heating. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere might cause reduction of cobalt or the like and hinder the lithium cobalt oxide or the like from maintaining a layered rock-salt crystal structure.

Here, a supplementary explanation of the heating temperature is given. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in lithium cobalt oxide and the additive element source occurs, and may be lower than the melting temperatures of these materials. It is known that in the case of an oxide as an example, solid phase diffusion occurs at the temperature 0.757 times the melting temperature Tₘ (the Tamman temperature T_{d}). Accordingly, the heating temperature in Step S33 is higher than or equal to 650° C.

Needless to say, the reaction more easily proceeds at a temperature higher than or equal to the temperature at which one or two or more selected from the materials contained in the mixture 903 are melted. For example, in the case where LiF and MgF₂ are included in the additive element source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably lower than that in Step S13.

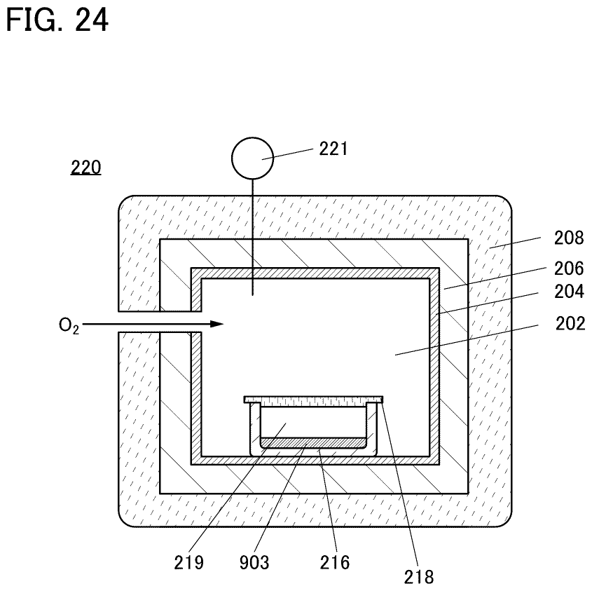

An example of the heating furnace used in Step S33 is described with reference to FIG. 24.

A heating furnace 220 illustrated in FIG. 24 includes a space 202 in the heating furnace, a hot plate 204, a pressure gauge 221, a heater unit 206, and a heat insulator 208. The heating is preferably performed with a container 216, which corresponds to a crucible or a sagger, covered with a lid 218. With this structure, an atmosphere including a fluoride can be obtained in a space 219 enclosed by the container 216 and the lid 218. In the heating, the state of the space 219 is maintained with the lid put on so that the concentration of the gasified fluoride inside the space 219 can be constant or cannot be reduced, in which case fluorine and magnesium can be contained in the vicinity of the particle surface. The atmosphere including a fluoride can be provided in the space 219, which is smaller in capacity than the space 202 in the heating furnace, by volatilization of a smaller amount of a fluoride. This means that an atmosphere including a fluoride can be provided in the reaction system without a significant reduction in the amount of a fluoride included in the mixture 903. Accordingly, LiMO₂ can be produced efficiently. In addition, the use of the lid 218 allows the heating of the mixture 903 in an atmosphere including a fluoride to be simply and inexpensively performed.

Before heating in the space 202 in the heating furnace is performed, the step of providing an atmosphere including oxygen in the space 202 in the heating furnace and the step of placing the container 216 in which the mixture 903 is placed in the space 202 in the heating furnace are performed. The steps in this order enable the mixture 903 to be heated in an atmosphere including oxygen and a fluoride. For example, flowing of a gas is performed during the heating (flowing). The gas can be introduced from below the space 202 in the heating furnace and exhausted to above the space 202 in the heating furnace. During the heating, the space 202 in the heating furnace may be sealed off to be a closed space so that the gas is not transferred to the outside (purging).

Although there is no particular limitation on the method of providing an atmosphere including oxygen in the space 202 in the heating furnace, examples are a method of introducing an oxygen gas or a gas containing oxygen such as dry air after exhausting air from the space 202 in the heating furnace and a method of flowing an oxygen gas or a gas containing oxygen such as dry air into the space 202 for a certain period of time. In particular, introducing an oxygen gas after exhausting air from the space 202 in the heating furnace (displacement by oxygen) is preferably performed. Note that the atmosphere of the space 202 in the heating furnace may be regarded as an atmosphere including oxygen.

Furthermore, the fluoride or the like attached to inner walls of the container 216 and the lid 218 is fluttered again by the heating and can also be attached to the mixture 903.

There is no particular limitation on the step of heating the heating furnace 220. The heating may be performed using a heating mechanism included in the heating furnace 220.

Although there is no particular limitation on the way of placing the mixture 903 in the container 216, as illustrated in FIG. 24, the mixture 903 is preferably provided so that the top surface of the mixture 903 is flat on the bottom surface of the container 216, in other words, the level of the top surface of the mixture 903 becomes uniform.

The heating in Step S31 described above is preferably performed with the pressure in the furnace controlled using the pressure gauge 221. The furnace is preferably in an atmospheric pressure state or a pressurized state. Exposed to pressure, for example, the surface of lithium cobalt oxide is probably melted. That is, the surface of lithium cobalt oxide heated together with LiF and MgF₂ may be melted under pressure.

Cooling after the heating in the Step S33 above can be performed by natural cooling, and the time it takes for the temperature to decrease to room temperature from a predetermined temperature is preferably longer than or equal to 10 hours and shorter than or equal to 50 hours; for example, the temperature falling rate (hereinafter also referred to as cooling rate) is preferably higher than or equal to 80° C./h and lower than or equal to 250° C./h, further preferably higher than or equal to 180° C./h and lower than or equal to 210° C./h. The cooling rate in Step S33 is preferably higher than that in Step S13. Cooling at a high cooling rate is referred to as rapid cooling. Performing rapid cooling after the above-described melting makes it possible to form a shell adequately. Specifically, it is possible to form a thin shell. Note that as long as the temperature becomes acceptable to the next step, the cooling is not necessarily continued until room temperature is reached.

In addition, at the time of heating the mixture 903, the partial pressure of fluorine or a fluorine compound originating from the fluorine source or the like is preferably controlled to be within an appropriate range. The partial pressure may be controlled by performing the heating in this step with the crucible covered with the lid. As described above, the lid can prevent volatilization or sublimation of a material. Thus, at the time when the temperature is increased and decreased in this step, the crucible is not necessarily sealed off with the lid as long as volatilization or sublimation of a material is prevented. For example, this step can be performed without sealing off the crucible in the case where the reaction chamber in which the crucible is put is filled with oxygen. A positive electrode active material containing fluorine or a fluorine compound in an appropriate manner is preferable because such positive electrode active material would inhibit ignition and smoking if an internal short circuit occurs.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

However, since LiF in a gas phase has a specific gravity less than that of oxygen, heating might volatilize LiF and in that case, LiF in the mixture 903 decreases. As a result, the function of a fusing agent deteriorates. Therefore, heating needs to be performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed even when a fluorine compound having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903. The crucible is preferably covered with the lid so that volatilization of LiF is inhibited.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element (e.g., fluorine), thereby hindering distribution of the additive element (e.g., magnesium and fluorine) in the surface portion. In order to promote a reaction with oxygen in the atmosphere, the crucible is not necessarily sealed off with the lid.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example. The same applies to the case where the crucible is covered with a lid.

A supplementary explanation of the heating time is given. The heating time depends on conditions such as the heating temperature and the size and composition of the lithium cobalt oxide in Step S14. In the case where the lithium cobalt oxide is small, the heating is preferably performed at a lower temperature or for a shorter time than heating in the case where the lithium cobalt oxide is large, in some cases.

When the median diameter (D50) of the lithium cobalt oxide in Step S14 in FIG. 20A is approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 2θ hours, for example. Note that the temperature decreasing time after the heating is, for example, preferably longer than or equal to 10 hours and shorter than or equal to 50 hours.

When the median diameter (D50) of the lithium cobalt oxide in Step S14 is approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 20A, in which crushing is performed as needed; thus, the positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

### [Formation Method 2 of Positive Electrode Active Material]

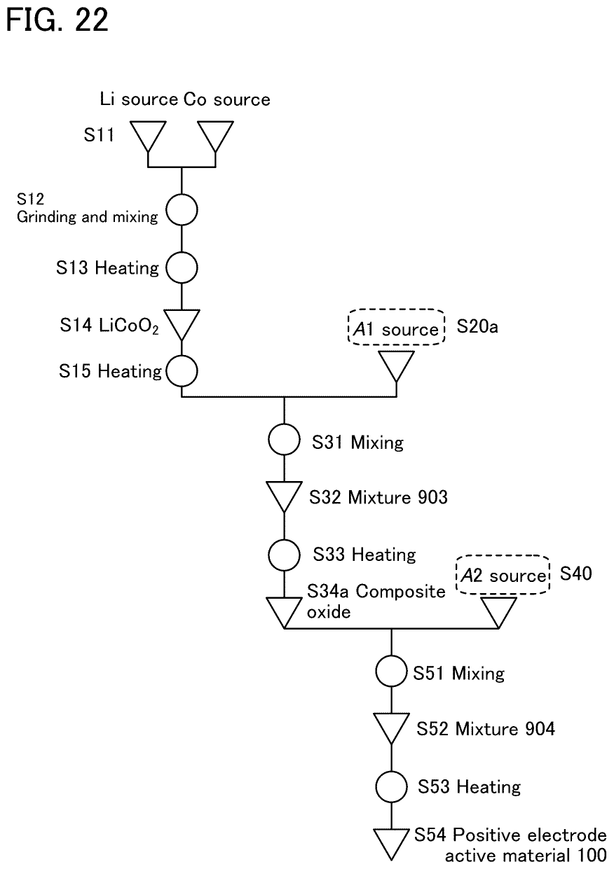

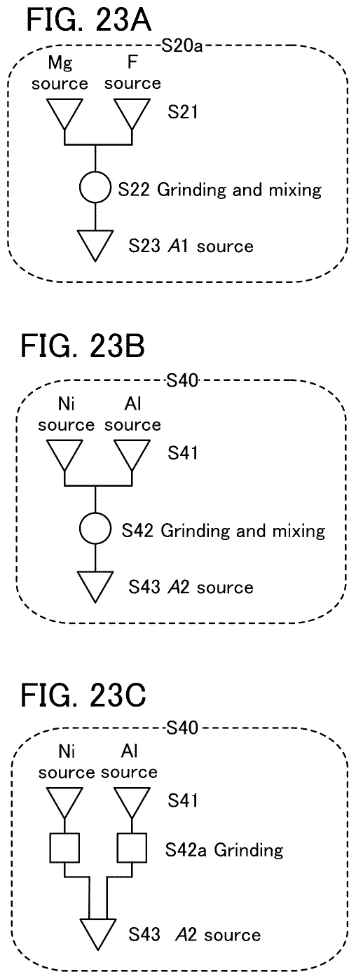

Next, as one embodiment of the present invention, a formation method 2 of a positive electrode active material, which is different from the formation method 1 of a positive electrode active material, is described with reference to FIG. 22 to FIG. 23C. The formation method 2 of a positive electrode active material is different from the formation method 1 mainly in the number of times of adding additive elements and a mixing method. For the description except for the above, the description of the formation method 1 can be referred to.

Steps S11 to S15 in FIG. 22 are performed as in FIG. 20A to prepare lithium cobalt oxide that has been subjected to the initial heating.

### <Step S20a>

Next, as shown in Step S20a, an additive element A1 is preferably added to the lithium cobalt oxide that has been subjected to the initial heating.

### <Step S21>

In Step S21 shown in FIG. 23A, a first additive element source is prepared. The first additive element source can be selected from the additive elements A described for Step S21 with reference to FIG. 20B to be used. For example, one or more selected from magnesium, fluorine, and calcium can be suitably used as the additive element A1. FIG. 23A shows an example of using a magnesium source (Mg source) and a fluorine source (F source) as the first additive element source.

Step S21 to Step S23 shown in FIG. 23A can be performed under the conditions similar to those in Step S21 to Step S23 shown in FIG. 20B. As a result, the additive element source (A1 source) can be obtained in Step S23.

Steps S31 to S33 shown in FIG. 22 can be performed in a manner similar to that of Steps S31 to S33 shown in FIG. 20A.

### <Step S34a>

Next, the material heated in Step S33 is collected to form lithium cobalt oxide containing the additive element A1. This composite oxide is called a second composite oxide to be distinguished from the composite oxide in Step S14.

### <Step S40>

In Step S40 shown in FIG. 22, an additive element A2 is added. FIG. 23B and FIG. 23C are referred to in the following description.

### <Step S41>

In Step S41 shown in FIG. 23B, a second additive element source is prepared. The second additive element source can be selected from the additive elements A described for Step S21 shown in FIG. 20B. For example, one or more selected from nickel, titanium, boron, zirconium, and aluminum can be suitably used as the additive element A2. FIG. 23B shows an example of using a nickel source (Ni source) and an aluminum source (A1 source) for the second additive element source.

Step S41 to Step S43 shown in FIG. 23B can be performed under the conditions similar to those in Step S21 to Step S23 shown in FIG. 20B. As a result, the additive element source (A2 source) can be obtained in Step S43.

FIG. 23C shows a modification example of the steps described with reference to FIG. 23B. A nickel source (Ni source) and an aluminum source (A1 source) are prepared in Step S41 shown in FIG. 23C and are separately ground in Step S42a. Accordingly, a plurality of the second additive element sources (A2 sources) are prepared in Step S43. FIG. 23C is different from FIG. 23B in separately grinding the additive elements in Step S42a.

### <Step S51 to Step S53>

Next, Step S51 to Step S53 shown in FIG. 22 can be performed under the conditions similar to those in Step S31 to Step S34 shown in FIG. 20A. The heating in Step S53 can be performed at a lower temperature and for a shorter time than the heating in Step S33. Through the above process, the positive electrode active material 100 of one embodiment of the present invention can be formed in Step S54. The positive electrode active material of one embodiment of the present invention has a smooth surface.

As shown in FIG. 22 to FIG. 23C, in the formation method 2, introduction of the additive element to the lithium cobalt oxide is divided into introduction of the additive element A1 and that of the additive element A2. When the elements are separately introduced, the additive elements can have different profiles in the depth direction. For example, the additive element A1 can have a profile such that the concentration is higher in the surface portion than in the inner portion, and the additive element A2 can have a profile such that the concentration is higher in the inner portion than in the surface portion.

The initial heating described in this embodiment makes it possible to obtain a positive electrode active material having a smooth surface.

The initial heating described in this embodiment is performed on a lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. The steps are preferably performed in such an order to maintain the smoothness of the surface achieved by the initial heating.

The positive electrode active material 100 with a smooth surface may be more resistant to physical break by pressure application or the like than a positive electrode active material without a smooth surface. For example, the positive electrode active material 100 is unlikely to be broken in a test involving pressure application such as a nail penetration test, which can result in high safety of the positive electrode active material 100.

At least part of this embodiment can be implemented in combination with the other embodiments described in this specification as appropriate.

### Embodiment 3

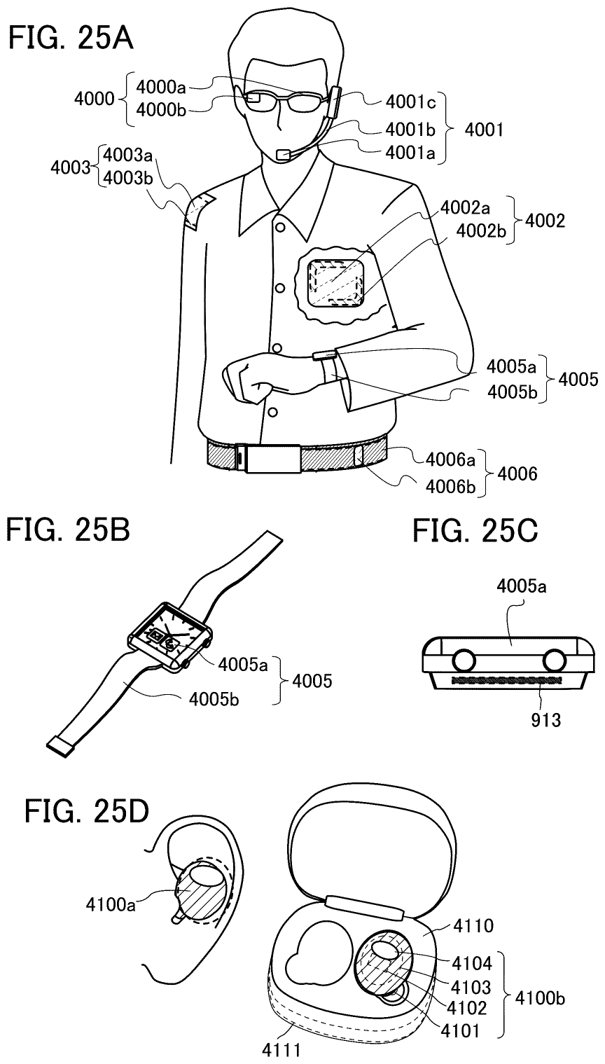

In this embodiment, examples of electronic devices each including the secondary battery described in the above embodiment are described with reference to FIG. 25A to FIG. 25C.

FIG. 25A shows examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 25A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 25B illustrates a perspective view of the watch-type device 4005 that is detached from an arm.

FIG. 25C is a side view. FIG. 25C illustrates a state where the secondary battery 913 is incorporated in the inner region. The secondary battery 913 is the secondary battery described in Embodiment 4. The secondary battery 913, which is small and lightweight, is provided at a position overlapping with the display portion 4005a.

FIG. 25D illustrates an example of wireless earphones. The wireless earphones illustrated here include, but are not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charge, and the like are preferably included. Furthermore, a microphone may be included.

A case 4110 includes a secondary battery 4111. Moreover, a substrate where a circuit such as a wireless IC or a charge control IC is provided, and a terminal for charge are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the above embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

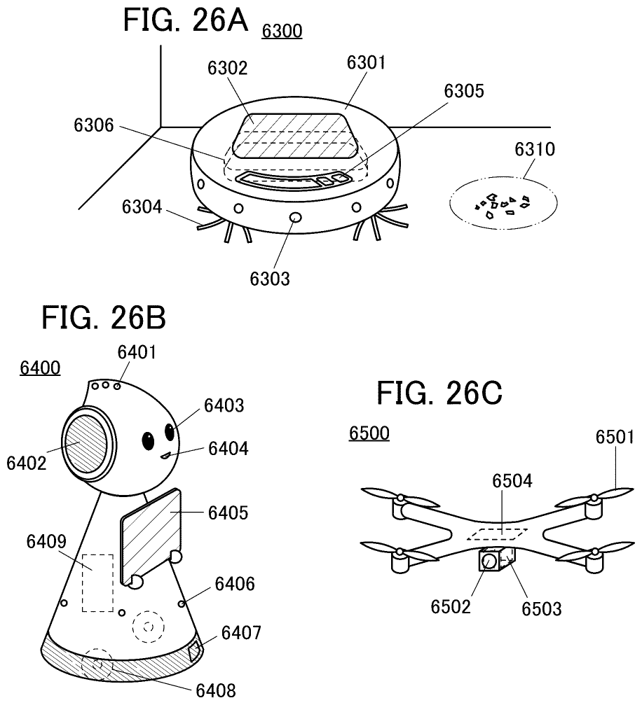

FIG. 26A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not shown, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The cleaning robot 6300 includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 26B illustrates an example of a robot. A robot 6400 shown in FIG. 26B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 26C illustrates an example of a flying object. A flying object 6500 shown in FIG. 26C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

At least part of this embodiment can be implemented in combination with the other embodiments described in this specification as appropriate.

### Embodiment 4

In this embodiment, examples of vehicles each including the secondary battery of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

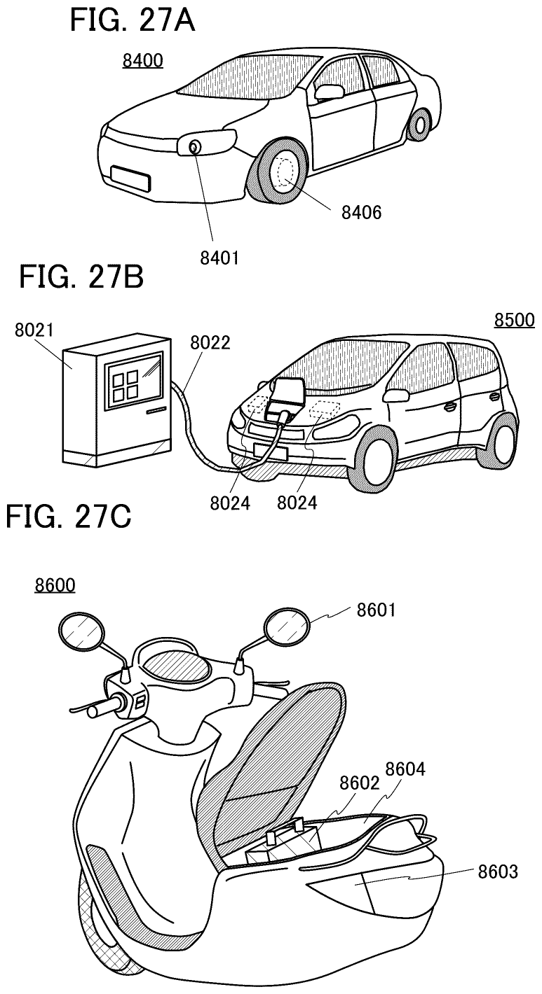

FIG. 27 illustrates examples of vehicles each using the secondary battery of one embodiment of the present invention. An automobile 8400 illustrated in FIG. 27A is an electric vehicle that runs on the power of an electric motor. Alternatively, the automobile 8400 is a hybrid electric vehicle capable of driving using either an electric motor or an engine as appropriate. The use of one embodiment of the present invention can achieve a high-mileage vehicle. The automobile 8400 includes the secondary battery. As the secondary battery, the modules of the secondary batteries illustrated in FIG. 25C and FIG. 25D may be arranged to be used in a floor portion in the automobile. Alternatively, a battery pack in which a plurality of secondary batteries illustrated in FIG. 26 are combined may be placed in the floor portion in the automobile. The secondary battery can be used not only for driving an electric motor 8406, but also for supplying electric power to a light-emitting device such as a headlight 8401 and a room light (not shown).

The secondary battery can also supply power to a display device included in the automobile 8400, such as a speedometer or a tachometer. Furthermore, the secondary battery can supply power to a semiconductor device included in the automobile 8400, such as a navigation system.

An automobile 8500 shown in FIG. 27B can be charged when the secondary battery included in the automobile 8500 is supplied with electric power through external charge equipment by a plug-in system, a contactless power feeding system, and/or the like. FIG. 27B illustrates a state where a secondary battery 8024 incorporated in the automobile 8500 is charged from a ground installation type charging device 8021 through a cable 8022. In charging, a given method such as CHAdeMO (registered trademark) or Combined Charging System may be employed as a charging method, the standard of a connector, and the like as appropriate. The charging device 8021 may be a charging station provided in a commerce facility or a power source in a house. For example, with the use of a plug-in technique, the secondary battery 8024 provided in the automobile 8500 can be charged by being supplied with power from outside. Charge can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of power between vehicles. Furthermore, a solar cell may be provided in the exterior of the vehicle to charge the secondary battery when the vehicle is stopped and/or driven. To supply electric power in such a contactless manner, an electromagnetic induction method and/or a magnetic resonance method can be used.

In addition, FIG. 27C is an example of a motorcycle using the secondary battery of one embodiment of the present invention. A motor scooter 8600 illustrated in FIG. 27C includes a secondary battery 8602, side mirrors 8601, and direction indicators 8603. The secondary battery 8602 can supply electricity to the direction indicators 8603.

Furthermore, in the motor scooter 8600 illustrated in FIG. 27C, the secondary battery 8602 can be stored in an under-seat storage 8604. The secondary battery 8602 can be stored in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycle performance and the discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power supply source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals typified by cobalt can be reduced.

At least part of this embodiment can be implemented in combination with the other embodiments described in this specification as appropriate.

### Example 1

In this example, the positive electrode active material of one embodiment of the present invention is formed, and results of performing powder resistivity measurement are described.

### [Formation of Samples]

In this example, a positive electrode active material was formed based on the formation method shown in FIG. 22 and FIG. 23.

As LiCoO₂ in Step S14 in FIG. 22, with use of cobalt as the transition metal M, commercially available lithium cobalt oxide (Cellseed C-10N produced by NIPPON CHEMICAL INDUSTRIAL CO., LTD.) not containing any additive element was prepared. The initial heating in Step S15 was not performed in this example.

In accordance with Step S21 shown in FIG. 23A, LiF and MgF₂ were prepared as the F source and the Mg source, respectively. LiF and MgF₂ were weighted so that the molar ratio of LiF to MgF₂ was LiF:MgF₂=1:3, dehydrated acetone was added as a solvent, and the materials were mixed and ground by a wet process to give the A1 source.

In accordance with Step S31 and Step S32 in FIG. 22, the A1 source was added to obtain the mixture 903. As Step S31, the A1 source and the lithium cobalt oxide were weighed such that the number of magnesium atoms of the A1 source was 0.5% with respect to the number of cobalt atoms of the lithium cobalt oxide, and were mixed by a dry method.

Next, as Step S33 in FIG. 22, the mixture 903 was heated. The heating conditions were 850° C. and 60 hours. During the heating, a lid was put on a crucible containing the mixture 903. The crucible and the lid were those made of alumina. In order that the crucible can be filled with an atmosphere containing oxygen, oxygen was supplied at a flow rate of 10 L/min to a furnace used for the heating (flowing). By the heating, Sample 1-1 as lithium cobalt oxide containing magnesium and fluorine was obtained (Step S34a). No A2 source was added in this example.

Sample 1-2 and Sample 1-3 having different mixing ratios of the A1 source from Sample 1-1 were formed.

Sample 1-2 was a mixture obtained by weighing such that the number of magnesium atoms contained in the A1 source was 1.0% with respect to the number of cobalt atoms contained in the lithium cobalt oxide.

Sample 1-3 was a mixture obtained by weighing such that the number of magnesium atoms contained in the A1 source was 6.0% with respect to the number of cobalt atoms contained in the lithium cobalt oxide.

In addition, Sample 2 was formed as a comparative example. As Sample 2, lithium cobalt oxide (Cellseed C-10N produced by NIPPON CHEMICAL INDUSTRIAL CO., LTD.) was used, and no heat treatment or the like was performed.

### [Powder Resistivity Measurement]

Volume resistivities of the powder of the formed samples were measured. The volume resistivities of the powders were measured by the method described in {Powder resistivity measurement} in Embodiment 1. As a measurement device, MCP-PD51 produced by Mitsubishi Chemical Analytech Co., Ltd. was used; as a resistance meter, Loresta-GP or Hiresta-UP was used. The range in which accurate measurement can be performed differs between resistance meters; thus, an appropriate resistance meter was selected and used in accordance with the resistivity of a sample. The measurement was performed in a common laboratory environment (i.e., an environment at a temperature higher than or equal to 15° C. and lower than or equal to 30° C.).

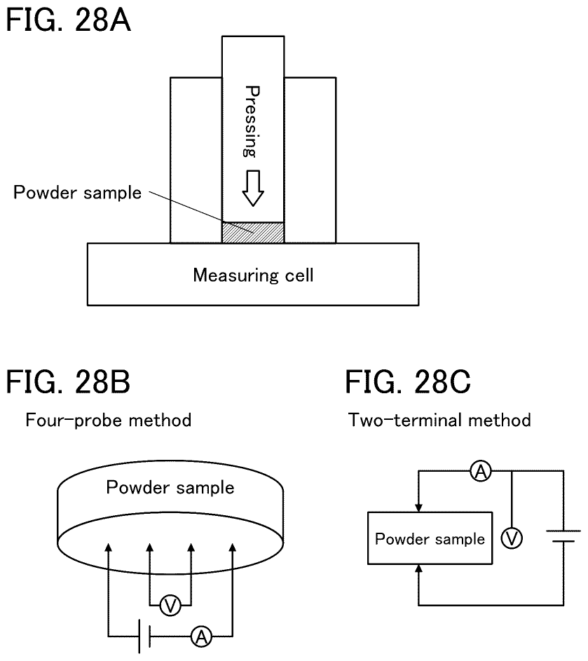

FIG. 28A is a schematic view of a measurement apparatus capable of measuring a powder volume resistivity. FIG. 28B is a conceptual diagram of a four-probe method, and FIG. 28C is a conceptual diagram of a two-terminal method.

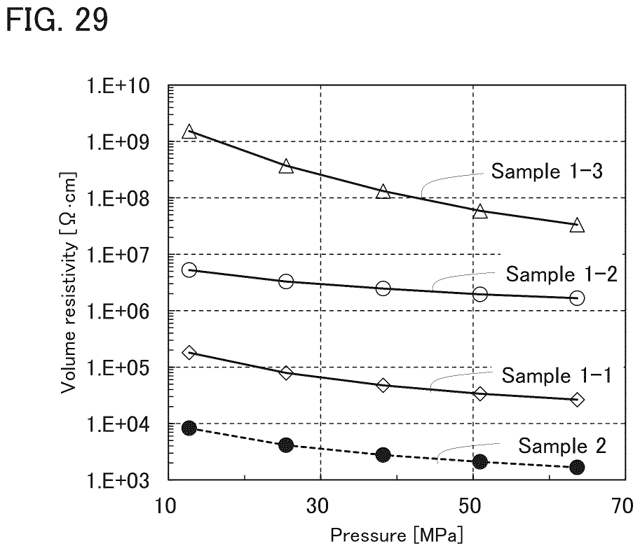

The powder volume resistivity of each sample was obtained by measuring the electric resistance and volume of the powder set in a measurement unit, under pressures of 13 MPa, 25 MPa, 38 MPa, 51 MPa, and 64 MPa. FIG. 29 shows results.

As shown in FIG. 29, it was found that in the positive electrode active material containing magnesium and fluorine (Samples 1-1, 1-2, and 1-3) of one embodiment of the present invention, the larger the mixed amount of the A1 source is, the higher the powder resistivity becomes. It is presumable that magnesium and the like positioned in a shell increased the powder resistivity of the positive electrode active material.

With a higher powder resistivity of the positive electrode active material, current is less likely to flow into the active material when an internal short circuit or the like occurs, so that the reduction reaction rate of the active material can be slowed. Therefore, a higher powder resistivity of the positive electrode active material makes it less likely to cause release of oxygen from the positive electrode active material, decomposition of an electrolyte solution, or the like when an internal short circuit occurs, probably resulting in inhibiting thermal runway of a secondary battery and reducing risks such as ignition or smoking. Accordingly, a secondary battery using the positive electrode active material of one embodiment of the present invention can have high safety. Note that the ease of thermal runway, ignition, and smoking due to an internal short circuit can be evaluated by the nail penetration test described above, for example.

Since the positive electrode and the negative electrode of the secondary battery of one embodiment of the present invention each include a plurality of tabs, the internal resistance of the secondary battery is lower than that of a conventional secondary battery. Thus, even when a material with high powder resistivity is used for the positive electrode active material, the influence of the positive electrode active material on charge and discharge time can be minimized. Thus, a secondary battery that is easily charged and discharged at high speed, is highly safe, and is inhibited from deteriorating can be provided.

### Example 2

In this example, a positive electrode active material is formed under conditions different from those in Example 1, and results of performing powder resistivity measurement of the positive electrode active material are described.

### [Formation of Samples]

In this example, a positive electrode active material was formed based on the formation method shown in FIG. 22 and FIG. 23.

As LiCoO₂ in Step S14 in FIG. 22, lithium cobalt oxide (Cellseed C-10N produced by NIPPON CHEMICAL INDUSTRIAL CO., LTD.) was prepared. The initial heating in Step S15 was performed on the lithium cobalt oxide, which was put in a crucible covered with a lid, in a muffle furnace at 850° C. for 2 hours. After the muffle furnace was filled with an oxygen atmosphere, no flowing was performed (02 purging).

In accordance with Step S21 shown in FIG. 23A, LiF and MgF₂ were prepared as the F source and the Mg source, respectively. LiF and MgF₂ were weighed such that LiF:MgF₂ was 1:3 (molar ratio). Then, LiF and MgF₂ were mixed into dehydrated acetone and the mixture was stirred at a rotating speed of 400 rpm for 12 hours, whereby the additive element source (A1 source) was produced. In the mixing, a ball mill was used and a grinding medium was zirconium oxide balls. The F source and Mg source weighing approximately 9 g in total were put in a 45-mL-capacity container of the mixing ball mill together with 20 mL of dehydrated acetone and 22 g of zirconium oxide balls (1 mmϕ) and mixed. Then, the mixture was made to pass through a sieve with an aperture of 300 μm, whereby the A1 source was obtained.

Next, as Step S31, the A1 source was weighed to be 1 mol % with respect to cobalt, and mixed with lithium cobalt oxide subjected to the initial heating by a dry method. Stirring was performed for 1 hour at a rotational speed of 150 rpm, which is milder condition than stirring performed for obtaining the A1 source. Finally, the mixture was made to pass through a sieve with an aperture of 300 μm, whereby the mixture 903 having a uniform particle diameter was obtained (Step S32).

Next, as Step S33, the mixture 903 was heated. The heating conditions were 900° C. and 20 hours. During the heating, a lid was put on a crucible containing the mixture 903. The crucible was filled with an atmosphere containing oxygen and entry and exit of the oxygen were blocked (purged). By the heating, a composite oxide containing Mg and F was obtained (Step S34a).

Then, as Step S51, the composite oxide and the additive element source (A2 source) were mixed. Nickel hydroxide on which a grinding step was performed was prepared as the nickel source and aluminum hydroxide on which a grinding step was performed was prepared as the aluminum source in accordance with Step S41 shown in FIG. 23C. The nickel hydroxide and the aluminum hydroxide were each weighed to be 0.5 mol % with respect to lithium cobalt oxide, and were mixed with the composite oxide by a dry method. At this time, stirring was performed at a rotational speed of 150 rpm for 1 hour. In the mixing, a ball mill was used and a grinding medium was zirconium oxide balls. The composite oxide, the nickel source, and the aluminum source weighing approximately 7.5 g in total were put in a 45-mL-capacity container of the mixing ball mill together with 22 g of zirconium oxide balls (1 mmϕ) and mixed. These conditions were milder than those of the stirring in the production of the A1 source. Finally, the mixture was made to pass through a sieve with an aperture of 300 μm, whereby a mixture 904 having a uniform particle diameter was obtained (Step S52).

Finally, as Step S53, the mixture 904 was heated. The heating was performed at 850° C. for 10 hours. During the heating, a lid was put on a crucible containing the mixture 904. The crucible was filled with an atmosphere containing oxygen and entry and exit of the oxygen were blocked (purged). By the heating, lithium cobalt oxide containing Mg, F, Ni, and Al was obtained (Step S54).

The LiCoO₂ subjected to the initial heating in Step S15 was used as Sample 3-1.

The composite oxide obtained in Step S34a was used as Sample 3-2.

The positive electrode active material obtained in Step S54 was used as Sample 3-3.

### [Powder Resistivity Measurement]

Volume resistivities of the powders of Samples 3-1, 3-2, and 3-3 were measured. The measurement conditions are similar to those in Example 1. The measurement was performed in a common laboratory environment (i.e., an environment at a temperature higher than or equal to 15° C. and lower than or equal to 30° C.).

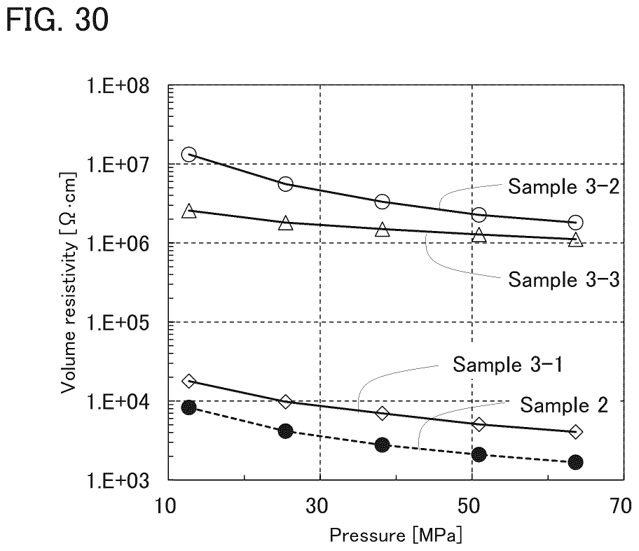

FIG. 30 shows the measurement results. FIG. 30 also shows Sample 2 in Example 1. As shown in FIG. 30, the volume resistivity was increased in the order of Sample 2, Sample 3-1, Sample 3-3, and Sample 3-2 from the lowest. The difference of the values between the volume resistivity of Sample 3-1 and the volume resistivities of the Sample 3-2 and Sample 3-3 was as big as larger than or equal to two digits. For Sample 3-1, only initial heating was performed, whereas Sample 3-2 and Sample 3-3 each contained Mg and F.

In FIG. 30, focusing on a pressure of 64 MPa, the volume resistivity is preferably higher than or equal to 5.0×10³ Ω·cm, further preferably higher than or equal to 1.0×10⁴ Ω·cm, still further preferably higher than or equal to 1.0×10⁵ Ω·cm, yet still further preferably higher than or equal to 5.0×10⁵ Ω·cm, yet still further preferably higher than or equal to 1.0×10⁶ Ω·cm.

In FIG. 30, focusing on a pressure of 13 MPa, the volume resistivity is preferably higher than or equal to 2.0×10⁴ Ω·cm, further preferably higher than or equal to 2.0×10⁵ Ω·cm, still further preferably higher than or equal to 5.0×10⁵ Ω·cm, yet still further preferably higher than or equal to 1.0×10⁶ Ω·cm, yet still further preferably higher than or equal to 2.0×10⁶ Ω·cm.

The volume resistivity tends to be higher under the condition with a lower pressure than under the condition with a higher pressure. Thus, the volume resistivity is preferably higher than or equal to 1.0×10⁴ Ω·cm under a pressure of 64 MPa and higher than or equal to 2.0×10⁴ Ω·cm under a pressure of 13 MPa. The volume resistivity is further preferably higher than or equal to 1.0×10⁵ Ω·cm under a pressure of 64 MPa and higher than or equal to 2.0×10⁵ Ω·cm under a pressure of 13 MPa. Furthermore, it can be said that the volume resistivity is still further preferably higher than or equal to 5.0×10⁵ Ω·cm under a pressure of 64 MPa and higher than or equal to 1.0×10⁶ Ω·cm under a pressure of 13 MPa.

As described above, the positive electrode active material of one embodiment of the present invention includes a high-resistance shell portion, whereby the powder volume resistivity is increased. Such a positive electrode active material can inhibit thermal runaway due to an internal short circuit and achieve a highly safe secondary battery.

### REFERENCE NUMERALS

10a: secondary battery, 10b: secondary battery, 10c: secondary battery, 10: secondary battery, 11a: end portion, 11b: end portion, 11: positive electrode, 12a: end portion, 12b: end portion, 12: negative electrode, 13: separator, 21_1: tab, 21_2: tab, 21_3: tab, 21_4: tab, 21_5: tab, 21_6: tab, 21_7: tab, 21: tab, 22_1: tab, 22_2: tab, 22_3: tab, 22_4: tab, 22_5: tab, 22_6: tab, 22_7: tab, 22: tab, 31: bonding portion, 32: bonding portion, 35: bonding mark, 100a: surface portion, 100b: bulk, 100f: fluorine compound, 100s: shell, 100: positive electrode active material, 101: crystal grain boundary, 102: filling portion, 103: uneven portion, 104: coating portion

1. A secondary battery which is a wound secondary battery comprising:
a positive electrode and a negative electrode,
wherein the positive electrode comprises a positive electrode current collector and a positive electrode active material,
wherein the positive electrode current collector comprises a first tab and a second tab,
wherein the negative electrode comprises a negative electrode current collector and a negative electrode active material,
wherein the negative electrode current collector comprises a third tab and a fourth tab,
wherein the first tab is positioned in a portion closer to a center of a winding than the second tab is,
wherein the third tab is positioned in a portion closer to the center of the winding than the fourth tab is,
wherein the first tab and the second tab are bonded in a first bonding portion,
wherein the third tab and the fourth tab are bonded in a second bonding portion,
wherein the positive electrode active material comprises a first region and a second region positioned on a surface side of the positive electrode active material,
wherein the first region comprises lithium, cobalt, and oxygen, and
wherein the second region comprises lithium, cobalt, magnesium, and oxygen.

2. A secondary battery which is a wound secondary battery comprising:
a positive electrode and a negative electrode,
wherein the positive electrode comprises a positive electrode current collector and a positive electrode active material,
wherein the positive electrode current collector comprises a first tab, a second tab, and a fifth tab,
wherein the negative electrode comprises a negative electrode current collector and a negative electrode active material,
wherein the negative electrode current collector comprises a third tab, a fourth tab, and a sixth tab,
wherein the first tab, the second tab, and the fifth tab are positioned in this order from a side close to a center of a winding and bonded in a first bonding portion,
wherein the third tab, the fourth tab, and the sixth tab are positioned in this order from a side close to the center of the winding and bonded in a second bonding portion,
wherein the first tab and the fifth tab are provided with the second tab therebetween in the first bonding portion,
wherein the third tab and the sixth tab are provided with the fourth tab therebetween in the second bonding portion,
wherein the positive electrode active material comprises a first region and a second region positioned on a surface side of the positive electrode active material,
wherein the first region comprises lithium, cobalt, and oxygen, and
wherein the second region comprises lithium, cobalt, magnesium, and oxygen.

3. A secondary battery which is a wound secondary battery comprising:
a positive electrode and a negative electrode,
wherein the positive electrode comprises a positive electrode current collector and a positive electrode active material,
wherein the positive electrode current collector comprises a first tab, a second tab, and a fifth tab,
wherein the negative electrode comprises a negative electrode current collector and a negative electrode active material,
wherein the negative electrode current collector comprises a third tab, a fourth tab, and a sixth tab,
wherein the first tab, the second tab, and the fifth tab are positioned in this order from a side close to a center of a winding and bonded in a first bonding portion,
wherein the third tab, the fourth tab, and the sixth tab are positioned in this order from a side close to the center of the winding and bonded in a second bonding portion,
wherein the second tab and the fifth tab are provided with the first tab therebetween in the first bonding portion,
wherein the fourth tab and the sixth tab are provided with the third tab therebetween in the second bonding portion,
wherein the positive electrode active material comprises a first region and a second region positioned on a surface side of the positive electrode active material,
wherein the first region comprises lithium, cobalt, and oxygen, and
wherein the second region comprises lithium, cobalt, magnesium, and oxygen.

4. The secondary battery according to claim 1,
wherein a thickness of the second region is greater than or equal to 2 nm and less than or equal to 5 nm.

5. The secondary battery according to claim 1,
wherein the second region further comprises nickel.

6. The secondary battery according to claim 1,
wherein the second region further comprises fluorine.

7. The secondary battery according to claim 1,
wherein the first region further comprises aluminum.

8. The secondary battery according to claim 1,
wherein the second region is positioned in a range of 5 nm from a surface of the positive electrode active material.

9. The secondary battery according to claim 1,
wherein a volume resistivity of a powder of the positive electrode active material at a temperature higher than or equal to 15° C. and lower than or equal to 30° C. is higher than or equal to 1.0×10⁵ Ω·cm under a pressure of 64 MPa.

10. The secondary battery according to claim 1,
wherein a volume resistivity of a powder of the positive electrode active material at a temperature higher than or equal to 15° C. and lower than or equal to 30° C. is higher than or equal to 2.0×10⁵ Ω·cm under a pressure of 13 MPa.

11. The secondary battery according to claim 1,
wherein a volume resistivity of a powder of the positive electrode active material at a temperature higher than or equal to 15° C. and lower than or equal to 30° C. is higher than or equal to 1.0×10⁵ Ω·cm under a pressure of 64 MPa and higher than or equal to 2.0×10⁵ Ω·cm under a pressure of 13 MPa.
